(19) United States
(12) Patent Application Publication
(10) Pub. No.: US 2005/0065970 A1
(43) Pub. Date: Mar. 24, 2005

(54) System, method and apparatus for developing software

(76) Inventors: Anthony Graham King, San Antonio, TX (US); Jacob Jonker, Weltevreden Park (ZA); Michael Zagorsky, Riviera (ZA)

Correspondence Address: CHALKER FLORES, LLP, 12700 PARK CENTRAL, STE. 455, DALLAS, TX, 75251, US

(21) Appl. No.: 10/922,643

(22) Filed: Aug. 20, 2004

Related U.S. Application Data
(60) Provisional application No. 60/496,658, filed on Aug. 20, 2003.

(51) Int. Cl. G06F 7/00

(52) U.S. Cl. 707/102

(57) ABSTRACT

The present invention provides a system, method and apparatus for developing software that includes a set of standardized code segments, an interface for defining a structure of a project and a code generator communicably coupled to the set of standardized code segments and the interface that can create a computer program from the project. The present invention also generates a new computer program by (a) creating and renaming a root part for a project having a structure, (b) adding and renaming one or more holders to the renamed root part, (c) adding and renaming a part to one or more of the renamed holders, (d) adding and renaming one or more holders to the renamed parts, (e) creating one or more elements for each renamed part, (f) repeating steps (c), (d) and (e) as needed to complete the structure, and (g) generating the new computer program from the project.

### PRIORITY CLAIM

This patent application is a U.S. non-provisional patent application of U.S. provisional patent application Ser. No. 60/496,658 filed on Aug. 20, 2003.

### FIELD OF THE INVENTION

The present invention relates generally to the field of computer software, and in particular, to a system, method and apparatus for developing software.

### BACKGROUND OF THE INVENTION

Development of new computer programs and databases is an expensive and time consuming endeavor that usually results in cost overruns, time overruns, expensive debugging and fixes, and a product that does not meet its original specifications. Some software development tools have been introduced that ease some of these problems, but they are expensive, cumbersome to use and typically have problems of their own.

There is, therefore, a need for a system, method and apparatus for developing software that is relatively inexpensive, easy to use and does not introduce new problems in the software.

### SUMMARY OF THE INVENTION

The present invention provides a system, method and apparatus for developing software that is relatively inexpensive, easy to use and does not introduce new problems in the software. Moreover, the present invention represents a breakthrough in productivity, component reusability and collaborative development, through a holistic approach to the software life cycle. The present invention not only dramatically accelerates a software development schedule, but the developed components will be robust, flexible, and above all, reusable. The present invention separates conceptually between overall system design and concrete implementation, so that changes in practical details have no impact on the whole—to the extent that components can be removed or replaced in a system with as much ease as ejecting a DVD from its player and inserting another. The present invention integrates with Microsoft Visual Studio .NET. As a result, all the power and features of the .NET framework and toolset can be used, while rapidly accelerating the new software through the present invention's development experience.

The present invention (sembleWare™ Visual Welder™) can save the user a tremendous amount of time and energy in developing a system, by automating the most commonly performed tasks, encapsulating best practices, and leaving the user to do only the intelligent work of coding business rules. The present invention includes at least three features that create this productivity benefit: Instant Databases, Projects and Prototypes, Ready Made Parts, and Automatic Control Binding.

A very large proportion of conventional application development consists of repetitive infrastructure setup. Typically, a developer would have to:
Create a database, setting up each of its tables, with their respective fields, primary keys, foreign keys, etc.
Hand-code classes for all business objects in the application, including code to load and save data from and to the database.
Hand-design a presentation layer, manually binding all controls to the appropriate members of the business objects.
Repeatedly refresh structural changes to all three application layers, when required due to specification changes—all by hand.
   In Visual Welder™, however, practically all of the above tasks can be automated—from whichever direction the user chooses. If the user wishes to start from a database design, the user can create the entire database using the tool of his or her choice—ensuring that all primary and foreign keys are correctly set up—and then instantly create a Visual Welder™ project based on the database design.

If the user prefers to start by designing the business objects (parts), the user may do so using the Visual Welder™ add-in. At any point during the development of the project structure, the user can generate the database tables, fields and keys, in accordance with the most up-to-date business layer design. The user can do this as many times as he or she chooses; any changes that are made to the parts will be updated accordingly on the database. Once the project is created, using either of the above methods, the user can also generate an entire working prototype of the system—from the home page through data listings through capture and editing screens. All that remains is for the user to code the business logic, and make any desired cosmetic changes to the look and feel of the system.

There are a great many business objects in the development world that could be re-used in thousands of different applications, yet are not, because of different languages, syntax, conventions—or else simply because of the lack of facility for such an exchange. The present invention offers developers the opportunity to benefit from each other's expertise, using the part store on the sembleWare.com web site. Here the user will find a repository of reusable parts and assemblies of parts that can be downloaded, plugged into the project and used immediately, without any need for modification.

One of the most boring and time-consuming tasks facing a developer is the creation of a presentation layer, and the binding of all the controls to the appropriate properties of the underlying business objects. It gets even more complicated if on a single form the user wishes to represent two or more inter-related business objects. The present invention saves the user the drudgery behind this task, with the Active Toolbox. The Active Toolbox is an intelligent, dynamic palette of controls that may be created to represent all the parts, elements, relationships and actions applicable to the current context. All data loading and saving is encapsulated within the Visual Welder™ libraries, and the binding to form controls is totally automated.

The present invention uses a “Part” based design pattern to provide drag-and-drop assembly of applications. “Parts” are composed using one-sided relationships, making them highly reusable in other contexts and applications. The user can package his or her own Parts for later re-use, or download and plug-in parts from an Online Part Catalog, potentially saving countless hours of development time. The user can also use the present invention's three-dimensional Spatial Editor to “opens up” the insides of the system being designed to see how the inner “parts” fit together. The system or application can be shaped by manipulating the 3D model, or using the Active Toolbox, tailor list and grids using the List Designer. As the user works, the present invention dynamically generates all the VS.NET code needed to get a working application. Working applications can be created without writing a single line of code. Or the user can introduce as much code as is needed. The choice is up to the user. The user can prioritize his or her efforts and produce more system in less time.

In addition, the present invention can generate complex web forms, complete with working drop-down combos, header-detail support, SQL queries with joins, navigation buttons and more, which are driven by an easy-to-customize html template. The user can even apply a new template to a form that was previously created, whether it was generated or painted by hand, to get a whole new look-and-feel. In addition, web forms can be crafted by dragging-and-dropping from the Active Toolbox. The present invention tracks the “parts” on the form, and can determine when a textbox, checkbox, option button, dropdown combo or nested grid is needed. The present invention will “wire” the code-behind the user, including SQL joins, as the user drags and drops. The user can create cascading combos, user grid-limiters, and even combos with related fields that auto-update, without writing a line of code.

Moreover, the present invention creates a normalized data model for the user, based on the specified Parts and Relationships. Foreign keys, composite keys and other relational database constructs are managed for the user. In addition, the present invention will generate all the scripts needed to keep the database synchronized with the project, from the initial “create table” statements to the “alter table” statements for later changes. The scripts can be applied directly, or in accordance with your corporate standards for production systems.

The present invention can also be used to reverse-engineer a database to provide a working application complete with screens. An entire database or selected tables can be imported. Additional tables can even be imported into an existing application. As a result, the user can build running applications from legacy systems with a few clicks of a mouse.

Any system built using the present invention is scalable. The runtime environment is optimized for a stateless web environment. The system uses libraries containing best-practice usage of the NET framework, so the QA cycle can be reduced.

More specifically, the present invention provides a software development tool that includes a set of standardized code segments, an interface for defining a structure of a project and a code generator communicably coupled to the set of standardized code segments and the interface. The code generator creates the project from an existing database, or creates a new database from the project, or creates a computer program from the project.

In addition, the present invention provides a system that includes a processor, a memory communicably coupled to the processor, a data storage device communicably coupled to the processor, one or more input/output devices communicably coupled to the processor and a computer program stored in the memory and data storage device. The one or more input/output devices are selected from a group that include a display, a keyboard, a mouse, a printer, a microphone, a speaker and a video camera. The computer program includes a set of standardized code segments, an interface for defining a structure of a project, and a code generator communicably coupled to the set of standardized code segments and the interface. The code generator creates the project from an existing database, or creates a new database from the project, or creates a computer program from the project.

The present invention also provides a computer program embodied on a computer readable medium for developing software that includes a set of standardized code segments, a code segment for defining a structure of a project, and a code segment for creating the project from an existing database, or creating a new database from the project, or creating a new computer program from the project.

Moreover, the present invention provides a method for generating a new computer program using a software development tool by (a) creating and renaming a root part for a project having a structure, (b) adding and renaming one or more holders to the renamed root part, (c) adding and renaming a part to one or more of the renamed holders, (d) adding and renaming one or more holders to the renamed parts, (e) creating one or more elements for each renamed part, (f) repeating steps (c), (d) and (e) as needed to complete the structure, and (g) generating the new computer program from the project. This method can be implemented using a computer program embodied on a computer readable medium wherein each step is executed by one or more code segments.

The present invention also provides a system that includes a computer and a computer program. The computer includes a processor, a memory communicably coupled to the processor, a data storage device communicably coupled to the processor, and one or more input/output devices communicably coupled to the processor selected from a group comprising a display, a keyboard, a mouse, a printer, a microphone, a speaker and a video camera. The computer program is stored in the memory and data storage device and performs the following steps: (a) creating and renaming a root part for a project having a structure, (b) adding and renaming one or more holders to the renamed root part, (c) adding and renaming a part to one or more of the renamed holders, (d) adding and renaming one or more holders to the renamed parts, (e) creating one or more elements for each renamed part, (f) repeating steps (c), (d) and (e) as needed to complete the structure, and (g) generating the new computer program from the project.

Other features and advantages of the present invention will be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram illustrating the functionality and output of a computer program in accordance with one embodiment of the present invention;

FIG. 2 is a block diagram illustrating the structural relationships of a project in accordance with one embodiment of the present invention;

FIG. 3 is a block diagram of a system in accordance with one embodiment of the present invention;

FIG. 4 is a block diagram of the various layers of one embodiment of the present invention;

FIG. 5 is a screen shot illustrating the format of the code of a part class in accordance with one embodiment of the present invention;

FIG. 6 is a screen shot illustrating the format of the code of a form class in accordance with one embodiment of the present invention;

FIGS. 7 and 8 illustrate the navigation structure of one embodiment of the present invention;

FIG. 9 depicts a sembleWebPage in accordance with one embodiment of the present invention;

FIGS. 10A, 10B and 10C illustrate the relationships between the present invention and relational databases in accordance with one embodiment of the present invention;

FIG. 11 is a flow chart of a method in accordance with one embodiment of the present invention;

FIG. 12 is a flow chart of a method in accordance with another embodiment of the present invention;

FIG. 13 is a block diagram illustrating part-holder relationships in accordance with one embodiment of the present invention;

FIGS. 14A and 14B8 illustrate a simple invoicing system in accordance with one embodiment of the present invention;

FIG. 15 illustrates an Invoice-LineItem relationship in accordance with one embodiment of the present invention;

FIG. 16 illustrate the part-holder relationship in accordance with one embodiment of the present invention;

FIG. 17 illustrates a project in accordance with one embodiment of the present invention;

FIG. 18 is a menu in accordance with one embodiment of the present invention;

FIG. 19 illustrates a spatial editor in accordance with one embodiment of the present invention;

FIG. 20 is tree view window of a project structure in accordance with one embodiment of the present invention;

FIG. 21 depicts a Part List window in accordance with one embodiment of the present invention;

FIG. 22 depicts an Active tool box in accordance with one embodiment of the present invention;

FIG. 23 depicts a Button Designer in accordance with a in accordance with one embodiment of the present invention;

FIG. 24 is a List Designer in accordance with one embodiment of the present invention;

FIGS. 25-36 illustrate various processes of one embodiment of the present invention;

FIGS. 37-40 illustrate various commonly used patterns for relationships in accordance with one embodiment of the present invention; and

FIGS. 41-51 illustrate various aspects of creating a project using the present invention in accordance with several examples.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention provides a system, method and apparatus for developing software that is relatively inexpensive, easy to use and does not introduce new problems in the software. Moreover, the present invention represents a breakthrough in productivity, component reusability and collaborative development, through a holistic approach to the software life cycle. The present invention not only dramatically accelerates a software development schedule, but the developed components will be robust, flexible, and above all, reusable. The present invention separates conceptually between overall system design and concrete implementation, so that changes in practical details have no impact on the whole—to the extent that components can be removed or replaced in a system with as much ease as ejecting a DVD from its player and inserting another. The present invention integrates with Microsoft Visual Studio .NET. As a result, all the power and features of the .NET framework and toolset can be used, while rapidly accelerating the new software through the present invention's development experience.

The present invention (sembleWare™ Visual Welder™) can save the user a tremendous amount of time and energy in developing a system, by automating the most commonly performed tasks, encapsulating best practices, and leaving the user to do only the intelligent work of coding business rules. The present invention includes at least three features that create this productivity benefit: Instant Databases, Projects and Prototypes, Ready Made Parts, and Automatic Control Binding.

A very large proportion of conventional application development consists of repetitive infrastructure setup. Typically, a developer would have to:
Create a database, setting up each of its tables, with their respective fields, primary keys, foreign keys, etc.
Hand-code classes for all business objects in the application, including code to load and save data from and to the database.
Hand-design a presentation layer, manually binding all controls to the appropriate members of the business objects.
Repeatedly refresh structural changes to all three application layers, when required due to specification changes—all by hand.
   In Visual Welder™, however, practically all of the above tasks can be automated—from whichever direction the user chooses. If the user wishes to start from a database design, the user can create the entire database using the tool of his or her choice—ensuring that all primary and foreign keys are correctly set up—and then instantly create a Visual Welder™ project based on the database design.

If the user prefers to start by designing the business objects (parts), the user may do so using the Visual Welder™ add-in. At any point during the development of the project structure, the user can generate the database tables, fields and keys, in accordance with the most up-to-date business layer design. The user can do this as many times as he or she chooses; any changes that are made to the parts will be updated accordingly on the database. Once the project is created, using either of the above methods, the user can also generate an entire working prototype of the system—from the home page through data listings through capture and editing screens. All that remains is for the user to code the business logic, and make any desired cosmetic changes to the look and feel of the system.

There are a great many business objects in the development world that could be re-used in thousands of different applications, yet are not, because of different languages, syntax, conventions—or else simply because of the lack of facility for such an exchange. The present invention offers developers the opportunity to benefit from each other's expertise, using the part store on the sembleWare.com web site. Here the user will find a repository of reusable parts and assemblies of parts that can be downloaded, plugged into the project and used immediately, without any need for modification.

One of the most boring and time-consuming tasks facing a developer is the creation of a presentation layer, and the binding of all the controls to the appropriate properties of the underlying business objects. It gets even more complicated if on a single form the user wishes to represent two or more inter-related business objects. The present invention saves the user the drudgery behind this task, with the Active Toolbox. The Active Toolbox is an intelligent, dynamic palette of controls that may be created to represent all the parts, elements, relationships and actions applicable to the current context. All data loading and saving is encapsulated within the Visual Welder™ libraries, and the binding to form controls is totally automated.

The present invention uses a “Part” based design pattern to provide drag-and-drop assembly of applications. “Parts” are composed using one-sided relationships, making them highly reusable in other contexts and applications. The user can package his or her own Parts for later re-use, or download and plug-in parts from an Online Part Catalog, potentially saving countless hours of development time. The user can also use the present invention's three-dimensional Spatial Editor to “opens up” the insides of the system being designed to see how the inner “parts” fit together. The system or application can be shaped by manipulating the 3D model, or using the Active Toolbox, tailor list and grids using the List Designer. As the user works, the present invention dynamically generates all the VS.NET code needed to get a working application. Working applications can be created without writing a single line of code. Or the user can introduce as much code as is needed. The choice is up to the user. The user can prioritize his or her efforts and produce more system in less time.

In addition, the present invention can generate complex web forms, complete with working drop-down combos, header-detail support, SQL queries with joins, navigation buttons and more, which are driven by an easy-to-customize html template. The user can even apply a new template to a form that was previously created, whether it was generated or painted by hand, to get a whole new look-and-feel. In addition, web forms can be crafted by dragging-and-dropping from the Active Toolbox. The present invention tracks the “parts” on the form, and can determine when a textbox, checkbox, option button, dropdown combo or nested grid is needed. The present invention will “wire” the code-behind the user, including SQL joins, as the user drags and drops. The user can create cascading combos, user grid-limiters, and even combos with related fields that auto-update, without writing a line of code.

Moreover, the present invention creates a normalized data model for the user, based on the specified Parts and Relationships. Foreign keys, composite keys and other relational database constructs are managed for the user. In addition, the present invention will generate all the scripts needed to keep the database synchronized with the project, from the initial “create table” statements to the “alter table” statements for later changes. The scripts can be applied directly, or in accordance with your corporate standards for production systems.

The present invention can also be used to reverse-engineer a database to provide a working application complete with screens. An entire database or selected tables can be imported. Additional tables can even be imported into an existing application. As a result, the user can build running applications from legacy systems with a few clicks of a mouse.

Any system built using the present invention is scalable. The runtime environment is optimized for a stateless web environment. The system uses libraries containing best-practice usage of the NET framework, so the QA cycle can be reduced.

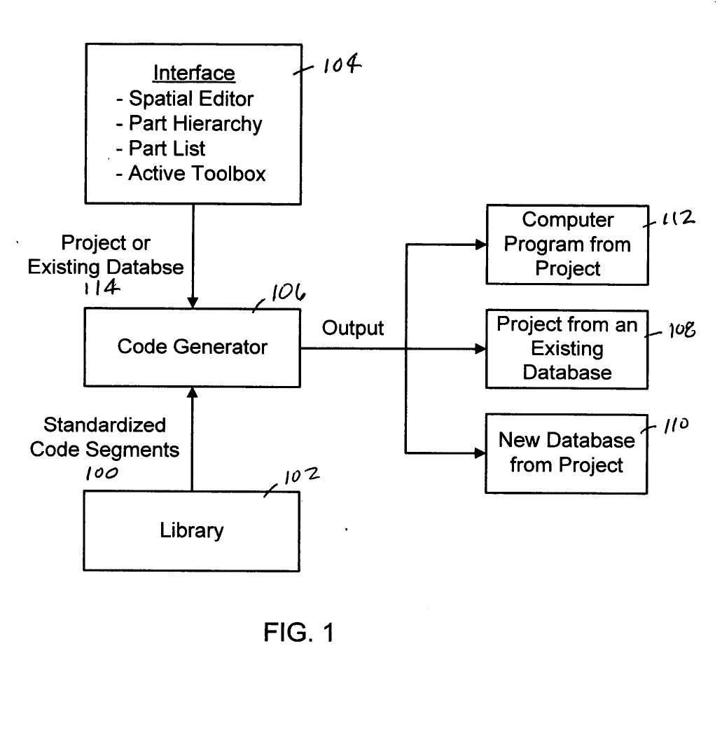

Now referring to FIG. 1, a block diagram illustrating the functionality and output of a computer program in accordance with one embodiment of the present invention is shown. The software development tool of the present invention includes a set of standardized code segments 100 stored in a library 102, an interface 104 for defining a structure of a project 114 and a code generator 106 communicably coupled to the library 102 (set of standardized code segments 100) and the interface 104. The code generator 106 creates the project from an existing database 108, or creates a new database from the project 110, or creates a computer program from the project 112. The structure includes one or more business rules that are implemented using the standardized code segments 100. The one or more business rules are automatically inserted into the project and the one or more business rules can include record deletion, validation before persisting, numbers, calculated fields, retrieve values for related parts, define the shape of a part, actions, action buttons, defaults or data structure relationship rules. The code generator 106 intelligently incorporates the standardized code segments into the project, generates one or more customized code segments in accordance with the structure and saved the generated code segments into the project 114. The standardized code segments typically are stored in the library 102 as machine code. The generated code segments are typically human readable code.

The interface 104 is a graphical user interface that includes two or more interface functions selected from the group comprising of a spatial editor, a part hierarchy, a part list and an active toolbox. The spatial editor displays a three dimensional representation of the structure of the project such that the structure of the project can be defined and modified by manipulating the three dimensional representation.

The present invention also provides a computer program embodied on a computer readable medium for developing software that includes a set of standardized code segments 100 stored in a library 102, a code segment for defining a structure of a project (interface 104), and a code segment for creating the project from an existing database (code generator 106 with output 108), or creating a new database from the project (code generator 106 with output 110), or creating a new computer program from the project (code generator 106 with output 112).

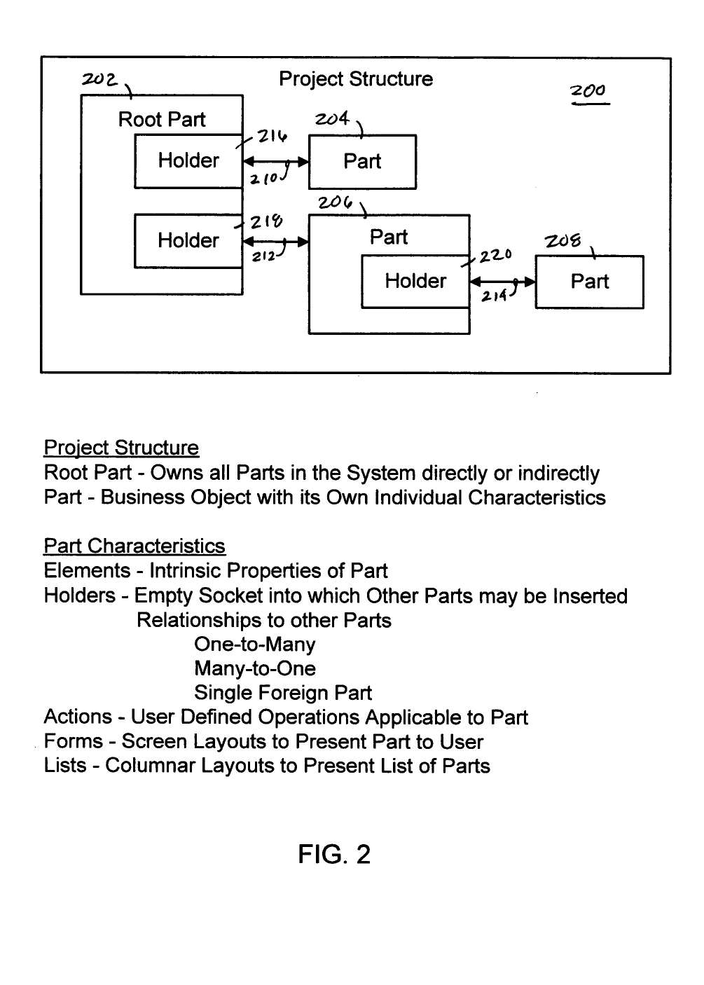

Referring now to FIG. 2, a block diagram illustrating the structural relationships of a project 200 in accordance with one embodiment of the present invention is shown. The structure 200 includes one or more objects 202, 204, 206 and 208 interconnected by one or more relationships 210, 212 and 214 to another part 204, 206 and 208. The one or more objects may include a root object (root part 202) and one or more other objects (parts 204, 206 and 208) directly or indirectly related to the root object (root part 202). The root part 202 directly or indirectly owns all parts 204, 206 and 208 in the system or project structure 200. Each part 204, 206 and 208 represents a business object having its own individual characteristics and properties. Each part 204, 206 and 208, including the root part 202, will have one or more characteristics, such as elements, holders 216, 218 and 220, actions, forms and lists. Each element represents an intrinsic property of the part and each holder represents a relationship between the part and another part. The element may be of a type selected from the group comprising identity, string, integer, single, number, datetime, Boolean and text. The holders 215, 218 and 220 are empty sockets into which other parts 204, 206 and 208 may be inserted. The holders 216, 218 and 220 are defined by a relationship 210, 212 and 214 selected from a group that includes a one-to-many relationship or a many-to-one relationship. Each action includes one or more user defined operations that are applicable to the part. Each form includes one or more screen layouts to present the part to a user. Each list includes one or more columnar layouts to display a list of the parts to the user.

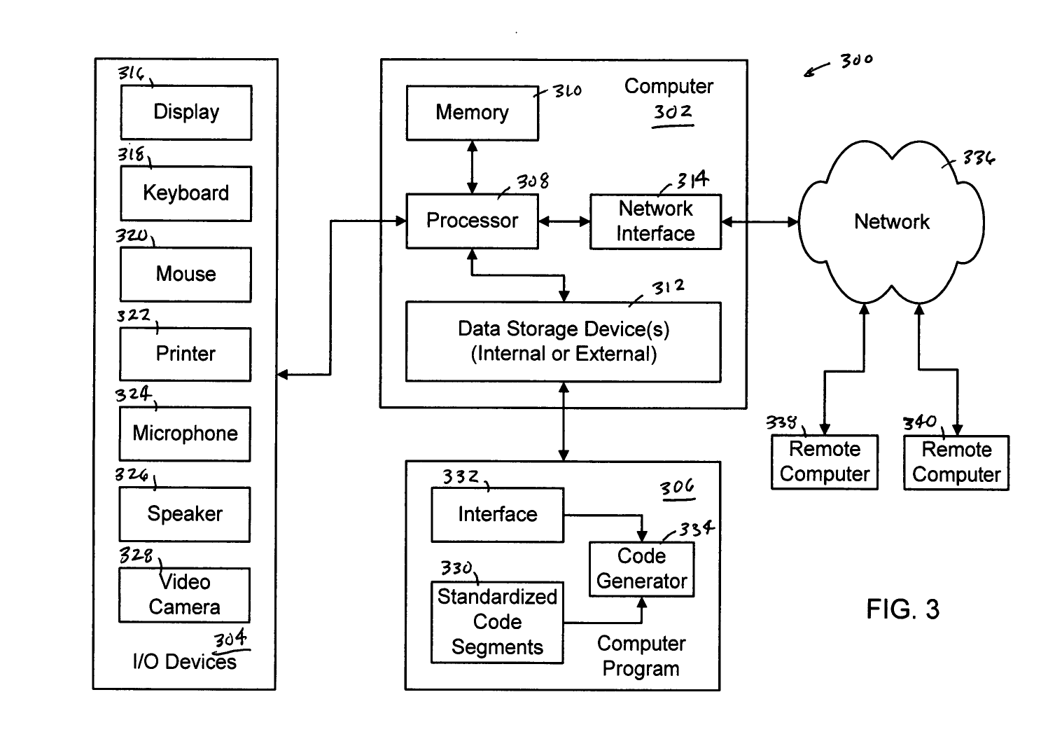

Now referring to FIG. 3, a block diagram of a system 300 in accordance with one embodiment of the present invention is shown. The system 300 includes a computer 302, one or more input/output devices 304 and a computer program 306. The computer 302 includes a processor 308, a memory 310 communicably coupled to the processor 308 and a data storage device 312 (internal or external) communicably coupled to the processor 308. The computer 302 may also include a network interface 314 communicably coupled to the processor 308. The one or more input/output devices 304 are communicably coupled to the processor 308 and can be selected from a group that includes a display 316, a keyboard 318, a mouse 320, a printer 322, a microphone 324, a speaker 326 and a video camera 328. The computer program 306 is stored in the memory 310 (during execution) and the data storage device 312 (during execution and non-use). The computer program 306 includes a set of standardized code segments 330, an interface 332 for defining a structure of a project, and a code generator 334 communicably coupled to the set of standardized code segments 330 and the interface 332. The code generator 334 creates the project from an existing database, or creates a new database from the project, or creates a computer program from the project.

The computer 302 can be a personal computer, workstation, laptop or server depending on the system configuration. The recommended minimum specifications for the computer 302 are a Pentium II 450 MHz processor, 160 MB RAM, 5 MB available hard disk space, a display and a mouse or comparable pointing device. The computer 302 should also have the following installed software: Microsoft® Windows NT® 4.0 with Service Pack 6 or later operating system (Windows 2000®, Windows XP®), Microsoft® Visual Studio® .NET™, and Microsoft® SQL Server® 7/2000.

The system 300 may also include a network 336 communicably coupled to the network interface 314 and one or more remote computers 338 and 340 communicably coupled to the network 336. The network 336 can be a local area network, a wide area network, such as the Internet, or any other configuration of linked computers. The remote computers 338 and 340 can be personal computers, workstations, laptops or servers depending on the system configuration. As a result, the computer program 306 can be installed on a single computer 302 or distributed over the one or more remote computers 338 and 340 in a client layer, a presentation layer, a business layer and a database layer.

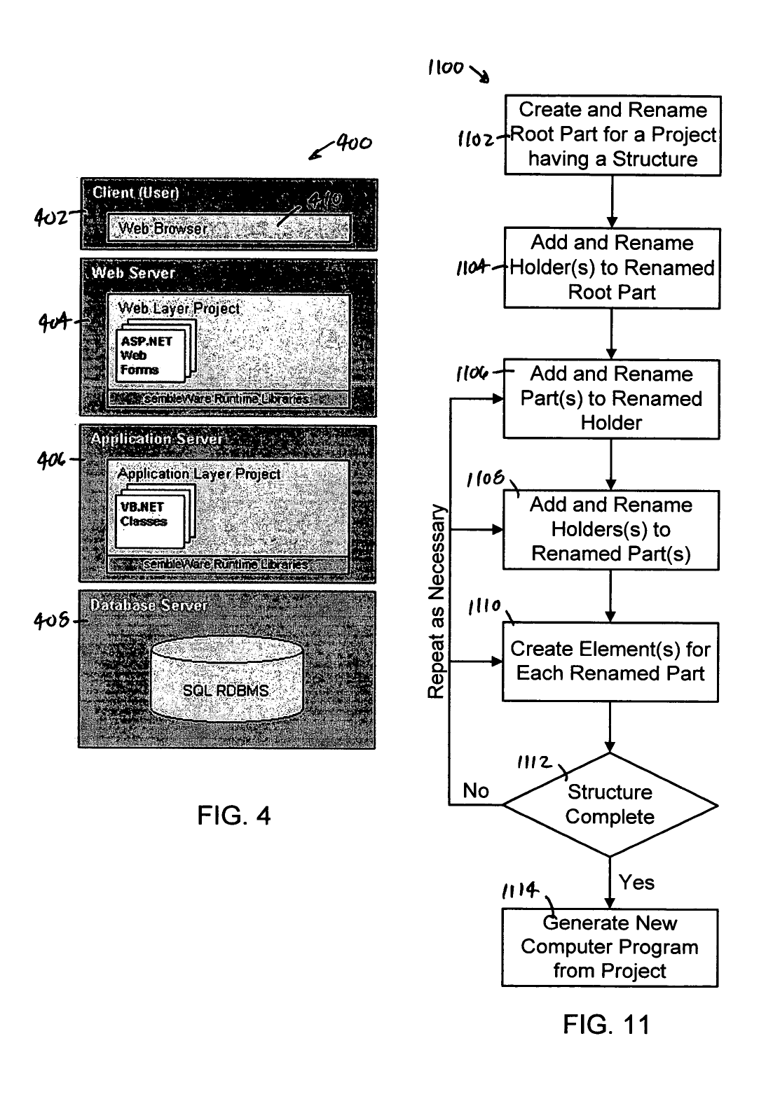

Referring now to FIG. 4, a block diagram of the various layers 400 of one embodiment of the present invention is shown. There are at least four layers in operation when the present invention is running: a client layer 402 running on the user's machine, a (web) presentation layer 404, a business or application layer 406 and a database layer 408. The present invention can be deployed in less than 4 tiers; if desired, the client 402 as well as the web 404, application 406 and database 408 servers could all be placed on a single machine, though for performance reasons this may not be desirable.

The presentation layer 404, which runs on a web server, contains all the aspx forms in the project, which will usually all be descendants of the present invention. The user interacts with this layer 404 using a web browser 410, and navigates through the forms in the system, along paths defined in accordance with the present invention's navigational structure, using buttons that are usually created using the Active Toolbox. These buttons may also be used to perform actions on the parts in the system. The business layer 406, which runs statelessly on an application server, contains all the part classes in the project. These classes contain all the code that implements elements and relationships. The part contains elements from as many as three layers (presentation layer 404, business layer 406 and database layer 408). The database 408 lies beneath the business layer 406. The present invention always implements concurrency protection, in order to protect the data from corruption arising from simultaneous editing of the same record.

While most (if not all) of the code required for the present invention's system is automatically generated by the program, this information is provided to equip the developer with an understanding of the structures involved, and therefore the ability to write efficient, correct custom code where this is required. It is also important to note that for the sake of preserving plug-and-play-ability, there are certain guidelines for writing safe code that should always be adhered to.

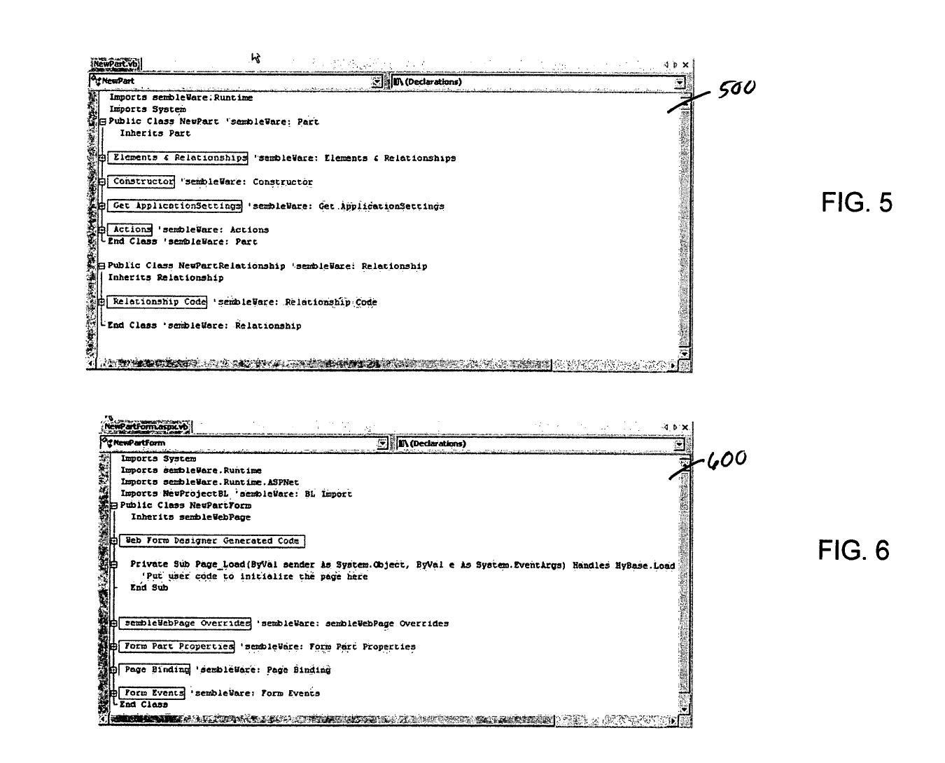

Now referring to FIG. 5, a window 500 illustrating the format of the code of a part class is shown. As is apparent, the class file contains two classes—one representing the part itself, and one to be used by other classes that have relationships to this class. The four regions in the part code contain, as implied by their descriptions, (a) the structural definition of the part in terms of elements and relationships, (b) a constructor, (c) code to trap change events of elements and relationships, and (d) code to be executed when actions are performed on the part. Inside the “Elements and Relationships” region is code of the following structure:

```
‘sembleWare: Elements Start - Do Not Modify
Public ReadOnly RegionCode As New StringElement(“RegionCode”,
Me, True,
  True, True, True, True, 3, Nothing, Nothing, Nothing, Nothing,
  Nothing)
Public ReadOnly RegionName As New StringElement(“RegionName”,
Me, False,
  True, True, True, False, 30, Nothing, Nothing, Nothing, Nothing,
  Nothing)
Public ReadOnly Parent As Relationship = New
AppRootRelationship(“Parent”,
  Nothing, RelationshipType.OwnedBy, True, True, True, Me)
‘sembleWare: Elements End - Do Not Modify
#Region “ Foreign Items”
  ‘sembleWare: Foreign Items Start - Do Not Modify
  Public ReadOnly_Parent As AppRootRelationship = Parent
  ‘sembleWare: Foreign Items End - Do Not Modify
#End Region ‘sembleWare: Foreign Items
#Region “ Indicator Options”
  ‘sembleWare: Indicator Options Start - Do Not Modify
  ‘sembleWare: Indicator Options End - Do Not Modify
#End Region ‘sembleWare: Indicator Options
```

It will be noted that there are a number of “Do Not Modify” comments all through the code. The code inside these blocks is generated, and any developer code that is inserted here will be lost the next time the part is regenerated.

The constructor is relatively simple:

```
Public Sub New(ByVal ApplicationSettings As ApplicationSettings)
    ‘sembleWare: Constructor Start - Do Not Modify
    MyBase.New(“Region”, ApplicationSettings)
    ‘sembleWare: Constructor End - Do Not Modify
End Sub
```

Thus far, there has been no need for the developer to add anything to the generated code. The “Change Events” and “Actions” regions, however, are where developer code may be necessary. This, in fact, is one of the main benefits of using the present invention: the developer can focus on business logic, and leave the repetitive structural work to the present invention.

The relationship class is entirely generated, and no developer code is necessary here. It contains a number of constructors and methods, used internally by foreign parts that have relationships to this part; the usage of this code is beyond the scope of this documentation. The code is typically of the following format:

```
‘sembleWare: Relationship Start - Do Not Modify
Public ReadOnly_RegionCode As ForeignKey = New ForeignKey(Me)
Public Sub New(ByVal ApplicationSettings As ApplicationSettings)
    MyBase.New(ApplicationSettings)
End Sub
Public Sub New(ByVal Name As String, ByVal Caption As String,
ByVal Type As
    RelationshipType, ByVal Mandatory As Boolean, ByVal
    Enabled As
    Boolean, ByVal Persist As Boolean, ByVal Owner As Part)
  MyBase.New(Name, Caption, Type, Mandatory, Enabled, Persist,
  Owner)
End Sub
Public Sub New(ByVal Name As String, ByVal Caption As String, ByVal
    OwnedByName As String, ByVal Owner As Part)
  MyBase.New(Name, Caption, OwnedByName, Owner)
End Sub
Public Overrides Function CreateObject() As sembleWare.Runtime.Part
  Return New Region(ApplicationSettings)
End Function
Public Overrides Sub MapForeignKeys(ByVal Instance As
    sembleWare.Runtime.Part)
  _RegionCode.ForeignElement = CType(Instance, Region).RegionCode
End Sub
‘sembleWare: Relationship End - Do Not Modify
```

Referring now to FIG. 6, a window 600 illustrating the format of the code of a form class is shown. The “Web Form Designer Generated Code” and “sembleWebPage Overrides” regions contain no developer modifiable code, and should not be tampered with. In the “Form Part Properties” region is code of the following structure:

```
Private ReadOnly Property Region() As Region
    Get
        Return SuppliedPart(“Region”, New
        RegionRelationship(ApplicationSettings))
    End Get
End Property
Private ReadOnly Property StatusList() As List
    Get
        Return PreservedList(“Status”, Region._Status.List)
    End Get
End Property
```

For each part or list that is represented on the form, there will be a property in the form code that acts as an accessor for the part or list. Note that the list accessor, representing a nested part on the form, refers to the part accessor of the primary part of the form.

The “Page Binding” region contains two very significant methods. BindPage( ) synchronizes the values of the form controls with the applicable elements:

```
Private Sub BindPage(ByVal BindRegion As Boolean)
    ‘sembleWare: Bind Page Start - Do Not Modify
    ‘ Bind Region part and related lists
    Dim oRegion As Region = Region
    If BindRegion Then
        BindElement(txtRegion_RegionCode, oRegion.RegionCode)
        BindElement(txtRegion_RegionName, oRegion.RegionName)
    End If
    ‘sembleWare: Bind Page End - Do Not Modify
End Sub
```

SavePage( ) persists the data from the page to the database:

```
Private Sub SavePage(ByVal SaveRegion As Boolean)
    ‘sembleWare: Save Page Start - Do Not Modify
    ‘SavePage is a helper method that binds and saves specified parts
        on the page, with one call.
    ‘It is designed for use in ‘Submit’ and ‘Apply’ type buttons.
    ‘ Bind the appropriate parts
    BindPage(SaveRegion)
    ‘ Save Region if specified
    Dim oRegion As Region = Region
    If SaveRegion And Not oRegion.IsNullInstance Then
        oRegion.Save()
    End If
    ‘sembleWare: Save Page End - Do Not Modify
End Sub
```

In the “Form Events” region are the event methods from the form and the buttons:

```
Private Sub RegionEditForm_RenderParts() Handles MyBase.RenderParts
    ‘sembleWare: Render Parts Start - Do Not Modify
    BindPage(True)
    ‘sembleWare: Render Parts End - Do Not Modify
End Sub
Private Sub btnSubmit_Click(ByVal sender As System.Object,
ByVal e As
        System.EventArgs) Handles btnSubmit.Click
    ‘ Button Code: Generated by sembleWare - Start
    SavePage(True)
    NavigateUp()
    ‘ Button Code: Generated by sembleWare - End
End Sub
Private Sub btnApply_Click(ByVal sender As System.Object, ByVal e As
        System.EventArgs) Handles btnApply.Click
    ‘ Button Code: Generated by sembleWare - Start
    SavePage(True)
    ‘ Button Code: Generated by sembleWare - End
End Sub
Private Sub btnCancel_Click(ByVal sender As System.Object,
ByVal e As
        System.EventArgs) Handles btnCancel.Click
    ‘ Button Code: Generated by sembleWare - Start
    NavigateUp()
    ‘ Button Code: Generated by sembleWare - End
End Sub
```

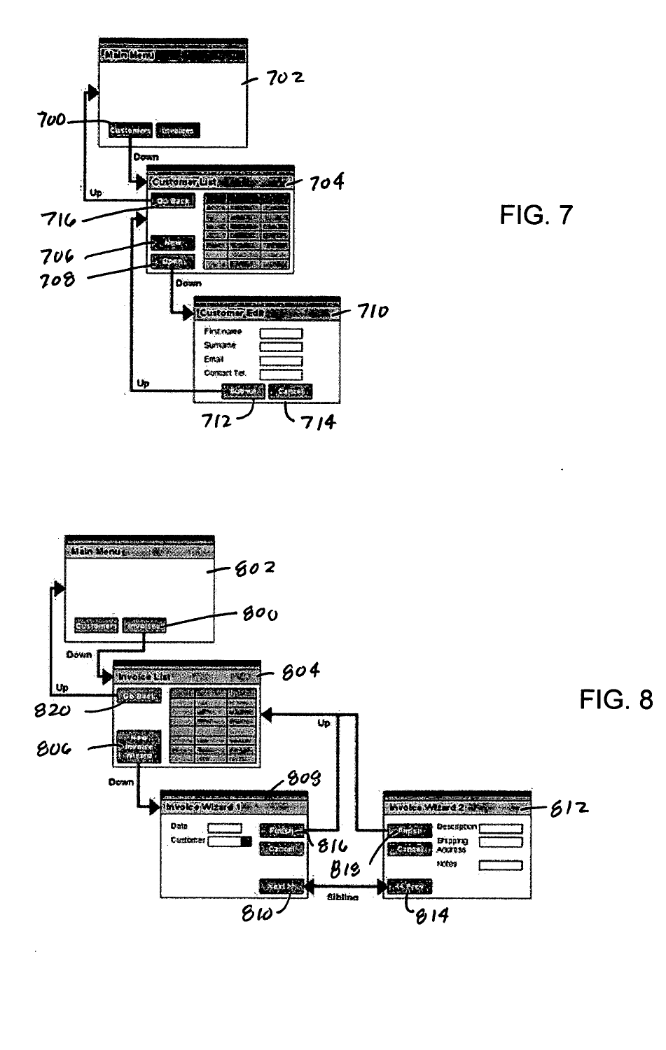

Referring now to FIGS. 7 and 8, the navigation structure of the present invention is illustrated. On most web sites, there is a common navigational structure: the user arrives first at the home page, and from there navigates deeper to various pages within the site, often zooming into greater levels of detail. Navigation through forms in the present invention works in a hierarchical structure that reflects this pattern. From the home/start page of the system, navigation is effected by moving down (zooming in to a greater level of detail), up or sideways. A simple up/down structure is shown in FIG. 7 where the “Customers” button 700 on the Main Menu 702 navigates down to the “Customer List” form 704, and the “New” button 706 and the “Open” button 708 both navigate down to the “Customer Edit” form 710. The “Submit” 712, “Cancel” 714 and “Go Back” 716 buttons all navigate up—and these do not specify to which form they should navigate, because “up” means to whichever form last navigated down. When moving down through the system, a page call stack is maintained, which keeps a record of the path traversed to reach the current page, as well as a pool of all parts required for pages at higher levels of the stack. When navigating downwards, the parts from the origin page are added to the part pool; upward navigation reverses this process.

Often there is a call to navigate sideways, as is the case in the creation of a “Wizard” as shown in FIG. 8. When navigating sideways to a “sibling” form, the page call stack is left intact, so that the sibling form will have the same “parent” as the origin form when it later navigates upwards. For example, the “Invoices” button 800 on the “Main Menu” 802 will navigate down to the “Invoice List” form 804, and the “New Invoice Wizard” button 806 will navigate down to the “Invoice Wizard 1” form 808. The “Next” button 810 on the “Invoice Wizard 1” form 808 will navigate sideways to the “Invoice Wizard 2” form 812. Similarly, the “Prev” button 814 on the “Invoice Wizard 2” form 812 will navigate sideways to the “Invoice Wizard 1” form 808. The “Finish” buttons 816 and 818 on “Invoice Wizard 1” form 808 and “Invoice Wizard 2” form 812, respectively, will navigate up to the “Invoice List” form 804. The “Go Back” button 820 on the “Invoice List” form 804 will navigate up to the “Main Menu” 802.

When navigating down or sideways, the Button Designer will frequently require that parts be passed to the destination page. These may be obtained from the current form—either by passing a part as-is from the form, or from the selected item in a DataGrid. It is possible to specify that the required part will be obtained in user code—i.e. code hand-written by the developer. In this case, the developer will need to write form code in the button's “Click” event, to supply the required part or parts, using the SupplyPart( ) method. It is also possible to specify that the required part is already available in the page call stack (even though it is not explicitly available on the current page). In this case, it is the programmer's responsibility to ensure that the required part is indeed available in the stack.

The present invention calls forms in a hierarchical structure, with navigation calls moving between sembleWebPages in clear directions—up, down or sideways. When moving down the hierarchy, the present invention maintains a call stack that keeps track of the navigational path traversed, so that when moving up, there is no need to specify the destination form; this is simply popped from the page call stack. When moving sideways (to a “sibling” form), the page call stack is unaffected. Also on the page call stack are stored any part instances that are needed for forms higher up in the navigational hierarchy. These are accessible to all forms lower down in the hierarchy, using the SuppliedPart method.

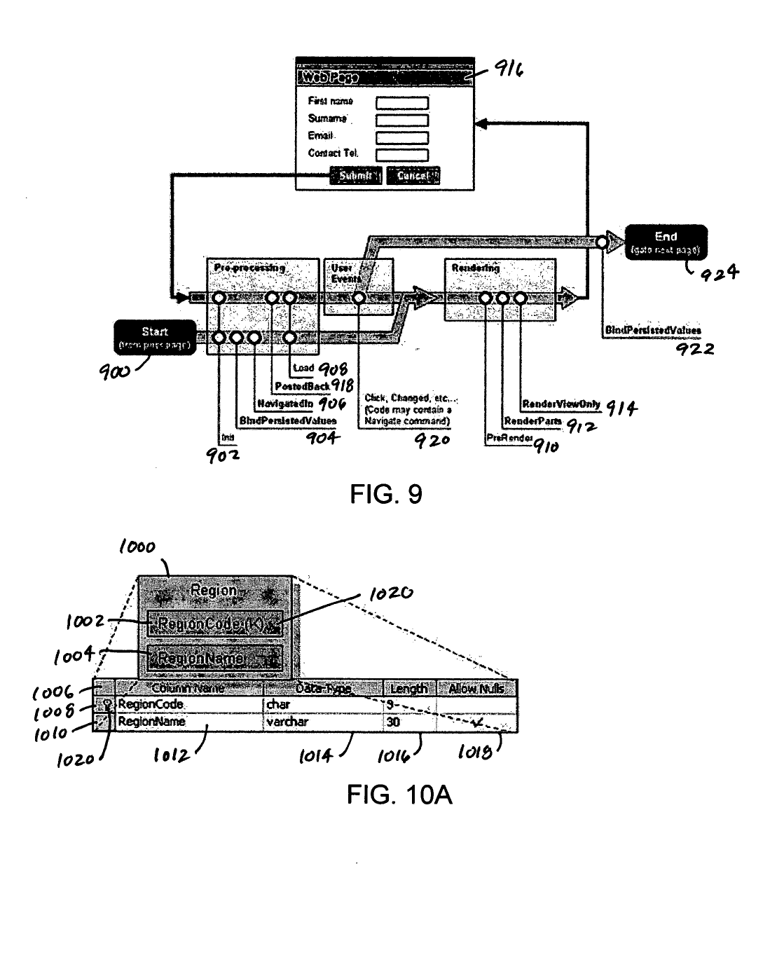

All forms within the present invention (also referred to as a sembleWare™ system) are created as descendants of the sembleWebPage class. This gives them inherited functionality that encapsulates best practices, and reduces the amount of actual code required on a form. As shown in FIG. 9, the sembleWebPage itself is a descendant of Page, and therefore has the same events as a standard web page, plus a few extra. There are two scenarios from which a sembleWebPage begins to work: when it receives control from another page (or from direct navigation); and when it is invoked by a post-back from the browser.

When control is received from another page 900, the pre-processing sequence begins where the first event that fires in the form code is Init 902, which is inherited from Page. Then the BindPersistedValues 904 and NavigatedIn 906 events fire, which, as shown in the diagram, are only raised when the page is being navigated to from a previous page. In these events, the developer may place any code that is specific to the first time the page is loaded. After this, the standard Load event 908 inherited from Page is fired. Thereafter, the rendering sequence executes wherein the page is prepared to be shown in the client browser. After the standard Page PreRender event 910, the sembleWebPage's RenderParts event 912 is called. This event must be trapped in order to set the values of the form controls as per the corresponding elements and relationships; the Visual Welder™ add-in automatically generates the necessary code. The RenderViewOnly event 914 is fired only when the form is to be displayed in view-only mode. This event is useful if it is desirable write additional code to disable or enable controls on view-only forms. At this point, the form 916 is fully displayed in the client browser, and the web server goes into stateless mode, until the user invokes a post-back, either by clicking a button or by changing the value of a control whose AutoPostBack property is set to True.

When a post-back is received, the page again goes through the pre-processing sequence—but this time it fires different events. As before, the Init event 902 fires first, after which the PostedBack event 918 is called (instead of BindPersistedValues and NavigatedIn). This is followed by the Load event 908. Once the reloading process is complete, any events 920 raised by form controls (such as TextChanged, Click etc.) are called in the form code. If no navigation calls are made in the form code, then the form continues through the rendering sequence as before; if a navigation call is made, this page ceases to load, the BindPersistedValues event 922 fires, and control is passed to the next page 924.

Like any standard web application, if an exception is thrown during a post-back, the browser will navigate to a standard error page, which will display the details of the exception thrown. The sembleWebPage, however, offers an alternative: on-page error handling. This is often a far more desirable behavior, since it enables the developer to display the error message on the same page, without giving the appearance of a system error. For example, on a simple login screen, the developer might wish to raise an exception if the password supplied is incorrect. In this case, it would be appropriate simply to display the exception message on the form, and allow the user to attempt to log in again.

On-page error handling is facilitated by a specific control from the Active Toolbox: the Error Message Label, which is found on the control palette when “Form” is selected in the Form Parts Panel. Simply drop an Error Message Label on the form, and if any exceptions are thrown during post-backs, instead of navigating to the error page, the browser will remain on the same page, and this label will display the exception message.

In order to maximize the scalability of Visual Welder™ applications, the architecture is built using a stateless business layer. This means that even while the client (presentation layer) is active, and a user may be filling in all manner of data, the server (business layer) is dormant until the client posts data back. This stateless model drastically reduces load on the server, and enables any application to be fully web-enabled, potentially supporting thousands of simultaneous users, with relatively little demand for hardware resources.

The abstract class Part acts as the common ancestor for all business objects created within the sembleWare™ framework. Each part consists of the following:
Elements are a part's intrinsic properties—i.e. those that are logically defined within this business object. So, for example, “Date” would be an element of an “Invoice” part.
Relationships to other parts (represented by holders in the Part Hierarchy). Visual Welder™ automatically imports any foreign keys from the related parts. “Customer” would be a relationship within an Invoice and not an element; its primary key would therefore be included as a foreign key within Invoice.
Actions are not objects in the runtime environment. They are implemented simply as methods within the code of the part.
Custom lists (not default lists) are implemented as method calls in the part's relationship class.

There are two derived classes of Part in the sembleWare™ architecture: DBPart and MemoryPart. DBPart or “database part” is a part that persists its data—its elements and the foreign keys of its relationships—to a relational database table. Database parts may optionally have a concurrency element to protect the data integrity of multiple-user systems, as well as an identity element—an automatically generated numeric field that uniquely identifies the part. MemoryPart or memory part is a part that does not have implicitly persistent data; the data within the part are generated and maintained only within the object itself. Typically this would be used to represent a business object whose possible values are predetermined and fixed, such as a “Status” part, whose available values might be limited to “Pending”, “Approved” and “Rejected”. For such a part, it would be a waste of database and system resources to create a table in a relational database; all the necessary data could rightfully be hard-coded within the part.

Parts may also be used to wrap legacy systems and integrate them into sembleWare™ systems. If, for example, you had a legacy banking system that contained information about customers, and you want to create a new sembleWare™ system that works with these customers, you can create a part that references the legacy system and implements the appropriate overrides. The legacy system is then fully integrated into your sembleWare™ system.

It is possible for a 3rd party organization to create a sembleWare™ part that interfaces with its own web services, for use in Visual Welder™. For example, a company that provides credit card authorization services may develop a part that can plug into any Visual Welder™ system that allows for integrated credit card authorization within the system, by seamlessly communicating with the company's own web services.

An element defines an intrinsic property of a part. Each element has properties such as name and data type, as well as properties defining whether and how the element is persisted to a relational database. Relationships are connectors that define the way parts relate to each other. They have one-sided definitions, i.e. only one of the parts involved in the relationship explicitly relates to the other. Every part that is created by the sembleWare™ add-in, is generated with a “ . . . . Relationship” class in the same class file. This relationship class comes with two constructors—one for Include->OwnedBy relationships, and one for OwnMany relationships. Please note that the relationship class code, as well as all code that refers to it, is unsafe code, and should not be addressed or manipulated directly by the developer.

As previously mentioned, it is considered “unsafe” programming to write code explicitly referring to foreign classes. The need still exists, however, for parts to be able to interact with related parts—and for this reason, the sembleWare™ add-in generates a “wrapper class” for every relationship in a part. The wrapper class encodes the shape—i.e. the expected properties—of any part that might be plugged in to that relationship. For example, an “Invoice” part might have an Include relationship to “Customer”. Invoice's “Customer” relationship might element sockets called “Name” and “Address”. The wrapper class, WrappedCustomer, will therefore have properties “Name” and “Address”.

Now it does not matter what actual part is plugged into the “Customer” relationship; all that matters is that the part should have these two properties—even if labeled by different names. The wrapper class will handle the property mapping to the actual part internally, while the developer's code in the rest of the “Invoice” class should refer only to the properties of the wrapper class. The wrapper class allows the developer to address related objects in a safe way, maintaining plug-and-play-ability.

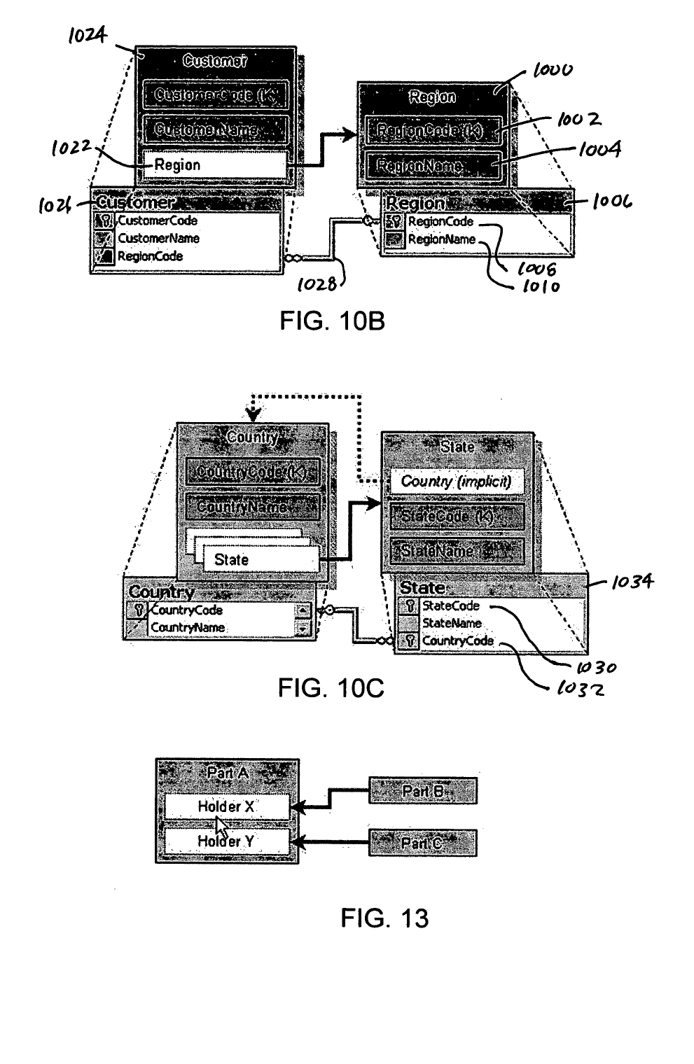

Now referring to FIGS. 10A, 10B and 110C, the relationships between the present invention and the relational database are illustrated. The “Region” part 1000 includes “RegionCode” element 1002 and “RegionName” element 1004. Any parts, such as “Region 1000, that have their Persist property is set to True are mapped to a single database table, such as 1006. The persisting elements of the part (“RegionCode” 1002 and “RegionName” 1004) are mapped to fields 1008 and 1010, respectively, within that table 1006, with data types and lengths according to the ElementType and MaxLength properties of each element respectively (e.g., “Column Name” 1012, “Data Type” 1014, “Length” 1016 and “Allow Nulls” 1018). Key elements 1020 are marked on the database as being part of the primary key of the table.

When a part has an Include relationship to another part, it imports the primary key fields of the foreign part to its underlying table. Note that the Include holder 1022 in the “Customer” 1024 part into which the “Region” part 1000 is plugged is effectively soft-coded. As a result, if the “Region” part 1000 was replaced with a different part, the change would be seamless as far as the “Customer” part 1024 is concerned. On the other hand, on the database level, the foreign key 1028 from the Customer table 1026 to the Region table 1006 is of necessity hard-coded. If the “Region” part 1000 was swapped out for another part, Visual Welder™ will need to re-generate the database in order to effect the necessary changes to the Customer table 1026.

Although an OwnMany relationship is created on the owner part, on the database level, the foreign key is created on the owned part. This reflects the bidirectional nature of the OwnMany relationship, since it always creates a reciprocal OwnedBy relationship on the owned part. The OwnedBy relationship, whether created implicitly (as is the case in FIG. 10C) or explicitly, behaves identically to the Include relationship in the way it maps to the database—with one exception: the foreign key created for this relationship is also made part of the primary key of the local table. Accordingly, in the example, CountryCode 1030 is added to StateCode 1032 to comprise the primary key of the State table 1034.

In multi-user environments, there is often a risk of more than one user editing a record simultaneously. To prevent data corruption arising from these circumstances, Visual Welder™ performs concurrency checking every time data is persisted. This ensures that the edited record has not been modified since it was loaded into local memory. The default concurrency check is performed by comparing the load value of all elements of the part being persisted, with the current values of all corresponding fields on the database table to which the part is mapped. Should these not match, an error message is displayed to the effect that another user has already modified the record.

For parts with large numbers of elements, this method can be expensive from a performance perspective. A more efficient method of concurrency checking is available, at the price of an extra integer field on the database table. The developer may optionally specify a concurrency element name in the properties of the part. This concurrency element is then automatically updated every time a user updates the database record, and is the only field compared for concurrency when persisting data.

sembleWare™ has been designed to provide the developer with a maximum of productivity with a minimum of effort. Around 90% of the code in a typical system is standard textbook design, which is taken care of by the sembleWare™ add-in; there should be no need to make any modifications directly to the class code. There are, however, times when something out of the ordinary has to be done—for example, complex mathematical or business rules—and this needs to be written manually in the class code. In such cases, it is strongly recommended that the guidelines listed here are followed to ensure safe code.

One of the principal features of sembleWare™ is the ability to swap parts seamlessly, without having to modify code in several places. This is achieved by having relationships to other parts that do not explicitly specify to which concrete part they refer. It will be noted in the class code, that relationships to other objects are generated in the following declaration format:
Public ReadOnly ForeignPart As Relationship=New ForeignPartRelationship( . . . )
   When using the relationship ForeignPart, the code will refer to this object variable—not to the actual class that is being referred to by that relationship. This maintains plug-and-play-ability, since the remote class can easily be substituted without breaking the code in the local class.

It should never be necessary to make direct references to another class from within a part—even to the “Relationship” classes (such as ForeignPartRelationship above); indeed, doing so would hard-code the bond between the two classes, and hinder the plug-and-play-ability of the system. Instead, reference can be made to the wrapper classes that are generated by the add-in for each relationship (e.g. WrappedForeignPart).

There is a lot of code in the part classes that is generated by the sembleWare™ add-in, and is commented as such. This code defines the structure of the part. It is not advisable to attempt to alter this code directly—rather, the developer should use the add-in itself to make any desired changes to the structure of the part. It will be noted that there are typically several object variables declared in the generated code, with names beginning with an underscore (“_”) These variables represent “unsafe” variables that are dynamically generated by Visual Welder™, and are continually renamed, added and removed as parts are plugged in and out of the system.

If the developer makes explicit reference to these variables, this hard-codes a relationship to a remote part. If the relationships between parts are later manipulated or even renamed, the generated code will change—but the developer code will not, creating a certain instability in the system. There should always be a way to accomplish the intended goal without making explicit reference to “underscore” variables, using wrapper classes.

Now referring to FIG. 11, a flow chart of a method 1100 in accordance with one embodiment of the present invention is shown. The method 1100 for generating a new computer program uses a software development tool by (a) creating and renaming a root part for a project having a structure in block 1102, (b) adding and renaming one or more holders to the renamed root part in block 1104, (c) adding and renaming a part to one or more of the renamed holders in block 1106, (d) adding and renaming one or more holders to the renamed parts in block 1108, (e) creating one or more elements for each renamed part in block 1110, (f) repeating steps (c), (d) and (e) as needed to complete the structure as illustrated by decision block 1112, and (g) generating the new computer program from the project in block 1114. This method can be implemented using a computer program embodied on a computer readable medium wherein each step is executed by one or more code segments. The renamed holders establish relationships between the renamed root part and renamed parts.

In addition, the method 1100 may include the steps of designing the project by identifying the parts, relationships and elements of the project, creating the project, setting one or more properties of the project, or coding one or more business rules for the project. The method 1100 may also include the steps of generating a database from the project, creating one or more forms from the project, or executing the new computer program. The renamed root part, the renamed part(s), or the renamed holder(s) may also be modified. The method 110 can be implemented using a spatial editor or a part hierarchy. The spatial editor displays a three dimensional representation of the structure of the project that can be used to define and modify the structure by manipulating the three dimensional representation.

The one or more business rules are automatically inserted into the project and the one or more business rules can include record deletion, validation before persisting, numbers, calculated fields, retrieve values for related parts, define the shape of a part, actions, action buttons, defaults or data structure relationship rules. The one or more relationships are selected from a group comprising a one-to-many relationship or a many-to-one relationship. Each element is of a type selected from the group comprising identity, string, integer, single, number, datetime, Boolean and text. Each renamed part further comprises an action, a form or a list. Each action comprises one or more user defined operations that are applicable to the renamed part, each form comprises one or more screen layouts to present the renamed part to a user, and each list comprises one or more columnar layouts to display a list of the renamed parts to the user.

The present invention also provides a system (see FIG. 3) that includes a computer and a computer program. The computer includes a processor, a memory communicably coupled to the processor, a data storage device communicably coupled to the processor, and one or more input/output devices communicably coupled to the processor selected from a group comprising a display, a keyboard, a mouse, a printer, a microphone, a speaker and a video camera. The computer program is stored in the memory and data storage device and performs the following steps: (a) creating and renaming a root part for a project having a structure, (b) adding and renaming one or more holders to the renamed root part, (c) adding and renaming a part to one or more of the renamed holders, (d) adding and renaming one or more holders to the renamed parts, (e) creating one or more elements for each renamed part, (f) repeating steps (c), (d) and (e) as needed to complete the structure, and (g) generating the new computer program from the project.

The system may also include a network interface communicably coupled to the processor, a network communicably coupled to the network interface and one or more remote computers communicably coupled to the network. The computer program can be distributed over the computer and one or more remote computers in a client layer, a presentation layer, a business layer and a database layer.

The computer program may also perform the steps of coding one or more business rules for the project, generating a database from the project, creating one or more forms from the project, or executing the new computer program. In addition, the computer program may modify the renamed root part, the renamed part(s), or the renamed holder(s).

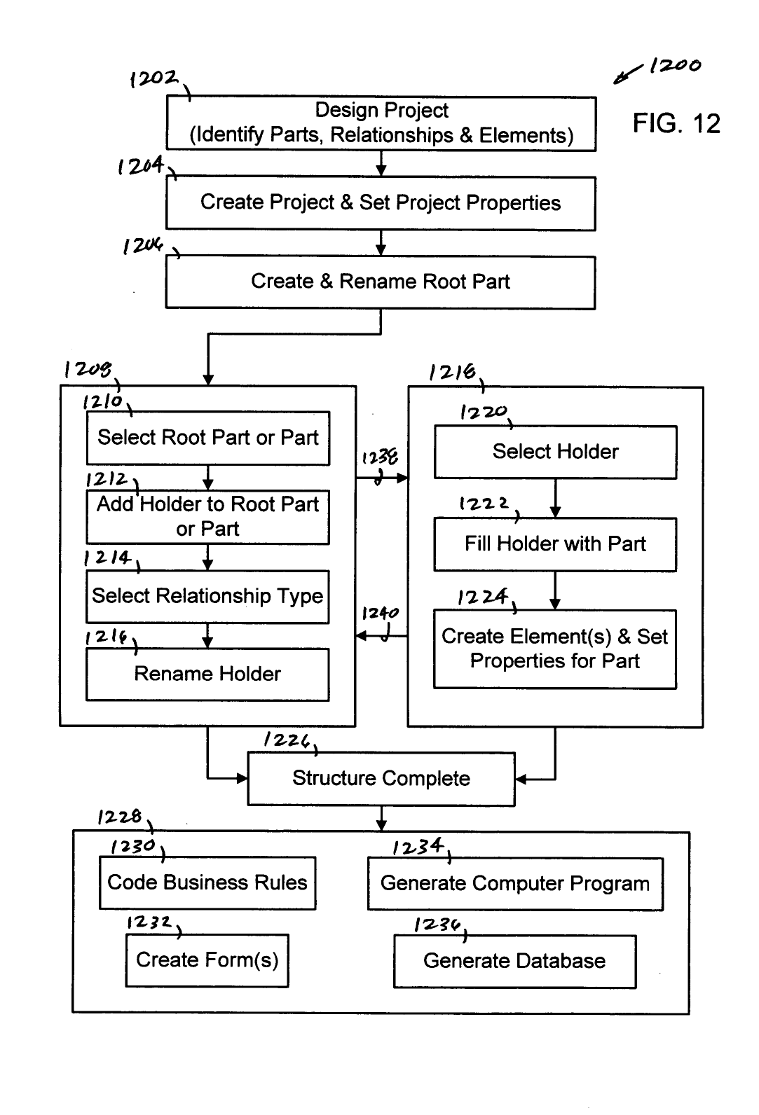

Referring now to FIG. 12, a flow chart of a method 1200 in accordance with another embodiment of the present invention is shown. The project is designed in block 1202 by identifying parts, relationships and elements that will form the structure of the project. The project is then created and its properties are set in block 1204. A root part is created and renamed in block 1206. Block 1208 and 1218 represent the add a part and add a holder functions, respectively. These functions 1208 and 1218 are repeated in virtually any order until the structure is complete in block 1226 as illustrated by arrows 1238 and 1240. The add a holder function 1208 includes selecting the root part or a part to which a holder is to be added in block 1210. The holder is added to the root part or other part in block 1212. The relationship type for the holder is selected in block 1214 and the holder is renamed in block 1216. The add a part function 1218 includes selecting a holder for which the part is to be inserted in block 1220 and filling the holder with the part in block 1222. Various element(s) are created and properties are set for the part in block 1224. Once the structure is complete in block 1226, various additional functions can be performed, e.g., coding business rules in block 1230, create form(s) in block 1232, generate a computer program in block 1234 and generate a database in block 1236.

The principles and practicality of working with the present invention will now be described in more detail in reference to FIGS. 13-36. A system designed using the present invention includes a set of parts interconnected via a network of relationships. Starting with the “root” or “application” part, each part contains any number of holders. Each part represents a business object, with its own individual characteristics and behavior. The holders are simply empty sockets into which other parts may be inserted; these other parts may, in turn, contain further holders, making a theoretically infinite recursive structure. The sum of these parts is the complete system; the complexity comes from how the parts themselves function internally, as described in detail below.

In the sembleWare™ paradigm, re-use of code goes beyond simply copying and pasting. Not only is it possible to re-use parts, as they are, but the integration of those parts requires minimal, if any, rework to the present assembly. As illustrated in FIG. 13, within any part—and particularly the root part—it is possible to create holders, which in essence are conceptual blanks to be filled by concrete parts. They are analogous to the sockets at the back of a computer, of all sorts of shapes and sizes. They are simply holders for the peripheral devices that will later be plugged in to these sockets. For example, part A includes Holder X and Holder Y. Part B plugs into Holder X and Part C plugs into Holder Y.

When creating a system, it is not necessary to have a concrete part ready to plug in; it is only necessary to identify that there will be a need for such a part. As and when such needs are identified, holders may be created to satisfy them; they need only be filled with “real” parts when development reaches the appropriate level of detail. Once the nature of all the business objects that will be required for the system has been identified, and a holder corresponding to each has been created, these may be filled with concrete parts. This may be done either by creating a new part from scratch, or by selecting an existing part and plugging it in to the holder. Furthermore, should the system needs change at any point in the future, it is a virtually trivial matter to unplug an obsolete part, and plug in a more appropriate one, without adversely affecting the remainder of the system.

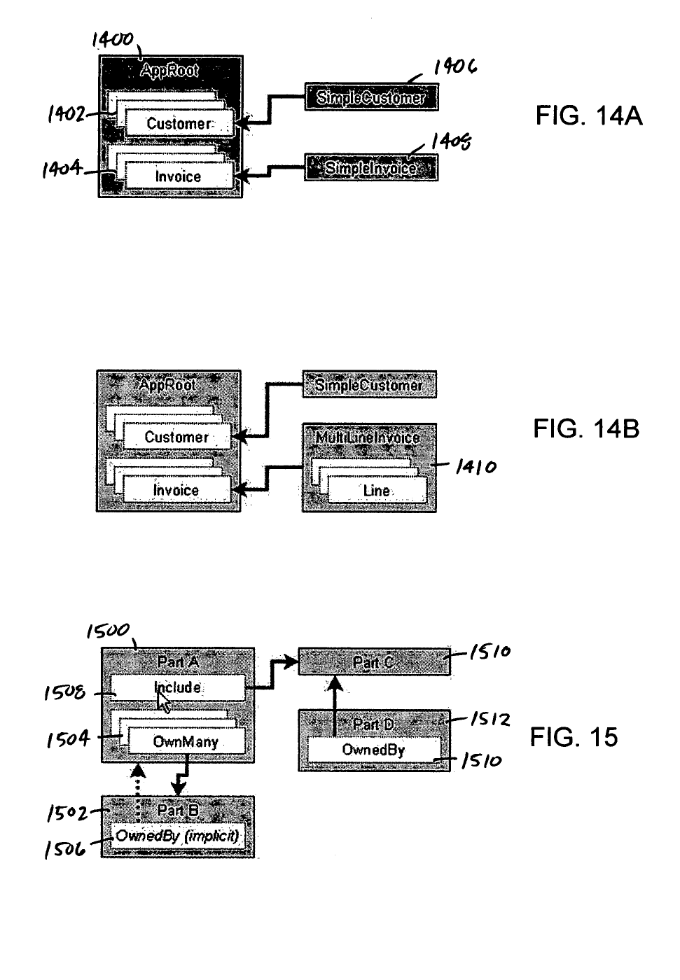

For example in FIGS. 14A and 14B, take a simple invoicing system 1400, which contains the holders Customer 1402 and Invoice 1404, which are filled by the parts SimpleCustomer 1406 and SimpleInvoice 1408 respectively. There is only one item per invoice. Later, the system needs change, so that it is necessary to be able to store multi-line invoices. There is a part that is known to work well for this purpose in another system, called MultiLineInvoice 1410. To replace SimpleInvoice 1408 with MultiLineInvoice 1410, right-click on the SimpleInvoice 1408 in the Part Hierarchy window, and select “Fill” (or, if desired, select “Empty” first, and right-click and select “Fill” later). Locate and select the MultiLineInvoice 1410 file in the dialog box. The system immediately begins operating with multi-line invoices.

A part is a conceptual business object, which might be anything from the simplest standalone object to a highly complex network of smaller, interconnected parts. A part could be a persistent database object, a login/security utility, a month-end process, a report etc. Parts are the plug-and-playable building blocks of any sembleWare™ system. A part is visualized as having the following properties:
Elements—these are a part's intrinsic properties—i.e. those that are logically defined within this business object.
Holders—these represent a part's relationships with other parts.
Actions—user-defined operations that are applicable to the part.
Forms—a set of screen layouts by which the part may present itself to the user.

Lists—a set of columnar layouts by which a list of parts may be displayed in grid format.

A special case of part is the root part, which as its name implies, is the starting point of any sembleWare™ system's architecture. The root part owns, directly or indirectly, all parts within the system. The root part will also typically have a large number of forms. In addition to the home or start page of the system, the root will also own any forms that simply present a listing of parts in a grid. Since there is no single part instance that could be said to own the form, the root itself must own the form that presents its OwnMany relationship.

An element defines an intrinsic property of a part. Each element has properties such as name and data type, as well as properties defining whether and how the element is persisted to a relational database. Each part must have at least one element that is marked as a key element, since the uniqueness of each part is defined by the combined values of its key elements. For example, an Invoice part might have elements called InvoiceNo (key), InvoiceDate and TotalAmount. When a part is instantiated, these elements become properties of the instance.

Identity elements are a special case of element, where the value, an integer, is automatically generated to be unique for the part to which the element belongs. Identity elements are automatically marked as key elements. Indicator elements (StringIndicator/NumericIndicator) are another special case of element, where the values are limited to a certain set of predefined, hard-coded values. This is appropriate, for instance, for a “Gender” element, where it is exceptionally unlikely that there will ever be any valid value other than “M” or “F”. To define the values allowed for an indicator element, right-click on the element, and select “Add Option”. The option properties can be modified in the “Properties” window.

Although in principle, parts simply relate to other parts, and there is generally no need for the developer to pay any attention to foreign elements, sembleWare™ exposes foreign elements because on an implementation level there is a necessity to store foreign elements locally. Foreign Elements are elements that have been “imported” from other parts via Include or OwnedBy relationships. As soon as one of these relationships is filled, all key elements from the related part are copied to the local part and marked as foreign elements. These can be renamed locally, but their data type cannot be changed. When a part is unplugged from the holder, the foreign elements originating from that part are automatically removed from the local part.

For example, the Invoice part described above in reference to FIG. 14A would probably have an Include relationship to Customer 1406. If we were to fill the Customer holder 1402 with a part called SimpleCustomer 1406, with one key element CustomerID, the Invoice part 1408 would automatically create a foreign element called CustomerID (of the same data type as the element in SimpleCustomer 1406). This element may be renamed in Invoice 1408, but should SimpleCustomer 1406 later be unplugged from the holder 1402, the foreign element would be deleted from Invoice.

Relationships are connectors that define the way parts relate to each other. They have one-sided definitions, i.e. only one of the parts involved in the relationship explicitly relates to the other. There are three types of relationships that may be defined in a part:
OwnMany—a one-to-many relationship, where the owned part is wholly subordinate to its owner, in that the owner is responsible for the creation of the parts it owns. For example and as shown in FIG. 15, an Invoice part (Part A 1500) would own many LineItem parts (Part B 1502). The root part 1500 has OwnMany relationships 1504 to all of the parts 1502 contained therein. Whenever an OwnMany relationship 1504 is created, the related part 1502 implicitly receives an OwnedBy relationship 1506.
Include—a reference to a single foreign part. For example, an Invoice part (Part A 1500) would include 1508 a Customer part (Part C 1510).
OwnedBy—this is the inverse of OwnMany: a many-to-one relationship, where the owned part inherits the key elements of its owner. Any time an OwnMany relationship is created, a reciprocal OwnedBy relationship is implicitly created on the owned part; nonetheless, if for any reason, the relationship must not be explicitly declared in the owner part, the OwnedBy relationship may be explicitly declared on the Owned part. In the diagram, Part B 1502 has a reciprocal OwnedBy relationship 1506 to Part A 1500, while Part D 1512 has a non-reciprocal OwnedBy relationship 1514 to Part C 1510.
   Note that the Include and OwnedBy relationships do not really map directly to parts; rather, they are mapped to parts via unification with an OwnMany relationship.

A holder is a conceptual placeholder within a part that represents its relationship with another part. It is important to note that a holder does not necessarily have to contain a concrete part at design time; it merely represents an expected related part that will be required for the integral functioning of this part. Note that holders are, like the relationships they represent, one-sided; the related part is not explicitly aware of the presence of the relating part.

Built into holders is the concept of shape—properties and functionality that are expected from any part that will be plugged into this holder. The shape of a holder consists of a set of element and action sockets, which define the expected properties and actions of such parts, and will be mapped to the appropriate elements and actions once a part has been plugged in. In this way, parts may be freely plugged in and out of holders, without affecting the stability of the remainder of the system. Element and action sockets are mapped differently, depending on the type of holder.

Since Include and OwnedBy holders do not map directly to parts, but are rather unified to an OwnMany holder elsewhere in the system, the shape of Include and OwnedBy holders cannot map directly to “real” elements and actions; instead they are mapped to element and action sockets within the OwnMany holder to which their holder is mapped. For example and as shown in FIG. 16, the root part 1600 includes an OwnMany holder Invoice 1602 and a OwnMany holder Customer 1604. Invoice holder 1602 is filled with part Invoice 1606, which includes OwnedBy holder Customer 1608. OwnMany holder Customer 1604 in the root part 1600 is filled by part Customer 1610. As a result, TotalOwingAmt 1612 in Invoice 1606 is mapped to Balance 1614 in root part 1600, which is mapped to OutstandingAmt 1616 in Customer 1610. Similarly, RunCreditCheck 1618 in Invoice 1606 is mapped to CreditCheck 1620 in root part 1600, which is mapped to CreditCheck 1622 in Customer 1610.

OwnMany holders, on the other hand, are mapped directly to concrete parts, and the element and action sockets may be mapped directly to the elements and actions of the part that has been plugged into the holder. In addition, an element socket mapping from an OwnMany holder may be redirected to an Include holder's element socket. So, for example, the Customer OwnMany holder has an element socket called “CityName”, and the Customer part does not have an element storing city information, but rather an Include relationship “HomeCity”, which is unified to the City OwnMany holder, which in turn refers to a City part, the “CityName” element socket could be mapped to “HomeCity.CityName”.

An action is an operation that may be performed on a part. By default, every new part is created with two actions:
Save—Persist the data in this part to the database; and
Delete—Delete this part's data from the database.
   In addition to these, the user may create his/her own custom actions, and may even delete either or both of the aforementioned default actions if such is desired.

A form is a presentation layout by which a part represents itself to the user. A form contains controls that may be bound to elements within the part as well as to related parts. Different types of elements and relationships are represented by different controls. sembleWare™ forms are descended from the sembleWebPage class.

A list is a columnar layout, by which a list of parts may represent itself in a grid. The list will invariably appear on a form representing a part to which this part is related via either an OwnedBy or an Include relationship. Every part is created with a default list, containing all its elements, and hiding the key element. The default list may be renamed but not modified or deleted, since it automatically and dynamically maintains synchronicity with all the elements of the part. For customized list layouts, it is necessary to create a new list using the List Designer.

Very frequently, numerous parts within the same system will have references to the same conceptual holder. In such cases, it makes sense to unify the holders, so that when the holder is to be filled by a concrete part, this need only be done in one place. So, for example, in one system, an invoice might refer to a customer; a journal transaction would refer to a customer; a call center log might also refer to a customer. These “customers” should be unified, so that a single part fills all holders. This is not to say, of course, that the invoice, journal and log would all share the same customer instance; it simply means that they each individually store a customer instance, which is selected from a common customer database. In practice, every Include and OwnedBy holder is mapped to a concrete part through unification to an OwnMany holder.

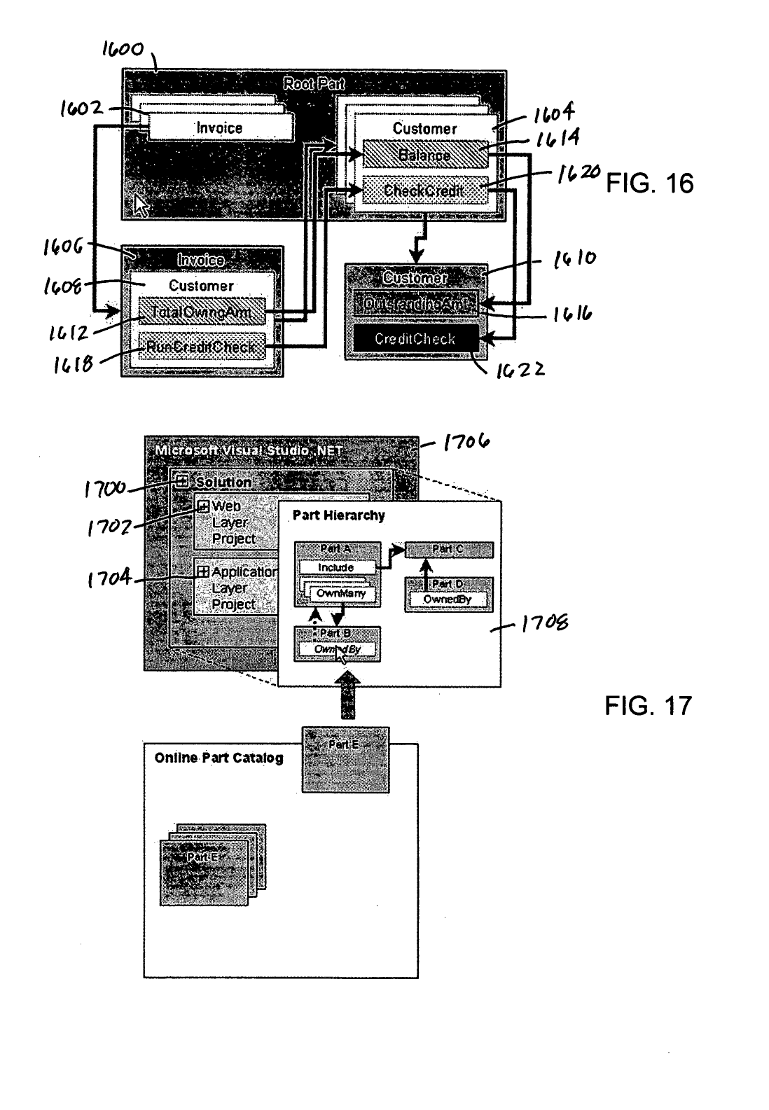

The sembleWare™ Visual Welder™ is an add-in for Microsoft™ Visual Studio .NET™, which enables the user to develop systems within the sembleWare™ architecture, in rapid time. As shown in FIG. 17, when a user creates a Visual Welder™ project 1700, the user will be working with two projects—one being a (web) presentation layer 1702; the other an application layer 1704, containing all the business logic of the system. The parts and forms that are created in the project are implemented as classes and aspx pages, within the application 1704 and web 1702 layers respectively.

In order to ensure centralization and consistency of all business rules, it is strongly recommended to keep all business logic in the application layer 1704, and restrict web layer 1702 code to only that which is necessary for presentation issues. Conversely, the application layer 1704 should not have any code that deals with presentation issues, since the same business objects may be used with any number of different kinds of presentation layers 1702. Instead of viewing the project through the standard Visual Studio .NET™ Solution Explorer 1706, which will display the project in this split-level view, it is recommended that the user work with the Visual Welder™ Part Hierarchy 1708, which presents the project in a consolidated conceptual view.

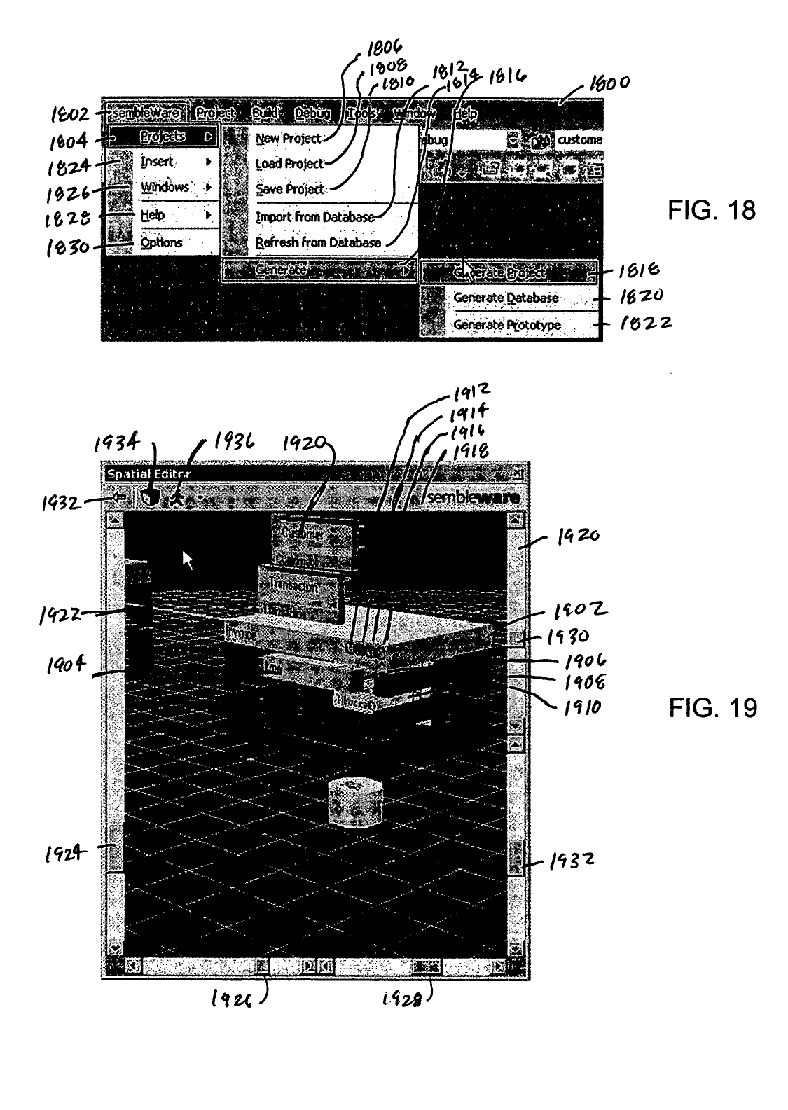

As shown in FIG. 18, when the sembleWare™ Add-In is installed, a new menu “sembleWare” 1802 appears in the Visual Studio™ IDE 1800. This menu has the following items and sub-items:
Projects 1804
   New Project 1806—creates a new sembleWare™ project
   Load Project 1808—loads an existing sembleWare™ project.
   Save Project 1810—saves all changes made to the current project.
   Import from Database 1812—this option may be used to create a new sembleWare™ project, based on the tables found in the database.
   Refresh from Database 1814
   Generate 1816
      Generate Project 1818—generates Visual Basic™ code and forms according to the sembleWare™ specifications.
      Generate Database 1820—generates database tables to match the definitions within the project.
      Generate Prototype 1822—creates a working prototype using all the parts in the project.
Insert 1824
   Element—creates an element within the selected part.
   OwnMany—creates an OwnMany relationship within the selected part.
   Include—creates an Include relationship within the selected part.
   OwnedBy—creates an OwnedBy relationship within the selected part.
   Form—creates a form within the selected part.
   List—creates a list within the selected part.
Windows 1826
   Spatial Editor—opens the Spatial Editor window.
   Part Hierarchy—opens the Part Hierarchy window.
   Toolbox—opens the Active Toolbox.
   Part List—opens the Part List window.
Help 1828
Options 1830—allows the developer to adjust several preference settings.
   In addition, there are two sembleWare™ toolbars, with buttons corresponding to all the options listed above under the “Insert” and “Windows” menus respectively.

As shown in FIG. 19, the Spatial Editor 1900 is a three-dimensional, navigable representation of the structure of a Visual Welder™ project, which is visualized as a set of interconnected parts, each containing its own set of elements, relationships, actions, forms and lists. Parts (e.g., Invoice 1902), including the root part, are visualized as transparent boxes, with blue walls and a grey roof. Inside the part are its OwnMany holders (e.g., Line 1904) (light blue brackets), containing filler parts 1906 (grey bolts); actions 1908 (dark red bars on the right side of the part) and elements 1910 (grey panel on the inner back wall of the part). On the right end of the grey roof of the part are four buttons 1912, 1914, 1916 and 1918.

The first three are used to switch what is displayed above the part between Include holders, lists and forms. Displayed above the part by default, or when the “Includes” button 1912 (orange-yellow frame around light blue interior) is clicked, are its Include holders 1920 (orange-yellow frames), filled by the OwnMany relationship to which they are unified (light blue bracket). When the “Lists” button 1914 (yellow columns on brown background) is clicked, all the lists for the part are shown above the roof of the part as white bars with orange-yellow columns. (These are best edited with the List Designer.) When the “Forms” button 1916 (grey background with blue top bar and two black bars) is clicked, all the forms for the part are visualized above the root of the part as grey-blue panels. Within each form panel are sub-panels representing each part displayed on the form. The “Close” button 1918 (red ‘X’) collapses the part and refocuses the camera on the owner part. Also visible in the Spatial Editor are green pipes 1922, connecting parts with the OwnMany holder wherein they are respectively housed within the system.

The scrollbars around the Spatial Editor window reposition the camera in the following ways:
The vertical scrollbar 1924 on the left of the window zooms in and out.
The left horizontal scrollbar 1926 below the window moves the camera along the horizontal axis while maintaining focus on the currently selected object.
The right horizontal scrollbar 1928 below the window rotates the camera around the currently selected object, in the horizontal plane.
The upper vertical scrollbar 1930 on the right of the window moves the camera along the vertical axis while maintaining focus on the currently selected object.
The lower vertical scrollbar 1932 on the right of the window rotates the camera around the currently select object, in the vertical plane.
   From any viewpoint, clicking on an object will always reposition the camera to it optimal position for viewing that object.

To navigate back to your previous camera position, click the “Navigate Back” button 1932 (light blue left-arrow). To reposition the camera on the root part, click the “Default View” button 1934 (red and yellow cube). To change animation speed, push the “Animation Speed” button 1936.

Most objects in the Spatial Editor may be dragged and dropped; the fact that it is a three-dimensional space makes this slightly more complicated than usual. Normal dragging of objects moves them vertically and backwards/forwards, without affecting their horizontal position. To change an object's horizontal position, hold down the “Ctrl” key while dragging. This will move the object horizontally and vertically, without affecting its depth.

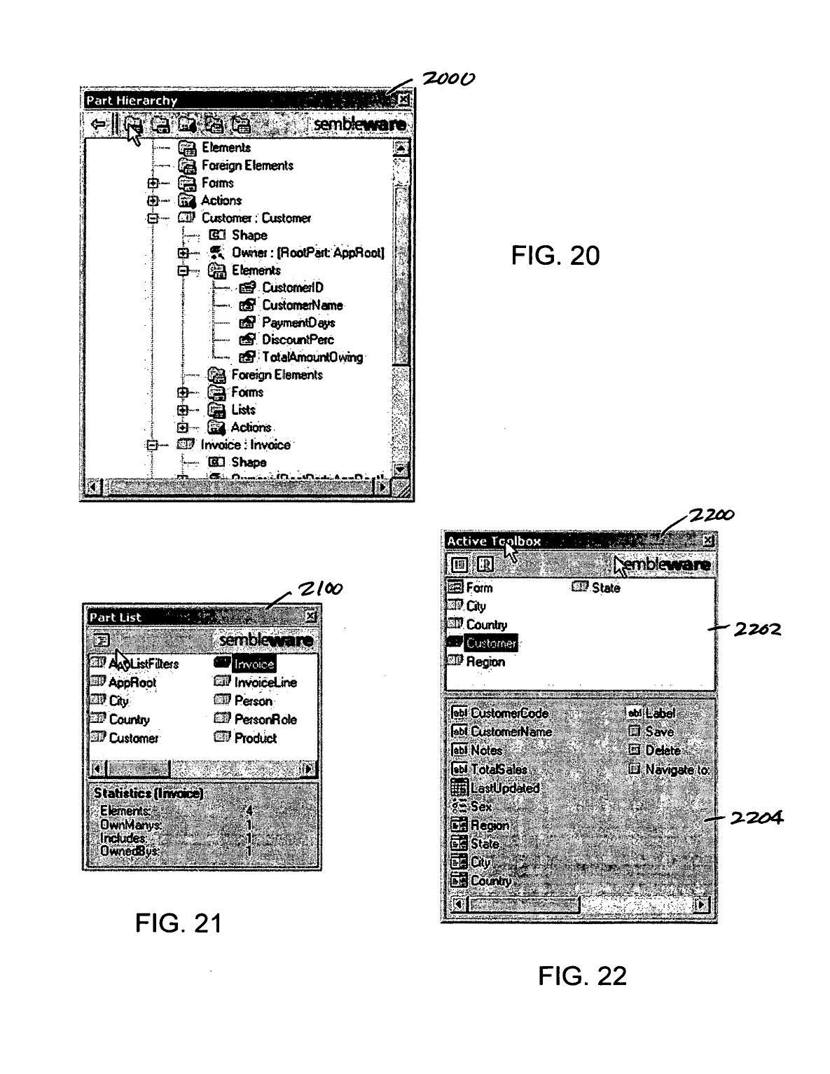

As shown in FIG. 20, the Part Hierarchy 2000 is a tree view window, in which the entire project structure may be viewed. The root node represents the total solution, under which a root part must be placed. The root part, in turn, may contain any number of OwnMany holders. Once a holder has been filled with a part, it is possible to expand the part's node further, and so on, reflecting the recursive nature of the sembleWare™ architecture. Each part has several properties that may be viewed and/or modified in the Part Hierarchy, specifically:
A reference to its parent part.
Its holders (and any parts that have been plugged into those holders).
Its elements (and foreign elements).
Its forms.
Its lists.
Its actions.
   Even before a part has been plugged into a holder, it is possible to define the shape of the holder—i.e. the properties expected of any part that will subsequently be plugged into the holder.

As shown in FIG. 21, the Part List window 2100 is a flat, alphabetical list of all parts contained within the system. When selected, it shows statistics relating to the part, specifically:
Number of elements
Number of OwnMany relationships
Number of Include relationships
Number of OwnedBy relationships
   To locate the part in the Part Hierarchy window, double click on the part in the Part List, or select it and push Enter.

As shown in FIG. 22, the Active Toolbox 2200, as its name implies, is a dynamic, context-sensitive palette of controls that may be dragged and dropped onto a form. The contents of the Active Toolbox will vary, according to the properties of the form that is currently being edited. There are two panels on the Active Toolbar: the Form Parts panel 2202 above, and the Control Palette 2204 below. In the Form Parts panel 2202 are listed the various parts available on the form, as well as an entry for the form itself. Initially, the only part listed in this panel will be the part that owns this form; other (related) parts may be added later, as detailed below. When a part (or the form icon) is selected in the Form Parts panel 2202, the contents of the Control Palette 2204 will change to reflect the elements, holders, actions and navigation options that are applicable to the selected entry. These may be dragged and dropped onto the form as desired. Elements and holders are represented on the form by various controls as appropriate to the type of element:

| Element/Relationship | Type | Control |
|---|---|---|
| Boolean | element | CheckBox |
| Indicator | element | RadioButtonList |
| | (StringIndicator/ | |
| | NumericIndicator) | |
| DateTime | element | TextBox with Calendar |
| | | Control |
| Other | element | TextBox |
| Include/OwnedBy | relationship | DropDownList |
| OwnMany | relationship | DataGrid |

When a relationship control (DropDownList/DataGrid) is dropped on a form, the part represented by the relationship appears in the Form Parts panel, and becomes available for use on the page. Actions and navigation options are represented by LinkButtons. The types of buttons available are:
Submit—Save the current data and navigate up a level.
Apply—Save the current data.
Cancel—Cancel all changes, and navigate up a level.
Go Back—Navigate up a level. This is practically the same as “Cancel”, but typically used on forms that do not have data to be persisted.
Open—Navigate down to a new form, using a part currently selected on this form.
New—Navigate down to a new form, using a new part.
Delete—Delete a part or parts on the form.
Navigate to URL—Navigates to a new URL, possibly unrelated to this system.
Generic—A custom button whose default properties are not set.
   When any of the above buttons is dropped on a form, the Button Designer dialog box will appear, allowing the developer fully to specify the properties of the button.

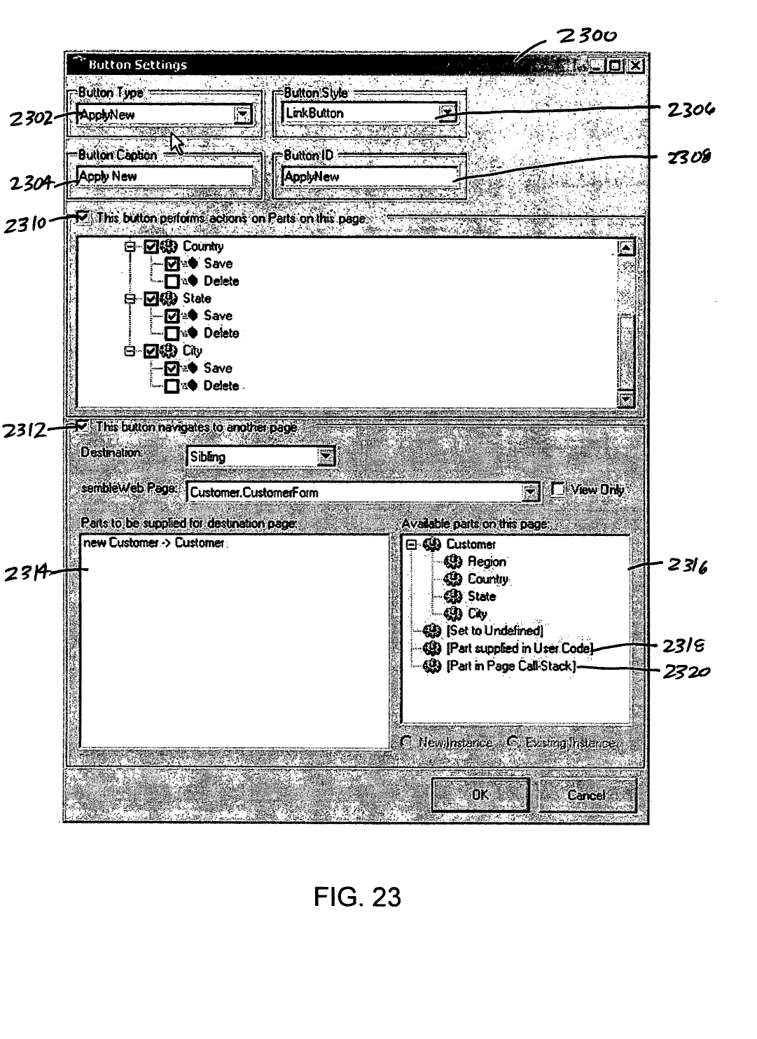

As shown in FIG. 23, when a LinkButton is dragged and dropped onto the form from the Active Toolbox, the Button Designer 2300 dialog appears, which allows the user to modify various properties of the button. Since buttons can be used for a variety of different purposes, such as saving, deleting, performing other actions, and navigating to different forms, there are several options that may be modified:
Button Type 2302—this sets the properties of the button to certain default values according to the type selected (as described in The Active Toolbox). Once button type has been selected, the properties of the button may be modified further as desired; button type is not a persisted property of the button.
Button Caption 2304—the caption of the button.
Button Style 2306
Button ID 2308—a programmatic identifier for the button, which will automatically be prefixed by “btn” in the name of the control.
This button performs actions on Parts on this page 2310—if checked, the button will perform the actions selected on the applicable parts. Any number of actions may be selected to be performed on any number of parts that are used on the form; these may be “Save”, “Delete”, or any developer-defined custom action.
This button navigates to another page 2312—if checked, the button will navigate to the URL or sembleWebPage (form within this system) specified. If the page selected requires any parts, it may be necessary to specify which part is to be supplied to the destination page. This is frequently filled in automatically; it is, however, often necessary to specify it manually, by first selecting the part in the left panel (“Parts to be supplied for destination page” 2314), and then selecting, from the right panel (“Available parts on this page” 2316) the part that is to be supplied. If “Part supplied in User Code” 2318 is selected, the developer will have to supply the part in the event code of the button, using the SupplyPart method (see example). If “Part in Call Stack” 2320 is specified, the developer is warranting that the required part will be found in the page call stack, and it is the developer's responsibility to ensure that the part is indeed found there.
   Once the button has been created, the developer may return to the button designer by locating the button under the form in the Part Hierarchy, right-clicking and selecting “Edit”.

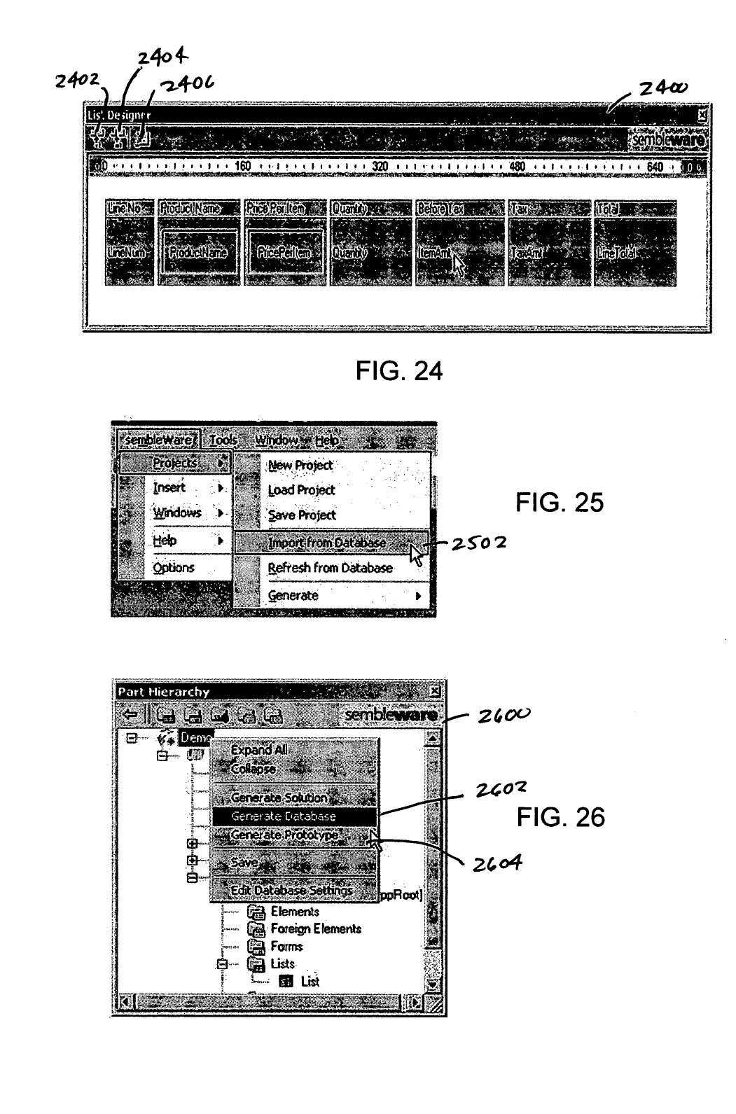

As shown in FIG. 24, the List Designer 2400 is a visual tool that enables the developer to design a custom list layout. While every part created within sembleWare™ always has a default list that dynamically updates itself as elements are added, modified or deleted, it is possible (and usually desirable) to create custom list layouts to represent a list of parts in a grid format. The List Designer 2400 only works with custom lists, not default lists, since default lists are dynamic and thus potentially volatile. Thus it is necessary to create a new list for a part before using the List Designer. With the List Designer 2400 window open, select the desired list in the Part Hierarchy. This will bring up a graphic representation of the list in the List Designer 2400. Using the List Designer 2400, it is possible to perform the following actions on the list:
Insert columns—either by clicking the “Insert New Column” button 2402, or by right-clicking and selecting “Add Column”. The column is bound to an element using the Properties window.
Insert foreign lists—either by clicking the “Insert Foreign List” button 2404, or by right-clicking and selecting “Add Foreign List”. The foreign list is bound to a relationship using the Properties window. This will copy all the columns from the foreign list into the local list, and it is possible thereafter to remove any unwanted columns.
Adjust column width—by dragging the right edge of the column.
Change column position—by dragging and dropping the entire column into the desired position.
Delete columns and foreign lists—by right-clicking on the applicable column or foreign list and selecting “Delete”.
Apply changes to the currently open form—by clicking the “Generate Current Form” button 2406, all changes you have made to the list layout will be applied to any grids on the current form that use this list.
   All properties of the list columns—such as caption and sort order precedence—may be modified using the Properties window. Sorting order is determined by the absolute value of the “OrderBy” property, in ascending order (zero signifies no ordering; 1 is the first sorting column). Positive numbers indicate ascending sort order; negative numbers indicate descending sort order.

The process of creating a project from a database will now be discussed in reference to FIG. 25. If a database is already set up, with all necessary tables and fields, and all primary and foreign keys in place, the user can effortlessly create a Visual Welder™ project from scratch. First, create a new project using the “sembleWare/Projects/New Project” menu, and set up the correct database information on the project using the Properties window. Then select the menu item “sembleWare->Projects->Import from Database” 2502. This will create a part for every table in the database, and elements on these parts as appropriate. Furthermore, the import utility intelligently creates relationships between the parts it is creating, based on the foreign key relationships that exist on the database tables. From this point, the user can also create a fully functional prototype.

The process of creating a database from a project will now be discussed in reference to FIG. 26. Visual Welder™ provides the facility to maintain synchronization between projects and their underlying databases. It is a very simple matter to change the structure of a part (or parts), and then refresh that structural change into the database. First, ensure that the project properties are correctly set up to refer to the database. Then right-click the project in the Part Hierarchy 2600, and select “Generate Database” 2602—or alternatively, select “sembleWare/Projects/Generate/Generate Database” from the menu.

The process of creating a working prototype will now be discussed. Once a Visual Welder™ project is set up with all the desired parts, elements and relationships, the user can generate a fully functional prototype of your system at the click of a mouse. Right-click on the project in the Part Hierarchy 2600, and select “Generate Prototype” 2604. This will cycle through the entire project, and generate the following forms:
A home page
A list form for every part to which the root part has an OwnMany relationship
A detail form for every part in the project. Parts that have OwnMany relationships to other parts will have lists generated on their detail forms to display the related part data.

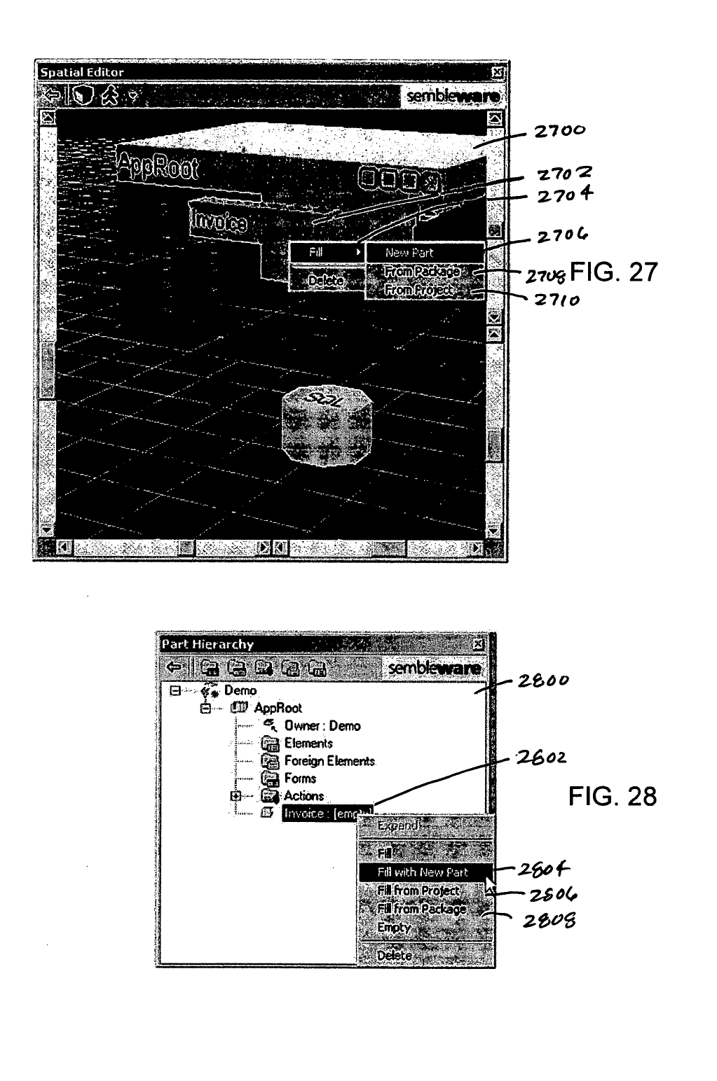

The process of creating or plugging in a part will now be discussed in Reference to FIGS. 27-29. It is possible to create a part using the Part Hierarchy window 2800. A holder must first be created, wherein the new part will be plugged. The Spatial Editor 2700 can be used to fill an OwnMany holder by right-clicking on the holder 2702, selecting Fill 2704 and then selecting one of the following options:
New Part 2706—create a new part to fill this holder; or
From Package 2708—use a part from a package that has possibly been downloaded via the internet; or
From Project 2710—use a part that already exists in this project.
   The Part Hierarchy 2800 can be used to fill an OwnMany holder by right-clicking on the holder 2802 to be filled, and selecting one of the following options:
Fill with New Part 2804—create a new part to fill this holder with the same name as the holder; or
Fill from Project 2806—use a part that already exists in this project.
Fill from Package 2808—use a part from a package that has possibly been downloaded via the internet.
   If a new part is created, the part is by default given the same name as the holder it is filling, though it may be renamed in the Properties window. Once the part is created, its elements, holders/relationships, actions, forms and lists may be defined as specified in the relevant documentation.

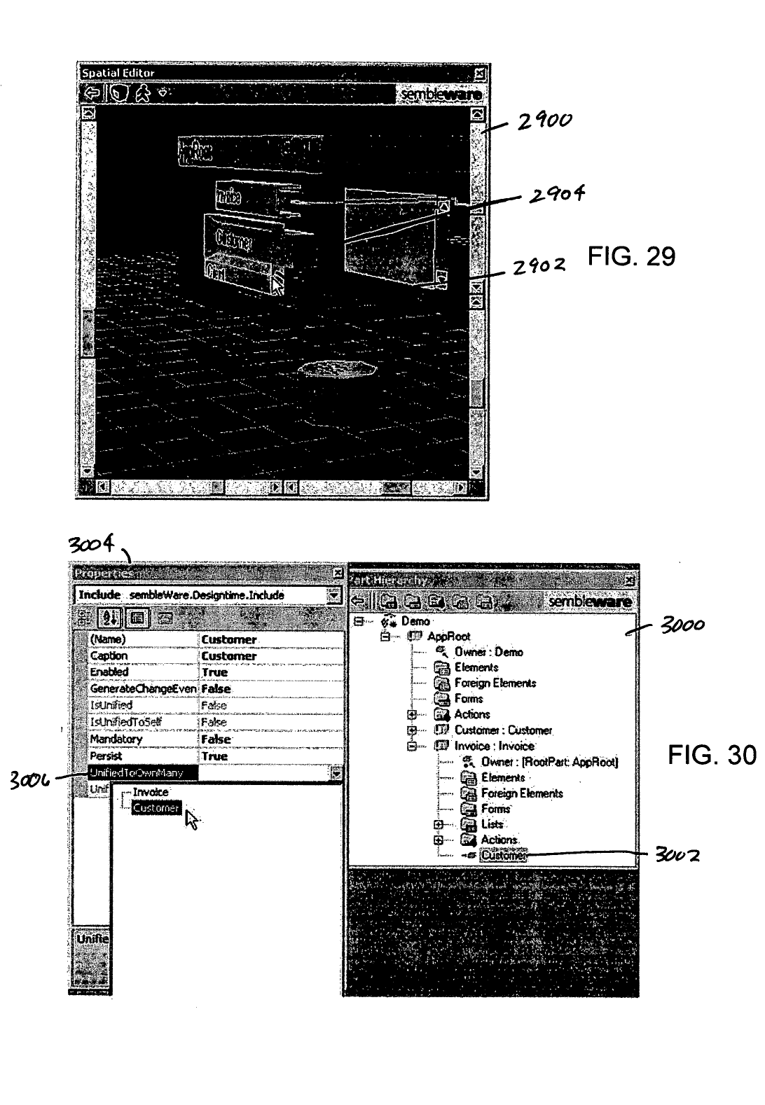

The process of filling an Include/OwnedBy holder will now be described in reference to FIGS. 29-30. Before filling an Include or OwnedBy holder, there must be an OwnMany path somewhere in the project (through any number of levels) referring to the part to be included. In other words, before a part can be included in another part, it must exist in its own right somewhere else in the project. Note that the OwnMany holder does not actually have to be filled to be used in an Include relationship elsewhere; it is sufficient that it exists. This action of bonding the Include/OwnedBy holder to an OwnMany holder is called unification, and it may be performed in either the Spatial Editor or the Part Hierarchy.

The Spatial Editor 2900 can be used to fill the holder 2902 by dragging the Include holder 2902 over the part 2904 (often the root part) containing the OwnMany relationship to which the Include is to be unified. This will cause the camera to refocus on the part; now continue dragging the Include holder over the OwnMany holder, and drop it. This will retrieve the OwnMany and link it into the Include. Likewise, the Part Hierarchy 3000 can be used to fill the holder 3002 by select the holder 3002 to be unified. This will cause its properties to be displayed in the Properties window 3004. Then set the UnifiedToOwnMany property 3006 as shown.

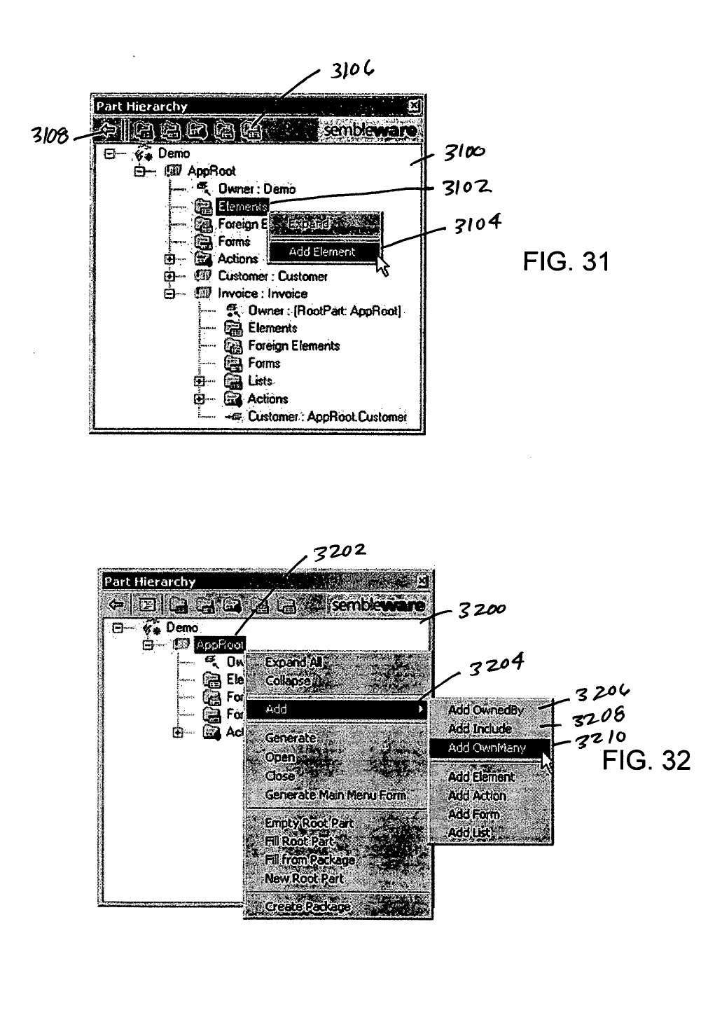

The process of creating an Element will now be described in reference to FIG. 31. In either the Spatial Editor or the Part Hierarchy 3100, right-click on the applicable part 3102 (or its “Elements” object/node), and select “Add Element” 3104. Alternatively, select the part, and push the “New Element” button 3106 on the “sembleWare Functions” toolbar 3108. This creates a new element, whose properties may be set in the Properties window.

The process of creating a Holder/Relationship will now be described in reference to FIG. 32. In either the Spatial Editor or the Part Hierarchy window 3200, right-click on the applicable part 3202, select “Add” 3204 and from the pop-up menu, select the type of relationship that is to be created (e.g., “Add OwnedBy” 3206, “Add Include” 3208, “Add OwnMany” 3210). Once the new holder appears, it may be renamed in the “Properties” window.

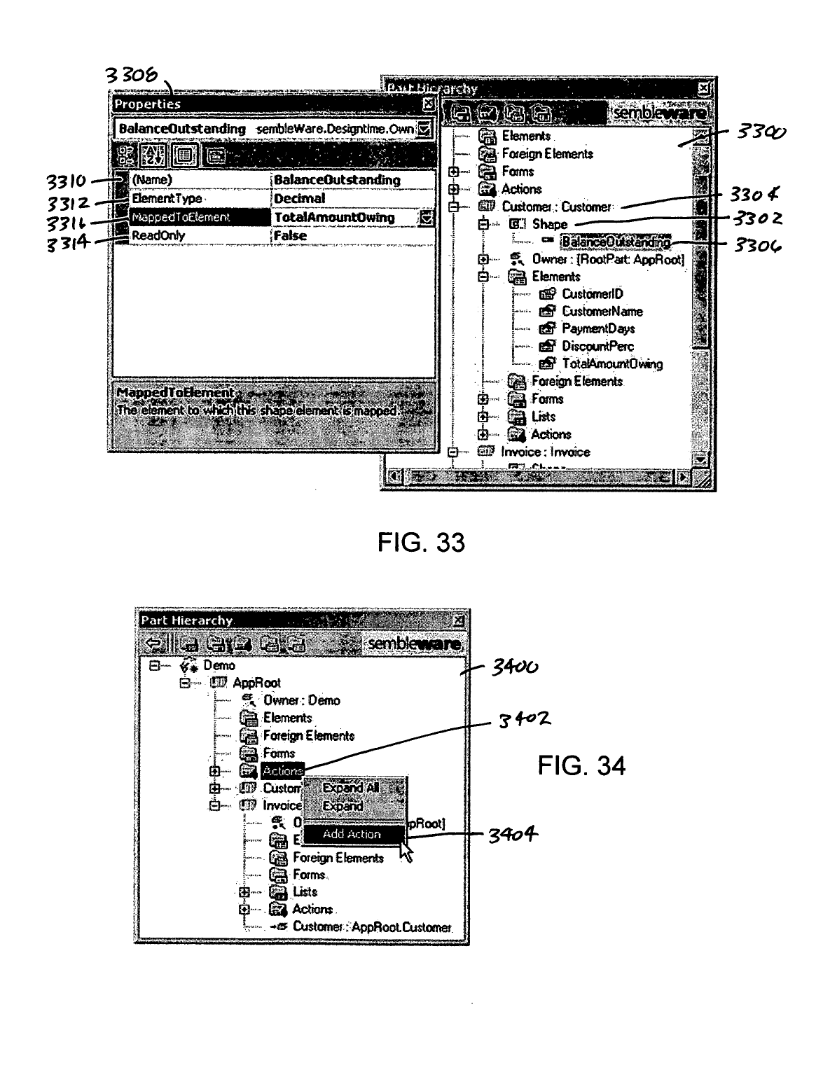

The process of defining the shape of a holder will now be described in reference to FIG. 33. The shape is defined in the Part Hierarchy 3300 by right-clicking on the “Shape” node 3302 under the applicable holder 3304 and selecting “Add Element Socket”. Then select the new element socket 3306 and set its properties in the Properties window 3308. It is always possible to set the Name 3310, ElementType 3312 and ReadOnly 3314 properties of the element socket; when a part is plugged in to the holder, it is also possible to set the MappedToElement property 3316, which defines the element on the plugged-in-part to which the element socket refers. Similarly, the expected action of the part to be plugged in can be defined by right-clicking the “Shape” node 3302 and selecting “Add Action Socket”. This action can be named using the Properties window 3308, and when a part is plugged in, using the MappedToAction property.

The process of creating an action will now be described in reference to FIG. 34. The action is created in the Spatial Editor or the Part Hierarchy 3400 by right-clicking on the applicable part (or its “Actions” node 3402 in the Part Hierarchy) and selecting “Add Action” 3404. Then, the action can be named in the Properties window as appropriate. When the add-in generates the Visual Basic code for the part, it generates methods for each action on the part, by the same name as the action, within a region of code labelled “User defined actions”. Within these methods, the user may code whatever business logic is applicable to these actions.

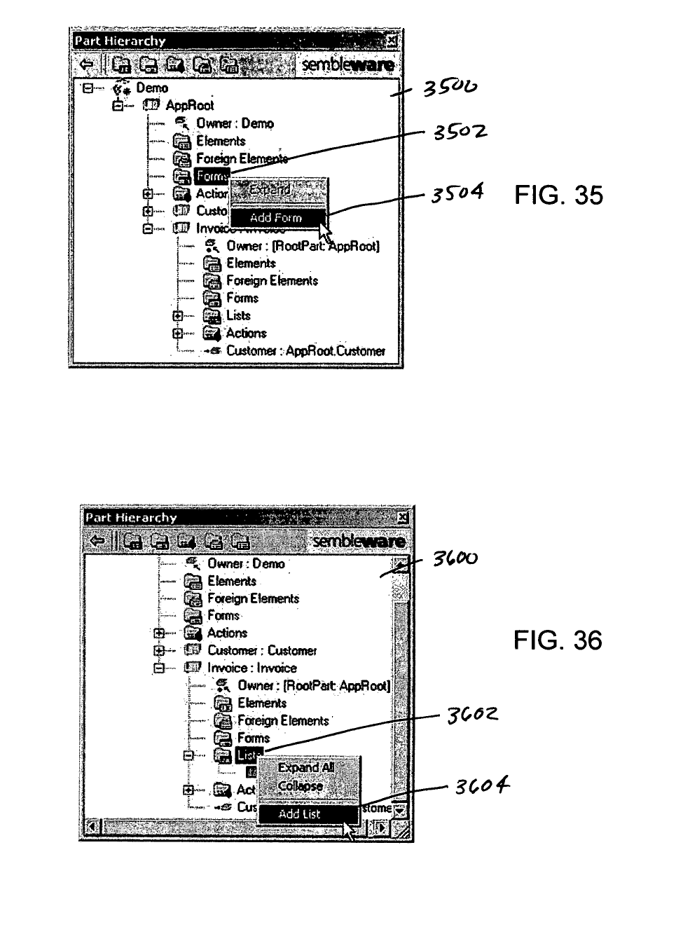

The process of creating a form will now be described in reference to FIG. 35. The form is created in the Spatial Editor or the Part Hierarchy 3500, right click the part (or the “Forms” node 3502 in the Part Hierarchy) for which a form is to be created, and select “Add Form” 3504. The new form is named by default by appending “Form” to the name of the part, and it may be renamed in the Properties window. To manipulate the form visually, double click on the newly created form or node. This will generate a blank aspx page and open it in the Visual Studio IDE. It is now possible to drag-and-drop elements and related parts from the Active Toolbox onto the form, where controls are created to represent them as appropriate. LinkButtons may be created using the Active Toolbox, also by dragging and dropping from the toolbox onto the form.

The process of creating a list will now be described in reference to FIG. 36. The list is created in the Spatial Editor or the Part Hierarchy window 3600 by right-clicking on the applicable part (or its “Lists” node 3602 in the Part Hierarchy), and selecting “Add List” 3604. Name the list as desired and then use the List Designer to modify the columns contained in the list.

Some commonly used patterns for relationships between parts within the sembleWare™ framework will now be discussed.

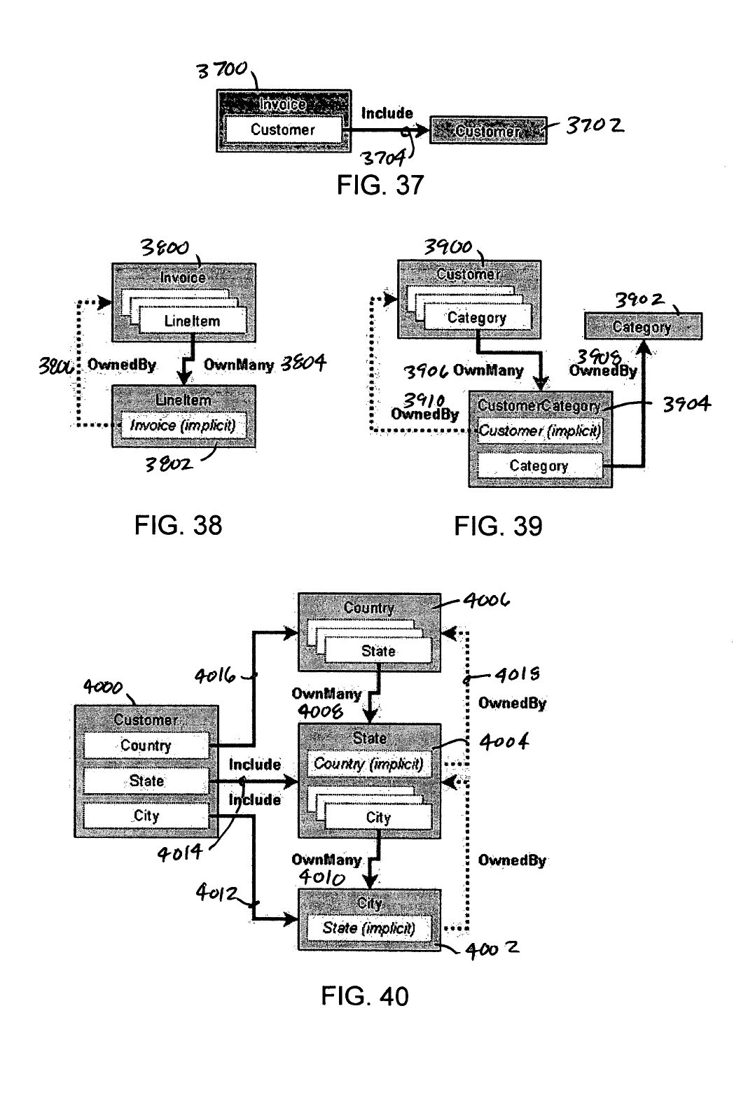

### Business Cases—Customer/Invoice (FIG. 37)

The Business Problem: In any invoicing system, when an invoice is created, it is always for a specific customer. In fact on paper, an invoice usually has customer information at the top and the billing details on the bottom. In Visual Welder™, “Invoice” 3700 and “Customer” 3702 would be two independent parts, with a relationship 3704 between them.

Part Cardinality: One customer 3702 can have many invoices 3700; an invoice 3700 has one and only one customer 3702.

Part Awareness: An invoice 3700 has no business meaning if it is not for a specific customer 3702. However a customer 3702 can exist without ever having an invoice 3700. More importantly, a customer part 3702 could be used in a system that has nothing to do with invoicing, for example a Contact Management System. Therefore the relationship belongs on the invoice part 3700.

Solution: Invoice 3700 has an Include relationship 3704 to customer 3702.

Explanation: A customer 3702 is an independent entity, and should not contain any reference to any parts that are not required for its internal functioning. An invoice 3700, however, intrinsically needs a reference to the customer 3702 being billed. The relationship 3704, therefore, belongs to the invoice 3700, and since each invoice 3700 has only one customer 3702, the correct relationship to use is the Include relationship 3704. Since the invoice 3700 is incomplete without a customer 3702, the “customer” relationship should have its “Mandatory” property set to True

### Business Cases—Invoice/Line Item (FIG. 38)

The Business Problem: The invoice 3800 that is required is not a single-item invoice; rather, there will be multiple items included inside one invoice 3800. Furthermore, there will be a need to encode a business rule that aggregates all line item totals into the invoice total. In Visual Welder™, “Invoice” 3800 and “LineItem” 3802 would be separate parts, with a relationship between them.

Part Cardinality: One invoice 3800 can have any number of line items 3802; a line item 3802 must belong to exactly one invoice 3800.

Part Awareness: Invoice 3800 intrinsically requires line items 3802; line items 3802 are intrinsically part of an invoice 3800. This mutual dependency is underscored by the fact that there are business rules that require the two parts to interact with each other.

Solution: Invoice 3800 has an OwnMany relationship 3804 to LineItem 3802.

Explanation: The OwnMany relationship 3804 on the invoice part 3800 implicitly creates an OwnedBy relationship 3806 on the line item 3802. Since this relationship is effectively two-sided (even though it is only explicitly declared on one side), each part is aware of the other, and they may interact with each other in their business rules. Therefore, as line item totals are changed, it is possible to update the invoice total accordingly.

### Business Cases—Categorization (FIG. 39)

The Business Problem: Categorization appears in many guises within a business. Often a single item may have only one category; this is a relatively trivial case where the category is simply a property of the item being categorized. A more complicated case arises when one item can belong to more than one category.

In this case, customers 3900 must be assigned to any number of categories 3902. The categories 3902 themselves must be user-configurable. In Visual Welder™, there would be a separate, independent part for categories 3902, in addition to the customer part 3900.

Part Cardinality: One customer 3900 may have many categories 3902; each category 3902 can contain many customers 3900.

Part Awareness: Customer 3900 and Category 3902 are, in principle, mutually independent, since conceptually neither business object intrinsically requires the other. This, however, will vary according to the business requirements, as described below.

Solution: In practically any many-to-many relationship, an “intersection” part will be required to interface between the primary parts. In this case, we will call the intersection part “CustomerCategory” 3904. From this point, there are multiple possibilities for the relationship structure:
a. Both Customer 3900 and Category 3902 have OwnMany relationships 3906 to CustomerCategory 3904;
b. Customer 3900 has an OwnMany relationship 3906 to CustomerCategory 3904; CustomerCategory 3904 has an OwnedBy 3908 relationship to Category 3902 (this is the version shown in the diagram);
c. Category 3902 has an OwnMany relationship to CustomerCategory 3904; CustomerCategory 3904 has an OwnedBy relationship 3910 to Customer 3900;
d. CustomerCategory 3904 is an independent part (an OwnMany off the root part), having OwnedBy 3910 and 3908 relationships to both Customer 3900 and Category 3902.

Explanation: The solution chosen is entirely dependent on what the business requirements are. If, from the perspective of the customer, it is necessary to know what categories a particular customer belongs to, then the customer part must be “aware” of CustomerCategory 3904, and an OwnMany 3906 relationship will be required from Customer 3900, as in solution (a) or (b) above. If the customer part has no intrinsic need to be aware of its own categorization, then either solution (c) or (d) would be indicated. In any event, the OwnedBy relationship 3910 from CustomerCategory 3904 to Customer 3900 will be created, whether implicitly or explicitly.

Similarly from the perspective of the category: if it is necessary to know which customers belong to a given category, then the category part 3902 must have an explicit OwnMany relationship to CustomerCategory 3904 as in solutions (a) and (c) above. If category is a simple lookup table with no need to be aware of who or what belongs to any given category, then solutions (b) or (d) would be sufficient.

In practice, it is uncommon to have a business requirement that would be solved with the pattern in solution (d), since at least one of the owner parts will usually have an intrinsic need for the data in the intersection part. Note that in all the proposed solutions above, it is also possible to create an OwnMany relationship from the root part directly to CustomerCategory. This may be desirable in the event that it is necessary to view the categorization of customers directly from a root form (one that is not bound to a specific part), and not necessarily via either a customer or a category form.

### Business Cases—Geographical Data (FIG. 40)

The Business Problem: It is a fairly common requirement to be able to select data from drop-down lists, where the selection will influence the contents of other drop-down lists. One of the most common examples of this is in specifying geographical data, where the selection of country will affect the states that may be selected, and the selected state in turn will limit the cities that may be chosen.

In this example, the customer 4000 must have region-specific data, relating to his/her physical location—specifically the city 4002 in which he/she lives. The geographical data to be used is structured as described above, with many available countries 4006 each containing any number of states 4004, which in turn contain cities 4002.

Part Cardinality: Each customer 4000 can have a maximum of one city 4002 specified—though obviously more than one customer 4000 may be registered in a city 4002. There are many states 4004 in one country 4006 and many cities 4002 in one state 4004.

Part Awareness: The geographical parts (Country 4006, State 4004 and City 4002) are practically a single functional unit, and are all mutually aware. None of these parts is aware of Customer 4000. Customer 4000 is aware of City 4002. Whether Customer 4000 should be aware of Country 4006 and State 4004 will be discussed below.

Solution: Country 4006 has an OwnMany relationship 4008 to State 4004. State 4004 has an OwnMany relationship 4010 to City 4002. Customer 4000 has an Include relationship 4012 to City 4002 (and possibly to Country 4006 (Include relationship 4016) and State 4004 (Include relationship 4014), too).

Explanation: As with Invoice/Line Item, Country 4006, and State 4004 form a typical OwnMany relationship 4018, with State 4004 being an integral part of Country 4006. Similarly, State 4004 owns many Cities 4002. (This multi-level OwnMany structure is often referred to as an OwnMany “tree”.) Note that in the event that a country 4006 needs to be directly aware of its cities 4002, it is necessary to have an additional OwnMany relationship directly from Country 4006 to City 4002.

The geographical parts have no need to be coupled with Customer 4000- and indeed should not have any reference to Customer 4000, since this would limit their re-use in the myriad of different circumstances where geographical data is stored. The relationship from the customer to his/her geographical location is similar to that from an invoice to its customer, and an Include relationship should be used—though it may not be mandatory to fill in a city for the customer.

As to which part or parts should be related to Customer 4000, this depends entirely on the business requirements. If only City 4002 information is required, then there should only be one Include relationship 4012 to City 4002, which will implicitly store all country and state information of that city within the customer data. If country and state information are also required, then Customer 4000 should have three separate Include relationships 4016, 1014 and 4012 to each of Country 4006, State 4004 and City 4002, respectively.

This decision may appear to be a technicality, but it reflects a deeper concept in the design of a system. Firstly, if Customer 4000 only has a reference to City 4002, it may make no assumptions whatever about the presence of country or state information for that city, and the only regional information that customer may access is that related directly to the city itself. Practically, this means that Customer 4000 forms may not have DropDownLists for Country 4006 or State 4004; only for City 4002.

Secondly, if it becomes necessary to unplug the current geographical data parts and replace them with another mode of storing geographical data, then we could replace the whole Country/State/City tree with a simple “City” part. If, however, country and state information are explicitly specified as related parts within customer, then any replacement parts for the current geographical data parts must provide the structure expected by Customer 4000.

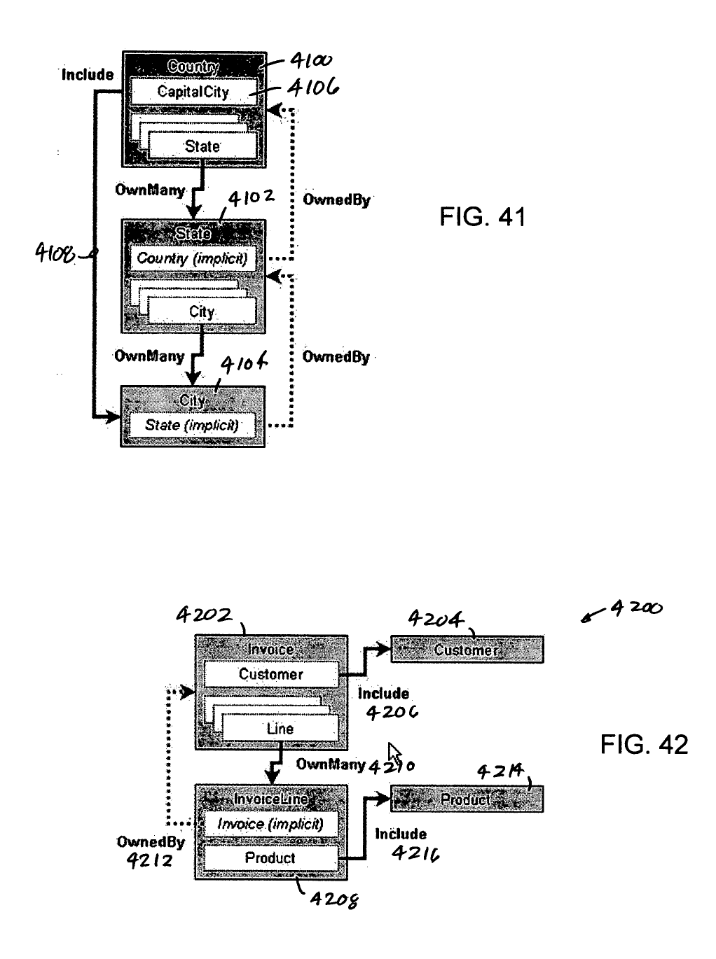

### Business Cases—Capital City (FIG. 41)

The Business Problem: Within an OwnMany tree, as described in Geographical Data, there is often a call to have a drop-down list whose possible options are limited according to the data of the item itself. A simple example of this is within a Country/State/City tree, where we wish to specify the capital city of a country. Obviously this capital city must be selected only from the cities within the country itself.

Part Cardinality: As before, a country 4100 has many states 4102, which each have many cities 4104. A country 4100, however, has only one capital city 4106.

Part Awareness: The country 4100 needs to be aware of its own capital city 4106. The city part 4104, however, should not have any awareness of any countries 4100 that refer to it as a capital city 4106.

Solution: Country 4100 has an Include relationship 4108 called CapitalCity 4106, which is filled by the City part 4104 from within the Country/State/City tree.

Explanation: Since each country 4100 only has one capital city 4106, and the city part 4104 has no need (according to this specification) to know whether it is the capital city 4106 of any country 4100, the Include relationship 4108 is indicated. It is arguably possible to have a boolean element on City 4104 that specifies that this city is a capital city 4106- and therefore obviously the capital of the country to which it belongs—but without a separate “CapitalCity” Include relationship 4108 from Country 4100 to City 4104, this would open the possibility of more than one city 4104 being marked as a capital 4106, which is not desirable according to this specification.

Note that Country 4000 may have an OwnMany relationship directly to City 4104, at the same time as it has an Include relationship 4108 filled by the same City part 4104. This illustrates the fact that it does not matter which part is plugged into the relationship; as long as the relationship names are distinct.

When the CapitalCity holder 4106 is first created on Country 4100 as an Include relationship 4108, we unify it with the City part 4104, using the UnifiedToOwnMany property of the holder in the Properties window. Initially this will allow any city—even one in a foreign country—to be selected as the capital of a country. In order to ensure that only a city within the country may be selected, it will be necessary to make the following adjustment:
When the unification is performed, all the key elements of City 4104 are imported to Country 4100 as foreign elements—with the notable exception of CountryID: since it already exists in Country 4100 as Country's own key element, it is imported here as CountryID1, thereby allowing selection of cities outside the country. Using the Properties window, it is possible to rename the foreign element back to CountryID. This signifies exactly our desired intention—that the capital city must have the same CountryID as the country to which it belongs.

### Business Design Patterns for Rules

Simple Mathematical Rules—There is a very common requirement to be able to write rules that calculate values within a part that are based on other element values within that part. For instance, let's look at a simple rule that calculates tax on a sale item and displays all relevant amounts (item amount, tax rate, tax amount and total) dynamically.

Let's put some names to the parts and elements: we'll use a part called SaleItem, with elements ItemAmt, TaxRate, TaxAmt and TotalAmt—all of “single” data type. Presumably the only “real” variable here is ItemAmt, since TaxRate would typically be obtained from a formula, either soft- or hard-coded, and TaxAmt and TotalAmt are calculated values based on the first two. We therefore can set the Enabled property on the latter three fields to False; they will not be enabled for user input.

To ensure that an event is fired whenever ItemAmt is changed, set the GenerateChangeEvent property of the element to True. Re-generate your SaleItem part by right-clicking on it in the Part Hierarchy and selecting “Generate”, then open the class code. You will find, in the code region named “Change Events”, a blank method called ItemAmt_Changed( ). Fill in the following code:

```
Private Sub ItemAmt_Changed(ByVal Element As Element, ByRef
        CancelChanges As Boolean)
    UpdateLineTotal()
End Sub
Private Sub UpdateLineTotal()
    Dim fItemAmt As Single = AppRoot.ZeroIfNull(ItemAmt.Value)
    ‘ Note 1
    Dim fTaxRate As Single = AppRoot.GetTaxRate() ‘ Note 2
    Dim fTaxAmt As Single = fTaxRate * fItemAmt ‘ Note 3
    Dim fLineTotal As Single = fItemAmt + fTaxAmt
    TaxRate.Value = fTaxRate ‘ Note 4
    TaxAmt.Value = fTaxAmt
    LineTotal.Value = fLineTotal
End Sub
```

In this code fragment, AppRoot refers to the root part, where we have created several public shared “black box” functions. ZeroIfNull( ) (Note 1) returns exactly the value of the supplied parameter, but returning zero for a null parameter value. GetTaxRate( ) returns the correct value for tax rate; for now this will be left as a black box. From these two values, we then perform a simple calculation (Note 3) and return the calculated values to the appropriate elements (Note 4).

Having this code in the business layer is sufficient to ensure that the rule will be fired whenever the SaleItem part is persisted. But should you wish to refresh the screen with the correct values immediately upon the user changing the value of ItemAmt, you will need to make a minor adjustment to your SaleItem form.

Assuming that you have already created this and all the necessary controls on the form (click here for how to do this): on the TextBox control for ItemAmt, set the AutoPostBack property to True. Then double-click on the control, and insert the following form code:

```
Private Sub txtSaleItem_ItemAmt_TextChanged(ByVal sender
As System.Object,
        ByVal e As System.EventArgs) Handles txtSaleItem_{—}
        ItemAmt.TextChanged
    BindPage(True)
End Sub
```

BindPage( ) causes any changes to element values on the form to be refreshed to the session (see more on this subject in The sembleWebPage Life Cycle). Note that depending on the number of parts that are represented on the page, the number of parameters to BindPage( ) may vary. The above code will cause a post-back to the server whenever the value of ItemAmt changes, which will cause your business layer to run the business rule code above, and immediately refresh all values to the form.

Aggregation Rules—Frequently there is a need to have aggregation rules between two parts—i.e. where one part stores the sum, average, count, etc. of values in a related part. This sort of mutually dependent relationship between parts usually indicates that an OwnMany/OwnedBy relationship is at work—though there might be exceptions.

Setting Default Values—Very often a part will have an element that should be set to a default value on creation (though the user may be able to change this value). This is accomplished in Visual Welder™ in one of two ways:
setting the DefaultValue property of the element; or
inserting custom code into the part constructor.

The DefaultValue property of the element may only be used for simple, literal values. For more flexibility in defining default values, it is possible to assign these values in the constructor, as in the fragment below, taken from an Invoice part:

```
Public Sub New(ByVal ApplicationSettings As ApplicationSettings)
    ‘sembleWare: Constructor Start - Do Not Modify
    ...
    ‘sembleWare: Constructor End - Do Not Modify
    InvoiceDate.Load(Now, Nothing) ‘ Note 1
End Sub
```

The assignment of a default date for the invoice is performed on the line marked “Note 1”. Since the default value for date is obtained from a formula (Now), and not a literal value, we could not do this using the DefaultValue property. Also take note that you must use the Load( ) method, and not the Value property within the constructor. This is because the latter might trigger a change event, which is definitely not desirable from within a constructor. Note also that the custom code must be placed outside the code block generated by Visual Welder™, delimited by the comments. Any custom code placed within this block will be lost when the part is next regenerated!

Rules Related to Loading and Persisting—There is often a need to perform business rules that are bound to loading and persisting of the part. For example, there may be a “Last Edited Date” element, which must be automatically updated whenever a part is saved. There might be a non-persisting element whose value must be calculated directly after loading the part data. Or there could be a rule that prevents deletion of a part instance under certain circumstances. In order to implement any of these business rules, it will be necessary to override certain methods inherited from the Part base class: specifically, Load( ), Save( ) and Delete( ).

Below are examples of how each of the rules described above might be implemented. First, code that sets the “Last Updated” date:

```
Public Overrides Sub Save( )
    LastUpdated.Value = Now
    MyBase.Save( )
End Sub
```

Here is an override that loads a non-persisting element value:

```
Public Overrides Sub Load( )
    MyBase.Load( )
    LoadedTime.Value = Now
End Sub
```

Finally, here is code that performs pre-deletion verification:

```
Public Overrides Sub Delete( )
    If CanDelete( ) Then
        MyBase.Delete( )
    Else
        Throw New Exception(“Cannot delete!”)
    End If
End Sub
```

Note that in each of the above cases, a call is made to the overridden method in the base class at some point; overriding these methods simply gives the developer the opportunity to write code that will be executed before and->or after these calls to the base class.

User Session Values—When there are values that need to be globally accessible within the system, these may be stored in the ApplicationSettings property of all parts and forms. In addition to being shared between all parts in the business layer, the ApplicationSettings object is shared between business layer and presentation layer, and is shared between all forms in the presentation layer. The developer can store any number of string values using the indexer property (Item( )) of ApplicationSettings. Take note that the sharing of ApplicationSettings between business and presentation layers is achieved by serialization, and the entire object is streamed forward and backward between the layers during hits. Over-using the indexer of ApplicationSettings might cause some deterioration in the speed of the application.

Logging In/User Authentication—Visual Welder™ provides certain native functionality to support login forms. The project (visible in the Part Hierarchy) has a property RestrictedPageNames, in which the names of all pages to which access is restricted to authenticated users are listed—or * for restricted access to all pages. There is also a RedirectPageName property, which should be set to the name of your login page (to be dealt with below). sembleWebPage has a property IsAuthenticated, which is, in practice, a static property, since it is internally stored on the session. In your login code, you will just have to set the value of IsAuthenticated to True, as we will see below.

There are many possible algorithms for authentication; the one presented here is by no means the only one, but it is probably the best one for scalable web applications. We will use a RegisteredUser table, containing UserName and Password. We will not deal here with populating the data in this table (you could do this with a RegisteredUser part—click here for how to create a part); instead we will assume that this table is already populated, and we will authenticate the user against the entries in this table. The login form itself can be a simple form based on the root part (click here for how to create a form). There is no need to use the Active Toolbox at all; you can create simple UserName and Password textboxes, and a Login button, from the regular Toolbox. Then in the login button's event code you can put the following code (or similar):

```
Private Sub btnLogin_Click(ByVal sender As System.Object, ByVal e As
        System.EventArgs) Handles btnLogin.Click
    Dim sError As String
    If Login(sError) Then
        IsAuthenticated = True ‘ This is how we signify that the user
                has been authenticated
        ApplicationSettings(“UserName”) = txtUserName.Text ‘ Stores
                the active user name for use anywhere else
                in the system
        NavigateContinue( ) ‘ Concludes the login redirection and sends
                us back to the page that redirected us here
    Else
        lblError.Text = sError
        lblError.Visible = True ‘ displays a message that the login
        has failed
    End If
End Sub
Private Function Login(ByRef ErrorMsg As String) As Boolean
    With ApplicationSettings.QueryBuilder
        Dim sQuery As String =
        “select * from RegisteredUser” & _{—}
        “where UserName = ” & .ToSQL(txtUserName.Text) & _{—}
        “ and Password = ” & .ToSQL(txtPassword.Text) ‘ ToSQL
        converts the value into SQL-friendly format
        Dim oResult As DataTable =
        ApplicationSettings.ResultQuery(sQuery)
        If oResult.Rows.Count = 0 Then
            ErrorMsg = “Invalid User Name or Password!”
            Return False
        Else
            Return True
        End If
    End With
End Function
```

Writing Custom Form Properties—When you create a form, Visual Welder™ generates all code necessary to bind the form to the parts, elements and relationships that you place on the form. The add-in creates accessors for all parts and lists used on the form; these are found in a code region labelled “Form Part Properties”. Occasionally there is a need to modify these accessors, such as when a list needs to have filters added, or when a part used on the form should be retrieved in a way that differs from the ordinary. This is perfectly feasible—with one prerequisite: you need to notify Visual Welder that you are customizing the accessor in question.

Locate the form whose code you are modifying in either the Spatial Editor or the Part Hierarchy. Listed under the form are all the parts and related parts represented on the form. Select the part whose accessor or list accessor you wish to modify, then change its CustomProperty in the Properties window to True. This signifies that from now on the accessor for this form part will no longer be generated, but will be implemented using developer code.

Wizard Forms—Often a series of forms is designed to capture, stage by stage, various details that should not be written to the database until the entire process is complete. This series of forms is often referred to as a “Wizard”. In the Visual Welder™ framework, all element values are cached on the client (unless the developer explicitly specifies that they should not be), and nothing is persisted to the database until explicitly told to do so. It is therefore a fairly simple matter to create a Wizard. Create all the necessary forms under the applicable part (click here for how), without creating any navigation controls yet.

Now, on the first Wizard form, drag a “Generic” button from the Active Toolbox onto the form. In the Button Designer, label the control “Next” (or something else appropriate), and name it accordingly. Uncheck the checkbox next to “This button performs actions on parts on this page”; the nature of a Wizard, as stated above, is that it does not perform any actions until the series of screens is complete. In the navigation panel of the Button Designer, select “Sibling” from the Destination drop-down, then select your second Wizard form in the sembleWebPage drop-down. Click OK, and your connection between the two wizard pages is almost complete.

Now you should be able to see your new link button. Double-click on it, to open its event code, where you will see a generated code block delimited by “Do Not Modify” comments. Before this comment block, insert a call to BindPage( )—this will ensure that the values the user has entered on the first Wizard page will be stored in the page state for future pages. You can follow this pattern for all pages within your Wizard. Only on the last page, place a standard “Submit” to commit all data to the database.

### EXAMPLE

The following example illustrates how an enterprise system maintaining a simple customer database can be built using easy commands within sembleWare™. To start, we'll create the customer maintenance section of the database.
1. Having installed sembleWare™ and opened Visual Studio, click on the “Spatial Editor” icon to open the Spatial Editor window. This will initially appear plain black.
2. Right-click on this black background, and select “New”. (Alternatively, click on the sembleWare™ menu, and select “Projects -> New Project”.)
3. Push F4 to bring up the Properties window. Then right-click on the background of the Spatial Editor, and select “Project Properties” to display the project's properties in the Properties window. Change the Name property to “MyProject”.
4. Change the DatabaseSettings properties to point to the desired SQL Server, and make the database name “MyDatabase”. Also set the user name and password appropriately.
5. Now right-click on the background of the Spatial Editor again, and select “New Root Part”. You will see that a block is created in the middle of the editor, representing the new root part that has been created, called “NewPart”.
6. Click on the grey “roof” or the blue “walls” of this part to bring it into focus in the editor. Using the Properties window, change its name to “ApplicationRoot”. (See the documentation on Parts for more about what a root part is).
7. Next, we need to create a Customer part. So right-click on the part, and select “Add -> Add OwnMany”. (See Holders for more about what you've just done.)
8. Click on this new cyan colored holder, and rename it from “OwnMany1” to “Customer”. Then right-click it, and select “Fill -> New Part”. This will create a grey block inside the holder.
9. Click on the grey block, representing the new part, to unsheathe it from the holder. Right-click it and select “Expand”. Now you can see an expanded view of the Customer part.
10. Now we need to give some shape to the Customer. Let's just give the customer an identity and a name, for simplicity's sake. So right-click on the part and select “Add -> Element”. Now, inside the part, you'll see that a new element called “NewElement1” has appeared on the grey panel on the back “wall”.
11. Click on this element to focus the editor on it. Rename it to “CustomerID”, and set its ElementType property to “Identity”. This will make CustomerID into an auto-numbering key field.
12. Repeat the process above to create a “CustomerName” element, only this time leave the element type as String.
13. Now we'll create ourselves a prototype to maintain our data. Open the Part Hierarchy window. This shows a tree-view representation of the project. The root node represents the project itself; right-click it and select “Generate Prototype”. Sit back and watch Visual Welder™ do your work for you!
14. Now, all that remains is to generate the database, and synchronize any changes made to the project. Right-click on “MyProject” in the Part Hierarchy, and select “Generate Database”. You will be asked if you wish to create the new “MyProject” database; after this you will see the “Database Generation” dialog. Click “Create Script”, then “Apply Script”. Then “Close”.
15. Click the “Run” button, and see your project running right away!

Now we'll take a walk through the creation of a full system. It should take no more than about 3 hours of your time to follow the step-by-step instructions here—and we think you'll see the productivity payback for the time you've spent within another 3 hours.

The Scenario—You have been called in to build an Accounts Receivable system for Moore Trading Inc. At your first JAD session, you meet with Bill Moore, the CEO, who explains his system requirements to you:
“It's a pretty simple system,” he says. “We have customers who buy products from us, and we need to be able to bill them.”
“OK,” you say, “we'll need a little more detail than that. You say you need to bill the customers: do they buy just one item at a time, or could there be lots of items on a single invoice?”
“Lots of items on each invoice.”
“And the items—do you enter the product descriptions in free-form?”
“No, no, we have an inventory of various products that can be selected. I forgot to mention that: we also need to keep track of the amount of stock we have of each product. So when an invoice is posted, we need to deduct the products sold from our inventory. And of course, we can't delete any product records if we're holding stock of that item.”
“And the price of each item?” you ask.
“Each product has a cost price to us, a recommended sale price and a minimum sale price. Obviously the recommended price is higher than the minimum price, and the minimum price is usually more than the cost price, but sometimes we do need to sell below cost. When we sell a product, the screen should right away have the recommended price, but the user can modify that if they want—just as long as they don't go below the minimum price.”
“OK, now how do you want to keep track of the customer's account? Do you want an age analysis of his outstanding debts . . . ”
Bill explains, “We don't need any age analysis, but we do need to keep track of how much the customer owes us.
“We have a personal relationship with each individual customer,” he continues, “and we tailor our service to each of them. Each customer has their own individual payment terms—how many days they have to pay—and we even have a standard discount that we give to our best clients. The invoice has a due date based on the date posted plus the customer's terms, and the invoice is discounted according to his standard discount.”
“Does the discount on the invoice ever vary from the customer's pre-set discount?” you ask.
“Sure, every now and then we have a special, and we might decide to change the discount on a particular invoice—but generally we use the pre-set discount.”
“What about refunds? If someone disputes an invoice?”
“We sometimes have to issue credit notes against invoices. Obviously they can only do that if the invoice has been posted; if not, we can just delete the invoice—but you can't change anything on an invoice once it's been posted. If the invoice has to be re-credited, we must record when and why this was done, and credit the customer's due amount. Only a supervisor is allowed to do this.”
“That brings me to security: I presume you want full user authentication throughout the system?”
“Of course. And sometimes we have users who get suspended by a supervisor—they shouldn't be able to operate the system at all.”
“OK, any other special requirements?”
“Ummm . . . ” he ponders, “yes, I want to keep track of the profit we're making on each sale. So I want to know, on both an item and invoice basis, what the goods cost me, and what my gross profit is.”
“Fine, no problem,” you smile. “I'll get to work on it right away.”
“When do you think it'll be ready?” he asks. “Do you think you could do it within two weeks?”
“Well, it's late afternoon now . . . I'll need an hour or so to code it, plus I'll want to test all the business rules to my satisfaction . . . so is tomorrow morning OK?”
Bill is dumbfounded, but manages to stammer, “ . . . and what about stability?”
“Stability?” you feign offence. “I'm building this system with sembleWare™ Visual Welder™!”
And leaving Bill reassured, you set to work . . .

The Design—First up, you identify that you will need the following parts: Customer, Invoice, InvoiceLine, Product and User. You then draw up the following relationship diagram 4200 illustrated in FIG. 42.

Each invoice 4202 requires a customer 4204, so invoice 4202 needs an Include relationship 4206 to customer 4204. The invoice 4202 contains many lines 4208, and the lines 4208 need to refer back to the invoice 4202; we therefore need an OwnMany/OwnedBy relationship 4210 and 4212, respectively, between Invoice 4202 and InvoiceLine 4208. Each invoice line 4208 has a Product 4214—this is another Include relationship 4216, from InvoiceLine 4208 to Product 4214. User is not depicted here since it does not directly relate to the other parts. Within the parts, you identify the following elements:

| Part | Element | Type | Comments |
|---|---|---|---|
| Customer | CustomerID | Identity | Automatically generated |
| | CustomerName | String (50) | Mandatory |
| | PaymentDays | Integer | >=0 |
| | DiscountPerc | Single | >=0.00, <=1.00 |
| | TotalAmountOwing | Decimal | Currency |
| Invoice | InvoiceNum | Identity | Automatically generated |
| | InvoiceDate | DateTime | Default to today |
| | DueDate | DateTime | InvoiceDate + Customer's |
| | | | PaymentDays |
| | TotalSaleAmt | Decimal | Currency |
| | TotalCostAmt | Decimal | Currency |
| | TotalGrossProfitAmt | Decimal | Currency |
| | DiscountPerc | Single | Default from customer |
| | DiscountAmt | Decimal | Currency |
| | InvoiceAmt | Decimal | Currency |
| | PostedYN | Boolean | |
| | PostedDate | DateTime | |
| | PaidYN | Boolean | |
| | PaidDate | DateTime | |
| | CreditNoteYN | Boolean | Indicates if this invoice has been |
| | | | re-credited |
| | CreditNoteDate | DateTime | |
| | CreditNoteReason | Text | |
| InvoiceLine | LineNum | Integer | Automatically generated to be |
| | | | unique per invoice |
| | CostAmt | Decimal | Same as product cost amount |
| | SaleAmt | Decimal | Per item; default to same as |
| | | | product recommended price |
| | Quantity | Integer | |
| | TotalCostAmt | Decimal | Cost amount * quantity |
| | TotalSaleAmt | Decimal | Sale amount * quantity |
| | GrossProfitAmt | | Decimal Total sale amount − |
| | | | Total cost amount |
| Product | ProductID | Identity | Automatically generated |
| | ProductName | String (50) | Mandatory |
| | CostAmt | Decimal | Currency |
| | RecommendedSaleAmt | Decimal | Currency |
| | MinimumSaleAmt | Decimal | Must be less than recommended |
| | | | amount |
| | InStockQty | Integer | |
| User | UserID | String (10) | Key; this is the login name |
| UserName | String (50) | Mandatory | |
| Password | String (50) | Must be displayed with *s | |
| SupervisorYN | Boolean | | |
| SuspendedYN | Boolean | | |

Having designed the parts on paper, you are now ready to put it all together using Visual Welder™.

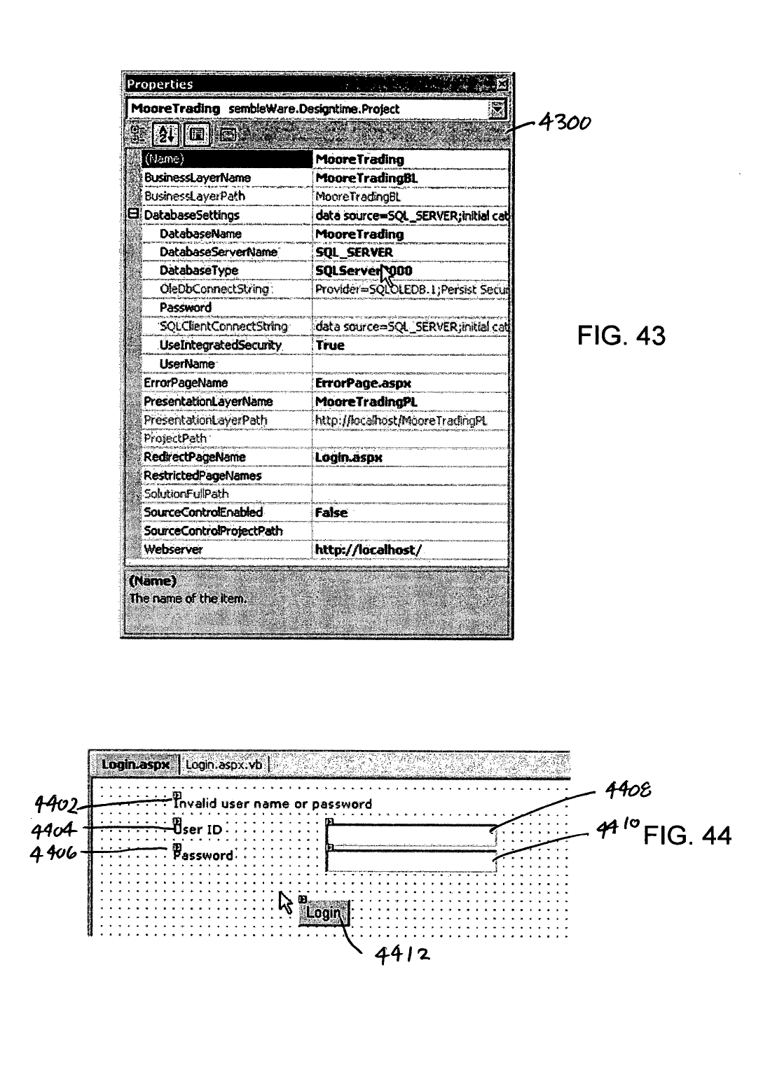

Creating the Project Structure—Setting up the project—Open Visual Studio .NET™, then open the Spatial Editor. Right-click on the background and select “New”. Then right-click again and select “Project Properties” to display the project properties in the Properties window 4300 (FIG. 43). Now you can set up the initial properties of the project, as below, with whatever changes you need to make, according to your local settings.

Creating parts—Now you need to fill your root part. Right-click on the Spatial Editor background and select “New Root Part”. Click on the new part, and using the Properties window, rename it to “AppRoot” (or something similar, according to your taste). We identified previously that we will need five parts in our system: Customer, Invoice, InvoiceLine, Product and User. Of these, four will be owned directly by the root part; InvoiceLine, however, is owned by Invoice—so we'll save it for later. Right-click on the root part, and select “Add -> OwnMany”. Do this four times, then rename each of the holders (the light blue brackets) you've created to Customer, Invoice, Product and User respectively. If you like, you can move them around inside the part so that they're or lined up, or however you prefer to view them.

Now we have four empty holders that need filling. So right-click on each of these in turn, and select “Fill -> New Part”. Each of the holders is now filled with a part (a grey bar), which has taken its name from that of the holder. By default, their table names are also identical to the part names; in the case of User, however, this will be problematic, since “User” is a reserved word in SQL Server. Click on the grey bar inside the “User” holder, and see how it ejects the User part. Right-click on this, and select “Expand”. Now change the TableName property of the User part to “UserInfo” (or something similar). You can collapse the User part again for now by clicking the red “X” button on the top right of the part.

Now, to create the InvoiceLine part, expand the Invoice part like you did with the User part, right click on it and select “Add -> OwnMany”. Rename this holder to “Line”, and as before, fill it with a new part. Now rename the new part to “InvoiceLine”. (It's not really necessary to do all this renaming; we're just demonstrating that the holder and the part that fills it by no means need to have the same name.)

According to our relationship diagram, we're still missing two relationships: the Include relationships from Invoice to Customer and from InvoiceLine to Product. Right-click on the Invoice part, and select “Add -> Include”. This produces an orange-yellow frame on the roof of the part. Rename this holder to “Customer”. Then drag it over to the AppRoot part (the editor will zoom in to the AppRoot part as soon as it detects that's where you're heading). Carry on dragging the holder until it slots over the Customer OwnMany, then drop it. Watch how the frame glides back to the Invoice part, now containing a copy of the OwnMany with which you have just unified it. Do the same on InvoiceLine, to create an Include relationship to Product.

Getting the hang of it? Just in time—the structural work on relationships has just finished. OK, it's element time, and we'll start with Customer. Create five elements either by selecting the Customer part and clicking the “New Element” button on your toolbar, or else by right-clicking the Customer part and selecting “Add -> Element”. You can click on these elements to select them (they appear as grey bars on the back wall of the part). Rename them and assign their data types according to the specification we worked out before (here). CustomerName must be mandatory; PaymentDays should have a MinValue of zero; DiscountPerc should have a MinValue of 0 and MaxValue of 1, and its Format property should be “p” (percentage); TotalAmountOwing should have Enabled set to False (since the user should not modify this directly), and you can set Precision and Scale to 10 and 2 respectively (10 significant digits, 2 of which are after the decimal point, which should be fine for all currency fields). You can also set the Format property to “c” for all currency elements.

Now you do the elements on the remaining four parts, according to the specification. Make sure of the following points:
On Invoice: TotalSaleAmt, TotalCostAmt, TotalGrossProfitAmt, DiscountAmt and InvoiceAmt should all have Enabled=False, since they are all calculated fields. Similarly, DueDate, PostedYN, PostedDate, PaidYN, PaidDate, CreditNoteYN, CreditNoteDate and CreditNoteReason should be disabled, since these will be set during the execution of business rules designed specifically for this purpose.
On InvoiceLine: CostAmt, TotalCostAmt, TotalSaleAmt and GrossProfitAmt are also calculated fields, and should be disabled for user modification. Be sure to set IsKey of LineNum to True—since it's not an Identity element, this property is not automatically set.
On Product: ProductName is mandatory.
On User: UserID must have IsKey set to True.
   Once you've created all the elements on the parts, it's also worthwhile to set the DefaultDescriptionColumn property of each part. This will be the element by which the part is most recognizable to the user—for example, Customer's DefaultDescriptionColumn should be CustomerName; Product's should be ProductName.

Generating the database and prototype—The skeleton of the project is now complete, and we are ready to generate both the underlying database, and a working prototype. So, open the Part Hierarchy, right-click on the “MooreTrading” project, and select “Generate Database”. You will be prompted to have the database created for you if it does not already exist. Then the “Database Generation” dialog box appears. Click the “Create Script” button, then the “Apply Script” button (don't worry about all the “Table does not exist” messages—they're just statements of fact, not errors). That's it, all done—you now have a database ready for use.

Now it's time to generate a prototype. Right-click the project again, and select “Generate Prototype”. When prompted to generate the project, click “Yes”, then sit back, sip a cup or glass of your favorite beverage, and before you know it you'll have a full, working prototype, ready for use! Go ahead, run your prototype, navigate through it, even capture a couple of records if you want. Of course, there are no business rules yet—and we'll deal with that now.

Coding the Business Rules—I—Login Authentication—The first business rule you'll have to code is the login authentication. Before you do this, though, you'll want to make sure that you have a valid login ID—so run your prototype, and click on “User Grid Form” in the main menu. From the grid form, click “Add”, and capture a user record with user name “Me” and password “pass”, which you can use to log in later. When you're done, close your browser to return to design mode.

Now, in the Spatial Editor, right click on your AppRoot class, and add a form, which will appear above the roof of the part, and the camera will swing up to focus on it. Rename it to “Login” (which is what you specified in your project properties for RedirectPageName). Right-click on the form, and select “View Designer”. You will be prompted to generate the form. Then, using regular TextBox, Label and Button controls from the Toolbox, create a form 4400 that looks something like FIG. 44. The controls on this form are:
lblError 4402 (the “Invalid user name” label)
lblUserID 4404 (the user ID label)
lblPassword 4406 (the password label)
txtUserID 4408 (the user ID text box)
txtpassword 4410 (the password text box)
btnLogin 4412 (the button)
   Make lblError label invisible, and make sure that txtpassword has TextMode set to Password.

We're going to use a very simple authentication algorithm, with no encryption, similar to that found in Business Design Patterns—User Authentication (you can find more detail about how it works there). Double-click the login button, and insert the following code:

```
Private Sub btnLogin_Click(ByVal sender As System.Object, ByVal e As
        System.EventArgs) Handles btnLogin.Click
    Dim sError As String
    If Login(sError) Then
        IsAuthenticated = True ‘ This is how we signify that the user
        has been authenticated
        NavigateContinue( )
    Else
        lblError.Text = sError
        lblError.Visible = True ‘ displays a message that the login
        has failed
    End If
End Sub
Private Function Login(ByRef ErrorMsg As String) As Boolean
    With ApplicationSettings.QueryBuilder
        Dim sQuery As String = _{—}
        “select * from UserInfo” & _{—}
        “where UserID = ” & .ToSQL(txtUserID.Text) & _{—}
        “ and Password = ” & .ToSQL(txtPassword.Text) & _{—}
        “ and SuspendedYN = 0” ‘ensures that user has
        not been suspended
        Dim oResult As DataTable =
        ApplicationSettings.ResultQuery(sQuery)
        If oResult.Rows.Count = 0 Then
            ErrorMsg = “Invalid User Name or Password!”
            Return False
        Else
            ApplicationSettings(“UserName”) = txtUserID.Text
            ApplicationSettings(“IsSupervisor”) =
            oResult.Rows(0)(“SupervisorYN”)
            Return True
        End If
    End With
End Function
```

Now, on your project properties, set the “RestrictedPageNames” property to “*, which will limit access to every page in the system, to authenticated users only. Go ahead and test your prototype. Watch the address bar in your browser, and notice how it briefly navigates to your main menu page, before being redirected to the login page you just created. Then login as “Me” with password “pass”, and see how you're directed back to your startup form.

Preventing deletion of certain records—Next, we'll implement Bill's requirement that we shouldn't be able to delete a product record while we're holding stock of that product. When you open the class code in Product.vb (either by right-clicking the part in the Spatial Editor or Part Hierarchy and selecting “Open”, or else by opening it directly from the Solution Explorer), you will notice that there is no explicit code handling deletion. That's because the code is inherited from Product's ancestor class, Part. We're going to override that code by explicitly coding our own Delete( ) method. (You can put this code wherever you want within the class, but we recommend you put it after the “Actions” region—possibly in a new region called “Overrides”.)

```
Public Overrides Sub Delete( )
    If InStockQty.Value <> 0 Then
        Throw New Exception(“Cannot delete a product with
        non-zero stock.”)
    End If
    MyBase.Delete( )
End Sub
```

As is evident from this code, we prevent deletion of the wrong records by throwing an exception. This exception will be caught and displayed on the default ErrorPage.aspx form (though you can change this—click here to see how).

Validation before persisting—While we're working on the product code, there is another requirement that the recommended price must be greater than or equal to the minimum price. It would be possible to accomplish this using some standard validator controls on the product form—but this would contravene our philosophy of keeping business logic in the business layer. So instead, we'll override the Save( ) method in our class, much as we did with the Delete( ) method above:

```
Public Overrides Sub Save( )
    If RecommendedSaleAmt.Value < MinimumSaleAmt.Value Then
        Throw New Exception(“Recommended sale amount cannot be
        less than minimum sale amount.”)
    End If
    MyBase.Save( )
End Sub
```

Go ahead and test the system; see what happens when you try to set the recommended sale amount below your minimum sale amount.

Auto-numbering—Now we're going to start working on the invoicing side of the system, starting at the level of greatest detail—the invoice line. Aside from the calculation of the monetary fields, InvoiceLine has another special requirement: that the line numbers be numbered from 1, incrementing by 1, on each invoice. This differs from the usual identity elements, which are unique among all records, and are auto-generated. We're going to have to calculate the line number manually, using the following code:

```
Private Sub GetNextLineNum( )
    Dim oLocalElement As Element = Owner.ForeignKeys(0).LocalElement ‘ Owner
        refers to the relationship with Invoice; here we retrieve the local foreign key
        element
    Dim sQuery As String = “select max(LineNum)” & _{—}
    “ from ” & TableName & _{—}
    “ where ” & oLocalElement.FieldName & “=” &
        ApplicationSettings.QueryBuilder.ToSQL(oLocalElement.ValueAsObject)
    Dim oResult As Object = ApplicationSettings.ResultQuery(sQuery).Rows(0)(0)
    If IsDBNull(oResult) Then
        LineNum.Value = 1
    Else
        LineNum.Value = CType(oResult, Integer) + 1
    End If
End Sub
```

Note the use of the ToSQL( ) function to format the value correctly for the literal SQL statement.

Then, to make sure that we generate this line number just before we save for the first time:

```
Public Overrides Sub Save( )
    If IsNew Then
        GetNextLineNum( )
    End If
    MyBase.Save( )
End Sub
```

Go ahead and test this; make sure that your generated line number is unique per invoice.

Calculated fields—In the interdependent pair of parts, Invoice and InvoiceLine, there are a number of elements whose values are calculated automatically. In InvoiceLine, these elements are: CostAmt, SaleAmt (default value from Product), TotalCostAmt, TotalSaleAmt and GrossProfitAmt. These amounts, in turn, will affect the aggregate totals in Invoice.

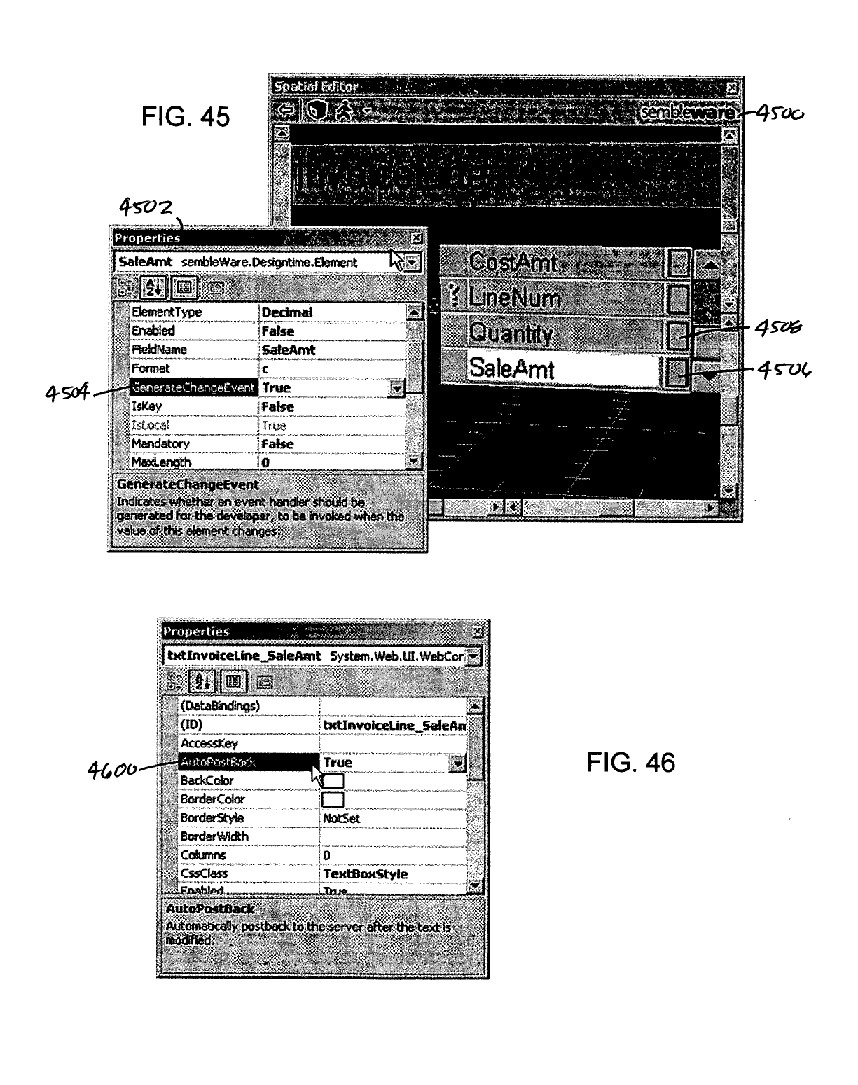

The starting point is to identify what will trigger changes in these calculated values—and we can quickly identify that changes in any of the amount elements would give rise to changes in other amounts (since we're also going to be affecting the Invoice aggregates). As shown in FIG. 45, using the Spatial Editor 4500 and Properties windows 4502, set the GenerateChangeEvent 4504 property to True, for the elements SaleAmt 4506, Quantity 4508, TotalCostAmt, TotalSaleAmt and GrossProfitAmt, as well as for the Product relationship (which you'll find lower down the tree, under “Line”). Now re-generate the part, and open the code. You will notice that inside the “Change Events” region, there are generated method stubs to catch the necessary change events. Let's do this one step at a time, starting with calculating the total sale amount. We will need to fill in some code for the Changed events of SaleAmt and Quantity, as below:

```
        Private Sub SaleAmt_Changed(ByVal Element As Element,
        ByRef CancelChanges
                As Boolean)
            UpdateLineSaleAmt( )
        End Sub
        Private Sub Quantity_Changed(ByVal Element As Element,
        ByRef CancelChanges
                As Boolean)
            UpdateLineSaleAmt( )
        End Sub
Here is the helper method UpdateLineSaleAmt( ) referenced above, which
you may want to put in a separate code region called “Helper Methods”.
        Private Sub UpdateLineSaleAmt( )
            TotalSaleAmt.Value = Quantity.Value * SaleAmt.Value
        End Sub
```

AutoPostBack—If you run the application now, you'll find that the line total calculation works correctly—but the calculation is only performed when the line is saved. What if we want to show the calculated amount as soon as either quantity or item amount changes? This is the function of the AutoPostBack property of your form controls. If set to True, a post-back to the server will be triggered as soon as the value of the control changes. So, as shown in FIG. 46, set the value of AutoPostBack 4600 to True on both SaleAmt and Quantity.

If you were to run the system now, though, it wouldn't quite work yet: you would find that instead of calculating the line total, the value of the control that you just changed would get blanked out! We're not going to go into the reason for this now (if you want to read up on it, see sembleWebPage and the related FAQ question)- to prevent this from happening, double click on each of the controls, and insert the following line into the event code:
BindPage(True)
   Run the application now, and see that the calculated value is displayed as soon as either Sale Amount or Quantity is updated.

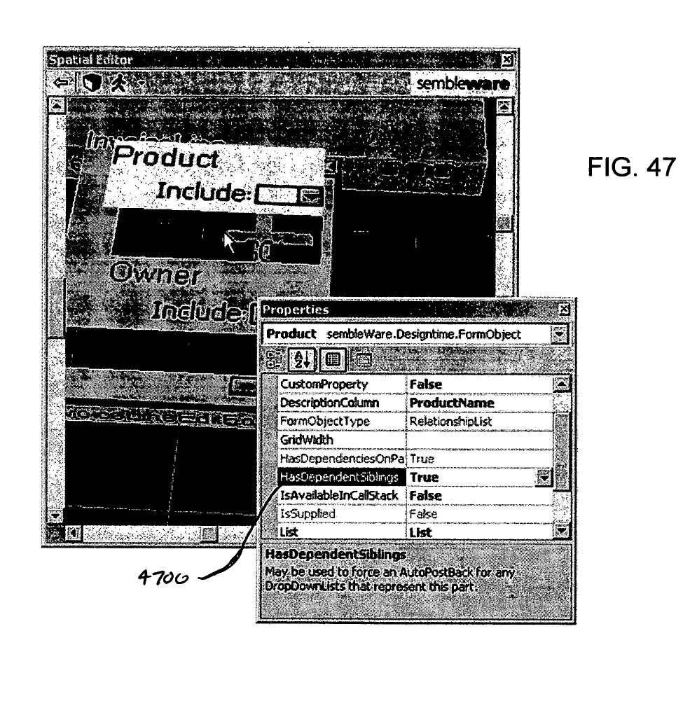

Retrieving values from related parts—The product selected on each line has a recommended price and a cost price, which we need to import to the invoice line whenever the product is selected. While we're working in the presentation layer, we should set up an auto-post-back for the Product drop-down list, so that the recommended sale price is displayed as soon as a product is selected. This will prove slightly simpler than it was for TextBox controls: in the Part Hierarchy, under the InvoiceLineEditForm node, you will find a node for Product. As shown in FIG. 47, select this, and set its HasDependentSiblings property 4700 to True, then regenerate the form. This will automatically set the AutoPostBack property of the control and generate the necessary call to BindPage( ).

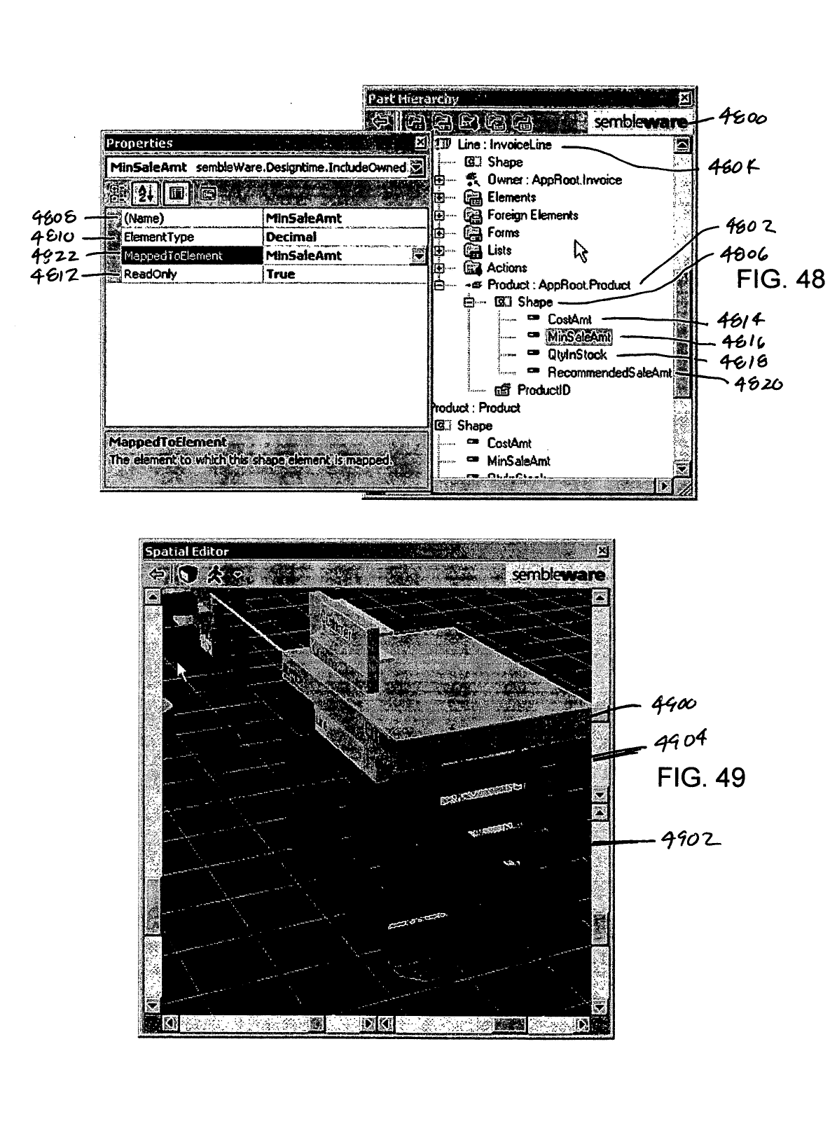

Defining Shape—Before we go any further with business rules, we're going to have to define some shapes, starting with what the invoice line expects of Product. According to our business rules, we're going to need read-only access to the product's cost, recommended and minimum sale amounts, as well as read-write access to the quantity in stock. As shown in FIG. 48, in the Part Hierarchy 4800, locate the Product holder 4802 under InvoiceLine 4804, then right-click on its “Shape” node 4806, and select “Add Element Socket”. You can do this four times to set the Name 4808, ElementType 4810 and ReadOnly 4812 properties of the element sockets CostAmt 4814, MinSaleAmt 4816, QtyInStock 4818 and RecommendedSaleAmt 4820.

In order to map these element sockets, click the drop-down selector of MappedToElement 4822. At first, you will see only one entry, reading “(New)”. This is because the OwnMany holder that contains the Product part does not yet have any shape defined. If you select this “new” entry, a new element socket, with identical element type, will be created on the OwnMany shape, to which this shape element will be mapped. You can do this for each of the four element sockets you created on your Include holder.

Now go to the Product OwnMany holder—you'll see it already contains the four element sockets 4814, 4816, 4818 and 4820 you created above. All that remains is for you to map these element sockets to the correct elements on the Product part. Select each of them in turn, and complete the mapping by setting the MappedToElement 4822 property on each. You'll notice, by the way, that not all elements show up as possible values for MappedToElement 4822. This is because the eligible elements are filtered for compatible data types—i.e. only string-type elements will show for string-type element sockets, etc.

Now that you have defined the shape for the Product holder, right-click on the InvoiceLine node 4804 (which now shows an exclamation mark, indicating that it needs to be regenerated), and select “Generate -> Part Class”. If you look at the class code now, you'll see that within the “Wrapper Classes” code region, there is a new private class called “WrappedProduct”, containing accessor methods for all the properties you defined above, as well as an accessor to the class itself called “GetWrappedProduct”.

Working with the wrapper class—Now we can fill in some code for the change event of the Product relationship—and notice how we use the wrapper class when referring to Product:

Private Sub Product_Changed(ByVal Relationship As Relationship)

Dim oProduct As WrappedProduct = GetWrappedProduct( ) ′

GetWrappedProduct( ) is a generated accessor returning this
lines product within the WrappedProduct wrapper.

If oProduct.Instance.IsNullInstance Then

′ No product selected
SaleAmt.Value = 0
SaleAmt.Enabled = False ′ Disallow modification of sale amount
CostAmt.Value = 0

Else

SaleAmt.Value = oProduct.RecommendedSaleAmt.Value
SaleAmt.Enabled = True ′ Allow modification of sale amount
CostAmt.Value = oProduct.CostAmt.Value

End If
′ Change in sale and cost amount will automatically trigger other
calculations

End Sub

As stated in the comment line above, the change made here to SaleAmt will trigger the code we wrote above to recalculate the line total. When we later code the rules for CostAmt, that code will also get triggered automatically from here. (If for whatever reason you don't want the change events to be triggered, click here to see how to achieve this.) Run your application, and verify that changing the selected product immediately causes the line total to change.

Exercise—OK, your turn now. We know that we're going to have to define the shape that the invoice line expects of Invoice. (The relationship to Invoice is, by default, named “Owner”; you can change that, if you want.) Identify the elements on Invoice that InvoiceLine is going to need access to, and define them in the shape of the “Owner” relationship. (Hint: this is an easy place to make a mistake—ensure that you are defining the shape that InvoiceLine expects of its “Owner” relationship, and not the shape that Invoice expects of its “Line” relationship. The shape node appears under the node of the relationship to which it applies.)

Now link the OwnedBy element sockets to the shape of the Invoice OwnMany holder from AppRoot (creating them on the fly, as before, by setting the MappedToElement property). Finally, complete the mapping of the OwnMany element sockets to the elements themselves, and regenerate the applicable parts (i.e. the ones that are now flagged with a red exclamation mark.) You can do this in one easy step, by the way, just by right-clicking on the project node and selecting “Generate Solution”. It's not important what you call the element sockets; they should just be named in such a way that it's clear what they refer to. In the code that follows, you may find that we've named our element sockets differently from you; don't hassle about it. As long as the mapping is directed to the correct element, everything will work fine.

Chain Reactions—Since each element value change triggers off whatever event code is necessary, it is possible to create a very complex chain reaction, without particularly complex code. Each change event simply needs to worry about setting the values that it directly affects, and any other values that are indirectly affected will be taken care of in other event code. With this in mind, we can fill in the remaining event code and helper functions to calculate all the line amounts and invoice aggregates, including some modifications to our existing event code for SaleAmt and Quantity:

Private Sub SaleAmt_Changed(ByVal Element As Element, ByRef CancelChanges

As Boolean)

Dim oProduct As WrappedProduct = GetWrappedProduct( ) ′ Wrapper class

again!

If Not oProduct.Instance.IsNullInstance Then

′ First validate that sale amount >= minimum sale amount
If SaleAmt.Value < oProduct.MinimumSaleAmt.Value Then

SaleAmt.Value = oProduct.MinimumSaleAmt.Value

End If

End If
′ Now update the sale amount total
UpdateLineSaleAmt( )

End Sub
Private Sub Quantity_Changed(ByVal Element As Element, ByRef CancelChanges

As Boolean)

Quantity affects total cost and total sale amt
UpdateLineCostAmt( )
UpdateLineSaleAmt( )

End Sub
Private Sub CostAmt_Changed(ByVal Element As Element, ByRef CancelChanges

As Boolean)

UpdateLineCostAmt( )

End Sub
Private Sub TotalCostAmt_Changed(ByVal Element As Element, ByRef

CancelChanges As Boolean)

UpdateLineProfitAmt( )
UpdateInvoiceTotalCostAmt(TotalCostAmt.PreviousValue, TotalCostAmt.Value)

End Sub
Private Sub TotalSaleAmt_Changed(ByVal Element As Element, ByRef

CancelChanges As Boolean)

UpdateLineProfitAmt( )
UpdateInvoiceTotalSaleAmt(TotalSaleAmt.PreviousValue, TotalSaleAmt.Value)

End Sub
Private Sub GrossProfitAmt_Changed(ByVal Element As Element, ByRef

CancelChanges As Boolean)

UpdateInvoiceGrossProfitAmt(GrossProfitAmt.PreviousValue,

GrossProfitAmt.Value)

End Sub
′ Helper methods
Private Sub UpdateLineCostAmt( )

TotalCostAmt.Value = Quantity.Value * CostAmt.Value

End Sub
Private Sub UpdateLineProfitAmt( )

GrossProfitAmt.Value = TotalSaleAmt.Value − TotalCostAmt.Value

End Sub
′ Helper methods to update invoice aggregates
Private Sub UpdateInvoiceTotalCostAmt(ByVal OldCostAmt As Decimal, ByVal

NewCostAmt As Decimal)

GetWrappedInvoice.TotalCostAmt.Value += NewCostAmt − OldCostAmt ′ Note

use of wrapper class

End Sub
Private Sub UpdateInvoiceTotalSaleAmt(ByVal OldSaleAmt As Decimal, ByVal

NewSaleAmt As Decimal)

GetWrappedInvoice.TotalSaleAmt.Value += NewSaleAmt − OldSaleAmt ′ Note

use of wrapper class

End Sub
Private Sub UpdateInvoiceGrossProfitAmt(ByVal OldProfitAmt As Decimal, ByVal

NewProfitAmt As Decimal)

GetWrappedInvoice.TotalGrossProfitAmt.Value += NewProfitAmt −

OldProfitAmt ′ Note use of wrapper class

End Sub
Private Sub UpdateInvoiceTotals(ByVal CostAmtDiff As Decimal, ByVal

SaleAmtDiff As Decimal, ByVal ProfitAmtDiff As Decimal)

Dim oInvoice As WrappedInvoice = GetWrappedInvoice( ) ′ Note use of wrapper class
oInvoice.TotalCostAmt.Value += CostAmtDiff
oInvoice.TotalSaleAmt.Value += SaleAmtDiff
oInvoice.TotalGrossProfitAmt.Value += ProfitAmtDiff

End Sub

And to make sure that the values of Invoice and InvoiceLine are kept in synch when the line is either saved or deleted, we need to amend our Save( ) method, and create a new Delete( ) override:

Public Overrides Sub Save( )

If IsNew Then

GetNextLineNum( )

End If
′ Now re-update all the invoice amounts for persisting:
UpdateInvoiceTotals(TotalCostAmt.Value −
TotalCostAmt.LoadValueAsObject,

TotalSaleAmt.Value − TotalSaleAmt.LoadValueAsObject,
GrossProfitAmt.Value − GrossProfitAmt.LoadValueAsObject)

′ Use a transaction to ensure that both or neither of invoice and
line are updated.
ApplicationSettings.BeginTransaction( )
Try

GetWrappedInvoice.Save( ) ′ That wrapper class again!
MyBase.Save( )
ApplicationSettings.CommitTransaction( )
Catch x As Exception

ApplicationSettings.RollbackTransaction( )

Throw x

End Try

End Sub
Public Overrides Sub Delete( )

′ First check that the invoice hasn't been posted
Dim oInvoice As WrappedInvoice = GetWrappedInvoice( )
If oInvoice.IsPosted.Value Then

Throw New Exception(“Cannot delete lines from an invoice that
has been posted!”)

End If
′ Update the invoice totals by the negative of the line totals
UpdateInvoiceTotals(−TotalCostAmt.Value, −TotalSaleAmt.Value, −

GrossProfitAmt.Value)

ApplicationSettings.BeginTransaction( )
Try

oInvoice.Save( )
MyBase.Delete( )
ApplicationSettings.CommitTransaction( )
Catch x As Exception

ApplicationSettings.RollbackTransaction( )

Throw x

End Try

End Sub

You can run your application again now, and check that all the calculated and aggregated elements are working to specification.

Coding the Business Rules—II—Actions—The invoice has some rules that need attention. Firstly, and as shown in FIG. 49, there are two identifiable actions that need to be performed on an invoice 4900: Post 4902 and Credit 4904. Posting finalizes the invoice and disallows any further changes to it; Credit issues a credit note against the invoice—and can only be performed by a supervisor. To create the actions, right click on the Invoice part 4900 and select “Add -> Action”. You will see the action on the right side of the part; it appears as a red bar with a round button on its right. Rename the actions “Post” 4902 and “Credit” 4904, and regenerate the Invoice part 4900. Inside your code you will now find two methods in the “Actions” region, appropriately named Post( ) 4902 and Credit( ) 4904.

Our algorithm for posting will also require a “Post” action on the InvoiceLine part. Create this action exactly as you did for Invoice, and regenerate InvoiceLine. Before we can start coding the actions, though, it's clear from the requirements here that we're going to need to work with elements and actions from related parts—and for this we're going to have to define some shape again.

For you this is mostly old hat now, since you've already defined shape for two previous relationships (click here if you need a refresher). The only difference this time, is that we're also going to have to create a action socket, which is how we invoke actions on remote parts, in much the same way as we use element sockets to access elements of remote parts. You create action sockets in almost exactly the same way as you create shape elements—by right-clicking the shape and selecting “Add Action Socket”. All you have to do from there is name the action socket and map it to the appropriate action on the remote part.

Here's a table describing the shape Invoice expects from its relationships:

| Relationship | Element Socket/Action | Element Type | Read Only |
|---|---|---|---|
| Customer | TotalAmountOwing | Decimal | False |
| | PaymentDays | Integer | True |
| | DiscountPerc | Single | True |
| Line | Post | N/A | N/A |

You can generate the Invoice part again, and fill in the code below for the Post action (explanatory comments inside):

Public Sub Post( )

′ Check: invoice not already posted
If PostedYN.Value Then

Throw New Exception(“This invoice has already been posted.”)

End If
′ Check: there is at least one line on the invoice
If Line_OwnMany.List.DataTable.Rows.Count = 0 Then

Throw New Exception(“An invoice must have at least one line before it may
be posted.”)

End If
′ Business rules: set PostedYN, PostedDate, Customer's due amount and inventory

quantity,

′ all inside a transaction boundary
Try

ApplicationSettings.BeginTransaction( )
PostedYN.Value = True
PostedDate.Value = Now
Save( )
′ Customer amount
Dim oCustomer As WrappedCustomer = GetWrappedCustomer( ) ′ Note use
of wrapper
oCustomer.TotalAmountOwing.Value += TotalSaleAmt.Value
oCustomer.Save( )
′ Each line must be posted; we leave the updating of product info to the
InvoiceLine.
′ For a more scalable system it would be better to do this using a stored
procedure.
Dim oRow As ListRow
For Each oRow In Line_OwnMany.List

′ Convert the ListRow into a Part:
Dim oLinePart As Part = Line_OwnMany.List.GetInstance(oRow)
′ Convert the Part into a WrappedInvoiceLine
Dim oLine As WrappedLine = GetWrappedLine(oLinePart) ′ This

accessor needs an instance parameter - see notes below

′ Post the line (which will update the product)
oLine.Post( ) ′ NB: This calls the Post action socket, not the actual

InvoiceLine.Post( ) action!
Next
ApplicationSettings.CommitTransaction( )
Catch x As Exception

ApplicationSettings.RollbackTransaction( )
PostedYN.Value = False
PostedDate.Value = Nothing

Throw x

End Try

End Sub

You'll see that the usage of wrappers for Include and OwnedBy relationships is not the same as it is for OwnMany relationships. This is because for the former, there is only one possible related part instance; for the latter it is necessary to specify exactly which related part instance we wish to work with.

The code for the Post action in InvoiceLine is as below:

Public Sub Post( )

‘ Must update the product's quantity in stock
Dim oProduct As WrappedProduct = GetWrappedProduct( )
oProduct.QtyInStock.Value −= Quantity.Value
oProduct.Save( )

End Sub

This modification to the product data is, of course, encapsulated within the transaction boundary that was initiated in the invoice's Post action.

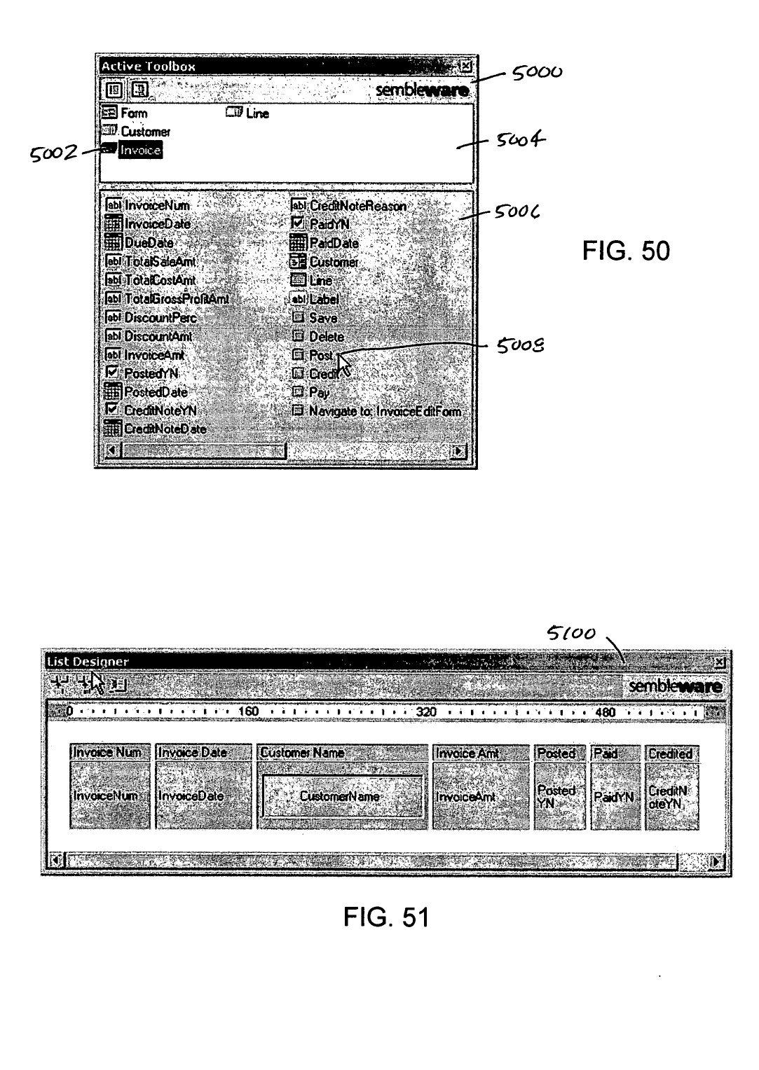

Action buttons—These actions need somewhere for the user to call them from. As shown in FIG. 50, open the invoice edit form, and open the Active Toolbox 5000. Select the Invoice part 5002 in the Form Parts Panel 5004 (the upper window), and you'll see all the elements, relationships and actions within Invoice 5002 (the lower window 5006). Drag and drop a “Post” button 5008 onto the form—this will open the Button Designer window. Here you can select exactly which actions should be performed, and what navigation should take place thereafter. So ensure that the only action you're performing here is to post the invoice, then ensure that you're navigating “Up”—i.e. back to the form that sent you here, which will probably be the invoice grid form. You can test your “Post” action now.

Using ApplicationSettings data—For crediting an invoice, we need supervisor rights. When we originally wrote the login authentication, we inserted the following code after a successful login (see the login authentication code if you cannot remember where we did this):
ApplicationSettings(“IsSupervisor”)=oResult.Rows(0)(“SupervisorYN”)

Now, anywhere we want elsewhere in the system, this value is available to us. So here's some code to allow the user to credit an invoice:

Public Sub Credit( )

′ Check: Invoice has been posted
If Not PostedYN.Value Then

Throw New Exception(“This invoice cannot be credited because
it has not been posted.”)

End If
′ Check: Invoice has not previously been credited
If CreditNoteYN.Value Then

Throw New Exception(“This invoice has already been
credited!”)

End If
′ Check: the user must be a supervisor
If ApplicationSettings(“IsSupervisor”) <> “True” Then

Throw New Exception(“Only a supervisor may perform this
operation.”)

End If
′ Begin crediting
CreditNoteYN.Value = True
CreditNoteDate.Value = Now
′ Now we just need to change the enabled and mandatory state
of the reason field
CreditNoteReason.Enabled = True
CreditNoteReason.Mandatory = True

End Sub

This now enables the user to edit the credit note reason. Note that we have not actually saved the invoice as yet—but when the user saves the record again, the necessary data will be saved.

When we do save again, though, we'll need an override of Invoice's Save( ) method, in order to update the necessary data to the customer record:

Public Overrides Sub Save( )

If CreditNoteYN.Value And Not CreditNoteYN.LoadValueAsObject
Then

′ We must obviously have just run a credit note through.
′ We therefore need to credit the customer now.
ApplicationSettings.BeginTransaction( )
Try

MyBase.Save( )
CreditNoteReason.Enabled = False
Dim oCustomer As WrappedCustomer =
GetWrappedCustomer( )
oCustomer.TotalAmountOwing.Value −=
InvoiceAmt.Value
oCustomer.Save( )
ApplicationSettings.CommitTransaction( )
Catch x As Exception

ApplicationSettings.RollbackTransaction( )

Throw x

End Try

Else

MyBase.Save( )

End If

End Sub

Create a “Credit” action button as you did above for “Post”—but for navigation, put “None”. That's because according to the rules we have instated here, all that happens is that the reason element gets enabled and the credited flag and date elements have their values set; the user still has to click the “Save” or “Apply” button before the action is completed. Run your code now, and test that crediting is working correctly.

Overriding Load( )—When an invoice has been posted, the user may not update any elements directly. For this, we can set the Enabled property of all the elements, as soon as we know whether the invoice has been posted—in other words, directly after it has been loaded.

Public Overrides Sub Load( )

MyBase.Load( )
If PostedYN.Value Then

′ Must disable all elements
Dim oElement As Element
For Each oElement In Elements

oElement.Enabled = False

Next
′ ... and the relationships
Dim oRelationship As Relationship
For Each oRelationship In Includes

oRelationship.Enabled = False

Next

End If

End Sub

Open up a posted invoice now, and check that you can't modify any elements or relationships.

Setting a default value—The default (but overridable) date for an invoice is today's date. Literal default values can be set in an element's DefaultValue property; default values that require calculation or method calls must be written in the part constructor:

Public Sub New(ByVal ApplicationSettings As ApplicationSettings)

′sembleWare: Constructor Start - Do Not Modify
. . .
′sembleWare: Constructor End - Do Not Modify
InvoiceDate.Load(Now, Nothing)

End Sub

Note that you should not set the Value property of the element in the constructor; this would allow change events to be fired, which is not desirable from a constructor.

Incidentally, you'll see these “Do Not Modify” comments all over your code—and they mean what they say! If you play with the code between these comments, your changes will be lost next time the class or form is regenerated.

Exercise—OK, enough copying and pasting; now it's time for you to do a bit more work on your own. We still have the following business requirements for the invoice, and you should have enough knowledge now to implement them:
Due date is equal to the invoice date plus the customer's payment days. (Hint: this code should be triggered when the invoice date changes—or when the customer changes.)
Discount percentage should be copied from the customer record when the customer is selected—but remember that it is overridable.
Discount amount=Total sale amount−discount percentage; total due amount=total sale amount−discount amount. (Hint: there are a lot of elements that could trigger changes in other element values—make sure you account for them all!)
Prevent deletion of an invoice if it has been posted. (Hint: you did this before in InvoiceLine.)
Cascade-delete all invoice lines when deleting an unposted invoice. (Hint:
this is a toughie. Look at the Post( ) method to see how the Invoice interacts with its lines.)
Disable all elements and relationships in InvoiceLine when the invoice has been posted. (Hint: you only know if the invoice has been posted after the element values have been loaded.)
Create an action to pay the invoice, which will set the PaidYN and PaidDate fields, as well as crediting the customer's account with the invoice amount. (Hint: this is very similar to the Post action.)
   When you're done—and it's really worth your while to do this yourself—carry on to the next topic.

Coding the Business Rules—III—In case you had some trouble with the exercise in the previous topic, here's the code we wrote to implement the required business rules. Don't forget that some elements need have GenerateChangeEvent set to True, some controls need to have AutoPostBack set to True, and you will need to write a couple of calls to BindPage( ). If you've forgotten where to put these things, go back to the beginning of Coding the Business Rules, and review it.

Private Sub DiscountPerc_Changed(ByVal Element As Element, ByRef

CancelChanges As Boolean)

UpdateDiscountAmt( )

End Sub
Private Sub DiscountAmt_Changed(ByVal Element As Element, ByRef

CancelChanges As Boolean)

UpdateInvoiceAmt( )

End Sub
Private Sub InvoiceDate_Changed(ByVal Element As Element, ByRef

CancelChanges As Boolean)

UpdateDueDate( )

End Sub
Private Sub TotalSaleAmt_Changed(ByVal Element As Element, ByRef

CancelChanges As Boolean)

UpdateDiscountAmt( ) ′ This will automatically update the invoice
amount

End Sub
Private Sub Customer_Changed(ByVal Relationship As Relationship)

UpdateDueDate( )
UpdateDiscountPerc( )

End Sub
Private Sub UpdateDueDate( )

If Not Customer.Instance.IsNullInstance Then

DueDate.Value = DateAdd(DateInterval.Day,
GetWrappedCustomer.PaymentDays.Value, InvoiceDate.Value)

End If

End Sub
Private Sub UpdateDiscountPerc( )

If Not Customer.Instance.IsNullInstance Then

DiscountPerc.Value =
GetWrappedCustomer.DiscountPerc.Value

End If

End Sub
Private Sub UpdateDiscountAmt( )

DiscountAmt.Value = TotalSaleAmt.Value * DiscountPerc.Value

End Sub
Private Sub UpdateInvoiceAmt( )

InvoiceAmt.Value = TotalSaleAmt.Value − DiscountAmt.Value

End Sub
Public Overrides Sub Delete( )

If PostedYN.Value Then

Throw New Exception(“Cannot delete a posted invoice!”)

End If
Try

ApplicationSettings.BeginTransaction( )
Dim oRow As ListRow
For Each oRow In Line_OwnMany.List

Dim oLinePart As Part = Line_OwnMany.List.GetInstance
(oRow)
Dim oLine As WrappedLine = GetWrappedLine(oLinePart)
oLine.Delete( )

Next
Delete( )
ApplicationSettings.CommitTransaction( )
Catch x As Exception

ApplicationSettings.RollbackTransaction( )

Throw x

End Try

End Sub

And in InvoiceLine, you'll need to have the something along the following lines:

```
Public Overrides Sub Load( )
    MyBase.Load( )
    If GetWrappedInvoice.IsPosted.Value Then
        Dim oElement As Element
        For Each oElement In Elements
            oElement.Enabled = False
        Next
        Dim oRelationship As Relationship
        For Each oRelationship In Includes
            oRelationship.Enabled = False
        Next
    End If
End Sub
```

For paying the invoice, you'll need an action, which we've called Pay:

```
Public Sub Pay( )
  ‘ Check: Invoice has been posted
  If Not PostedYN.Value Then
    Throw New Exception(“This invoice cannot be paid because it has
    not been posted.”)
  End If
  ‘ Check: hasn't been paid before
  If PaidYN.Value Then
    Throw New Exception(“This invoice has already been paid!”)
  End If
  ‘ Check: hasn't been credited
  If CreditNoteYN.Value Then
    Throw New Exception(“An invoice cannot be paid if it has already
    been credited.”)
  End If
  ‘ Pay the invoice
  Try
    ApplicationSettings.BeginTransaction( )
    PaidYN.Value = True
    PaidDate.Value = Now
    Save( )
    Dim oCustomer As WrappedCustomer = GetWrappedCustomer( )
    oCustomer.TotalAmountOwing.Value −= InvoiceAmt.Value
    oCustomer.Save( )
    ApplicationSettings.CommitTransaction( )
    Catch x As Exception
      ApplicationSettings.RollbackTransaction( )
      PaidYN.Value = False
      PaidDate.Value = Nothing
    Throw x
  End Try
End Sub
```

Tweaking the Forms—Up to now, we have been focusing exclusively on business rule issues—but of course, a system is much more than just the business rules. Simply put, it has to look good.

Customizing Lists—Firstly, those grids that got generated for the prototype are a fair starting point, but they probably aren't exactly what you want to show the user. Take the invoice grid form: because the invoice has so many elements, and the prototype by default displays all elements, the grid is way too wide. All we really need to see in this grid are the invoice number and date, the customer's name, the invoice total, whether it's been posted and paid and whether it's been credited.

In order to do this, we need to create a new list layout for Invoice. Right click on the Invoice part, and select “Add -> List”. The Spatial Editor will swing its camera over the newly created list. Name it “CustomList”, or whatever you choose. Now open the List Designer window. You'll see a little yellow block with a horizontal line near the top, labeled “InvoiceNum”. That's a list column; you'll need to add a few more. Insert a column either by right-clicking and inserting a column, or by clicking the “Insert List Column” button. Now select the new column, and in the Properties window, change the Element property to InvoiceDate. OK, you now have a date column for your list.

To get the customer name is slightly more complicated, since this has to be retrieved from a related part. Right-click and select “Add Foreign List” or click on the “Insert Foreign List” button. This will create a new “ForeignList” node in the Part Hierarchy, under the “CustomList” node that you just created. Change its Relationship property to Customer, and note that all the customer elements have now been inserted into the List Designer window. Now you don't want all these columns; all you want is the customer name. So right-click on all the columns you don't want, and select “Hide Column”.

Exercise: Add the remaining columns (Invoice total, posted, paid and credited) to the list. Now you can adjust the column widths and order to your taste, by dragging the column borders, or the columns themselves, as desired. It'll eventually look something like FIG. 51. Now you need to apply this list format to the form. In the Part Hierarchy, locate the InvoiceGridForm node under AppRoot's forms. Listed under this node are listed the form parts—locate Invoice and select it. Then, in the Properties window, change the List property to CustomList. Open the form—and presto! The list looks just like you designed it.

Exercise: You've now completed the tutorial. You just need to clean up the rest of the lists and put them in a more user-friendly format, then you're ready to present your completed system to the soon-to-be-astounded Bill Moore.

### Technical Frequently Asked Questions

Where do I start?

Q: I can understand the concepts of parts and relationships between the parts, but how do I start translating that into a working system? What application structure should I be using? Where do I start?

A: We recommend you start with the Quick Start tutorial. This should give you a feel as to how Visual Welder™ applications can be built.

In general, the recommended standard format for applications—though we by no means exclude other possibilities—is the list-to-detail format, whereby the user is first presented with a “list” form, containing a list of part data, from which he/she can choose to add, modify or delete records. When adding or deleting, the user is navigated to a “detail” form, where modifications to the part instance can be made.

If a part has an OwnMany relationship to another part, it is common for the detail form to have embedded within it a list of the related part data. All of this is easily achieved using the Active Toolbox.

How do I format element values?

Q: How do I format element values so that they appear on-screen as percentages, currency, a particular date format, or any other custom format?

A: Elements have a Format property, which uses exactly the same format strings as are used in Visual Studio™. Once you have defined the format property of an element, there is no need to re-define it on any form controls; the given format will be used automatically.

How do I write a literal SQL query?

Q: I know that Visual Welder™ invisibly takes care of most of my run-of-the-mill select, update, insert and delete queries. I also know that it is possible to manipulate data within parts and in related parts, using the interfaces provided by sembleWare™, and especially by means of wrapper classes. But I've got some more complicated data manipulation to do, and I want to do it by means of literal SQL commands. How do I do it?

A: There are a number of relevant methods provided by the ApplicationSettings object, which is accessible from within every sembleWare™ part via the ApplicationSettings property:
ActionQuery executes an insert, update or delete query.
ResultQuery executes a select query, and returns the results in a DataTable object.
BeginTransaction, CommitTransaction and RollbackTransaction manage transaction boundaries.
To get a reference to the active transaction, use the ActiveTransaction property.
The QueryBuilder property returns a reference to the QueryBuilder object, which provides, among others, the following useful utilities:
   Ready-built select, update, insert and delete queries for parts, using the LoadQuery, UpdateQuery, InsertQuery and DeleteQuery methods. These methods return the SQL string that is used to persist part data.
   The ToSQL method, which formats a value for use in an SQL query according to its data type.

As an example, the Invoice part has an OwnMany relationship to LineItem. LineItem therefore inherits Invoice's key elements, whatever they may be, as part of its own set of keys—with LineItem itself contributing one other key element, LineNum. For the sake of convenience, we wish to generate the line number automatically. Normally we would use an identity element to achieve this; in our case, however, this is not possible, since identity elements generate a number that is unique for a certain part—whereas here we do not require that line numbers be absolutely unique, only that they be unique per invoice. The following code may be placed in LineItem to generate a line number that conforms to these requirements:

```
Public Overrides Sub Save( )
  Dim nCounter As Integer
  Dim sWhere As String = “”
  Dim sJoin As String = “ where”
  If IsNew Then ‘ Note 1
    For nCounter = 0 To Invoice.ForeignKeys.Count − 1 ‘ Note 2
      With Invoice.ForeignKeys(nCounter).LocalElement
      sWhere = sWhere & sJoin & .FieldName & “ = ” &
    ApplicationSettings.QueryBuilder.ToSQL(.ValueAsObject) ‘ Note 3
      sJoin = “ and ”
    End With
  Next
    Dim sQuery As String = “select max(LineNum) from ” &
    Me.TableName & sWhere ‘ Note 4
    Dim oResult As Object =
    ApplicationSettings.ResultQuery(sQuery).Rows(0)(0) ‘ Note 5
    LineNum.ValueAsObject = AppRoot.ZeroIfNull(oResult) + 1
    ‘ Note 6
  End If
  MyBase.Save( ) ‘ Note 7
End Sub
```

Firstly we must only generate a new line number if this is a new LineItem. This we verify using the IsNew property (Note 1).

In order to maintain plug-and-play compatibility, we are using a soft-coded relationship with Invoice. This means that instead of hard-coding the key elements that are provided via the relationship to Invoice, we recurse through all the foreign keys of the relationship (Note 2), adding each one to the “where” clause of the query. In order to ensure that the data values are formatted correctly for the SQL string, we use the ToSQL function (Note 3). Next, we build the literal SQL string (Note 4). Since LineNum is internally defined in this part, it is perfectly acceptable according to the safe code guidelines to hard-code the field name. Indeed, we could have done the same for the table name, but we have used Me.TableName to demonstrate how to soft-code this.

The following line demonstrates how to execute the result query (Note 5). The result of the query is contained in the first row and first column of the DataTable returned by ResultQuery( ). We then increment this value by 1 from the old maximum existing line number (Note 6) to get the new line number—ensuring that we do not run into trouble with null values by using the ZeroIfNull( ) function (code not shown here). Finally, since we have overridden the base class's Save( ) method, we invoke it explicitly to persist all of the part's data (Note 7).

How do I work with interdependent parts?

Q: I like the concept of creating reusable parts, so that I can swap them in and out at will, without requiring any rework to the system. But there are lots of places where I have to code business rules that involve reading and writing data from and to related parts. How do I do it without hard-coding related part classes and properties thereof into my local part class?

A: You can achieve this using wrapper classes. This will maintain the plug-and-play-ability of your system.

For example, parts will frequently need to modify properties on related parts. This is allowable, within the sembleWare™ guidelines for writing safe code, as long as wrapper classes are used. Furthermore, it will also be necessary to persist the related part's data explicitly—unlike most persisting of data, which is performed invisibly to the developer. The persisting of remote part data should be performed within transaction boundaries, as in the example below.

A very common application of this requirement is found wherever aggregation is required—e.g. Invoice total should be the sum of all its line item amounts. So every time an invoice line is created, deleted or changed, the difference in item amount should be updated to the invoice total, as in the code fragment below from LineItem:

Private mbInvoiceChanged As Boolean
Private Sub UpdateInvoiceAmt(ByVal OldLineAmt As Double,
ByVal NewLineAmt As Double)
Dim oInvoice As New WrappedInvoice(Invoice.Instance)
oInvoice.Amount.Value = oInvoice.Amount.Value − OldLineAmt +
NewLineAmt
mbInvoiceChanged = OldLineAmt <> NewLineAmt Or
mbInvoiceChanged
End Sub

Note that the Invoice class is never referenced directly (the Invoice object variable here is a reference to the relationship from LineItem to Invoice); instead we use a WrappedInvoice, which is declared (in automatically generated code) as follows:

```
Private Class WrappedInvoice
    Inherits WrappedPart
    Public ReadOnly Property Amount( ) As DoubleElement
        Get
            Return CType(Instance, Invoice).InvoiceAmt
        End Get
    End Property
    Public Sub New(ByVal Instance As Part)
        MyBase.New(Instance)
    End Sub
End Class
```

There are two cases when UpdateInvoiceAmt should be called:
1. When the LineAmt element's value is changed; and
2. When a line is deleted (i.e. the amount changes to zero).

To trap the LineAmt value change, we set the GenerateChangeEvent property of the element to True. This will generate a method called LineAmt_Changed, which would be implemented as below:
Private Sub LineAmt_Changed(ByVal Element As Element, ByRef CancelChanges As Boolean)
   UpdateInvoiceAmt(LineAmt.PreviousValue, LineAmt.Value)
End Sub

To trap the Delete event, we need to override the Part's Delete method, as below:

```
Public Overrides Sub Delete( )
    UpdateInvoiceAmt(LineAmt.Value, 0)
    If Not mbInvoiceChanged Then
        MyBase.Delete( )
    Else
        Try
            ApplicationSettings.BeginTransaction( )
            Parent.Instance.Save( )
            MyBase.Delete( )
            ApplicationSettings.CommitTransaction( )
            Catch Exception As Exception
                ApplicationSettings.RollbackTransaction( )
            Throw Exception
        End Try
    End If
End Sub
```

Notice the transaction boundaries implemented here, which ensure that we update either both or neither of Invoice and LineItem.

Similarly below, when we save the LineItem by overriding the base class's Save method, we must also put transaction boundaries in place to maintain data integrity.

```
Public Overrides Sub Save( )
    If Not mbInvoiceChanged Then
        MyBase.Save( )
    Else
        Try
            ApplicationSettings.BeginTransaction( )
            Parent.Instance.Save( )
            MyBase.Save( )
            ApplicationSettings.CommitTransaction( )
            Catch Exception As Exception
                ApplicationSettings.RollbackTransaction( )
            Throw Exception
        End Try
    End If
End Sub
```

Calls to related classes' Save and Delete methods can also chain effectively, in the event that the related classes have also overridden these methods. It is not necessary for any class to be aware of any such chaining of code—indeed, it is undesirable, since it will hinder the plug-and-play-ability of the parts. The transaction boundaries implemented within each method will ensure that data integrity is maintained.

How do I use Radio Buttons on a form?

Q: One of the elements in my part has a certain limited number of possible values, and I want to represent it on the form as a RadioButtonList control. How do I do it?

A: The element should have its ElementType property set to either StringIndicator or NumericIndicator.

Once the element is marked as an indicator element, you can add options by right-clicking the element in the Part Hierarchy and selecting “Add Option”. You can then change the value and description of the option in the Properties window. Now when you use the Active Toolbox to place this element on a form, it will automatically create a RadioButtonList control to represent it.

How do I change the settings of a button after it's been created?

Q: I created a button using the Button Designer, and set all the necessary properties. Now the button is on the form, and I realized it needs some settings changed: it needs to navigate to a different form, perform different actions, etc. How do I get back to the Button Designer? Surely I don't have to delete and re-create the button?

A: Correct; you don't have to delete and re-create the button.

In the Part Hierarchy, locate the form you are working on, and expand its node. Below this node, you will now see, among other things, a node for each button on the form. Just right click on the node of the button you wish to modify, and click “Edit . . . ”. This will re-open the Button Hierarchy window for you to make any modifications you wish to this button.

How do I change the look and feel of my forms?

Q: I used the “Generate Prototype” feature to create forms throughout my system. Functionally, it's great, but I don't like the look. How do I change the way my forms look and feel?

A: You can change the template on which your project is based. By default, your project will use the sembleWare™ standard template, but you can change this by setting the FormTemplate property of your project. When you change FormTemplate, you will be prompted to upgrade the forms in your project to the new template.

How do I get dependent drop-down lists to work?

Q: I have two Include relationships from one of my parts, to two related parts. These two related parts are interdependent, with an OwnMany/OwnedBy relationship between them. I want to make sure that when the user selects a value from the owner part in my form's drop-down list, it limits the values available in the owned part drop-down list. In addition, I wish to ensure that if the user first selects a value from the owned part's drop-down list, the form will automatically populate the value for the owner part. How do I do it?

A: To demonstrate the solution, we will use some of the parts described in the Geographical Data relationship pattern: Country owns many states; State owns many cities; Customer has Include relationships to each of Country, State and City.

Starting from the assumption that the relationships are all referring to the same set of foreign elements (this is achieved by ensuring that the foreign elements listed in the Part Hierarchy under Customer for these three relationships have matching names), and we already have a Customer form (see How to Create a Form for more on this), use the Active Toolbox to drop Country, State and City drop-down combos on the form.

Now, to ensure that we refresh the combo data every time a selection is made, we need to rebind the page—i.e. refresh the latest set of data into all controls (see sembleWebPage Life Cycle for more on this). Double-click on the Country drop-down, and insert the line in red below, to create the following event code:

```
Private Sub cboCountry_SelectedIndexChanged(ByVal sender
As System.Object,
        ByVal e As System.EventArgs) Handles cboCountry.
        SelectedIndexChanged
    BindPage(True)
End Sub
```

Do the same for the State and City drop-downs. Then set the AutoPostBack property to True on all three of these controls. If you wish, you can test your Customer page now, and observe its behavior. Notice how when you select a city (you'll obviously need to populate your database for this), the other two drop-downs are filled in automatically with the correct values for country and state; if you change the value of state, the correct value for country is filled in, while the value for city is blanked out; if the value of country is changed, both of the other drop-downs are emptied. This, however, only satisfies one half of our requirements. Notice that at this point, when you select a country, you are still able to select states and cities from other countries. To correct this, we will need to place limiters on the state and city lists.

In the form code, you will find generated methods called StateList and CityList, that appear as follows:

```
Private ReadOnly Property StateList( ) As List
    Get
        Return PreservedList(“State”, Customer._State.List)
    End Get
End Property
Private ReadOnly Property CityList( ) As List
    Get
        Return PreservedList(“City”, Customer._City.List)
    End Get
End Property
```

These methods are called whenever we need to fetch data for either of these lists. To limit these lists, replace the code above with the following:

```
Private ReadOnly Property StateList( ) As List
  Get
    Dim oList As List = PreservedList(“State”, Customer._State.List)
    If Not Customer.Country.Instance.IsNullInstance Then ‘ Note 1
      oList.LimitByRelatedPart(Customer.Country.Instance,
        “Country”) ‘ Note 2
    End If
    Return oList
  End Get
End Property
Private ReadOnly Property CityList( ) As List
  Get
    Dim oList As List = PreservedList(“City”, Customer._City.List)
      If Not Customer.State.Instance.IsNullInstance Then ‘ Note 1
        oList.LimitByRelatedPart(Customer.State.Instance,
        “State”)
      ElseIf Not Customer.Country.Instance.IsNullInstance
      Then ‘ Note 3
        oList.LimitByRelatedPart(Customer.Country.Instance,
        “Country”) ‘ Note 4
      End If
    Return oList
  End Get
End Property
```

We typically would only wish to limit dependent drop-downs if there is an actual value by which to limit them—for this reason, we check that the limiting part is not a null instance (Note 1). We then limit the list by the value of country (Note 2). Note that if we were to omit the null instance check, this would also allow limiting by a blank value for country, which would have the effect of disabling the state and city drop-downs until a value is filled in for country—which may also be desirable, depending on the system requirements.

For the city list, the requirements are slightly more complicated, since we have to cater for the possibility that country may be filled in, while state is left blank (Note 3). In this event, we can simply limit the city by country (Note 4), but this is only possible if City has an OwnedBy relationship directly to Country—either implicitly (where Country has an OwnMany relationship to City) or explicitly.

How do I change the element displayed in a DropDownList?

Q: When I created a DropDownList to represent an Include (or OwnedBy) relationship, I used the Active Toolbox to select a certain element from the related part to display in the control. If I want to change the element displayed, either because I've swapped out the related part, or simply because I just want to show a different element, how do I do it now?

A: In either the Spatial Editor or the Part Hierarchy, locate the form object (found within the part it represents). Inside this form object, you will see the primary part of the form, under which are found the related parts that are used on the form. Locate the related part that is represented by the DropDownList in question, and select it. Now use the Properties window to change the DescriptionColumn property to the desired element.

How do I disable a control in the presentation layer only?

Q: I have a control representing an element that I want to disable only on certain forms, not others—so I don't want to set the element's Enabled property to False. When I tried to set the control's Enabled property to False at design time, it didn't work; when the form opened up, the control was enabled again. What must I do to disable the control?

A: You are correct; the design-time setting of the control will be overridden at run time, by the BindPage( ) method, which sets the values and enabled state of all controls. You will therefore need to disable your control at run time, in the RenderParts event, which makes the call to BindPage( ). Make sure to put your code after the “Do Not Modify” comments!

```
Private Sub MyForm_RenderParts( ) Handles MyBase.RenderParts
  ‘sembleWare: Render Parts Start - Do Not Modify
  BindPage(True)
  ‘sembleWare: Render Parts End - Do Not Modify
  txtMyElement.Enabled = False
End Sub
```

How do I make a custom error page?

Q: When an error is raised in my application, the browser navigates to the default error page. I don't like the look and feel of this page, and I'd like to replace it with my own error page. How do I do this, and where can I get the error message to display?

A: The Visual Welder™ project (selectable in the Part Hierarchy) has a property for this purpose, called ErrorPageName. Just set this property to the name of a page you wish to create (say MyErrorPage.aspx). Then, under the root part, create a form by the same name, and generate it. You may then set up the page with whatever controls you wish.

To access the error message that led to the error page, use the GetLastError( ) method of sembleWebPage. This returns the Exception object that the Microsoft™ runtime wraps around the originating error. From here, use the InnerException property, which will return the Exception object that was thrown to create the current error. Below is the syntax that will return the correct Exception:
GetLastError(Session.SessionID).InnerException
   You can use this object to display the desired message on the form.

If you want to see your error screen in debugging mode, ensure that your the “customErrors” property in the Web.config file has its mode set to “On”—if it's in “RemoteOnly” mode, you'll see the regular ASP error page when you're debugging, and the custom error page will only show when a remote computer views the error.

How do I show unrelated parts or lists on a form?

Q: I have created a form that needs to display, apart from the standard elements and relationships of the primary part of the form, certain elements and lists from totally unrelated parts. I can't drag-and-drop these from the Active Toolbox, because they're obviously not listed there—so how do I do it?

A: You can manually add your own references to unrelated parts by writing form code.

All related lists and parts used on a form have generated accessors, of the following format:

```
Private ReadOnly Property RegionList( ) As List
  Get
    Return PreservedList(“Region”, Customer._Region.List)
  End Get
End Property
Private ReadOnly Property Invoice( ) As Invoice
  Get
    Return SuppliedPart(“Invoice”, New
    InvoiceRelationship(ApplicationSettings))
  End Get
End Property
```

You can copy the format of these accessors, and modify them as desired in order to “import” unrelated parts onto your form. You can then add controls from the regular toolbox (not the Active Toolbox), and bind them to your unrelated parts and lists in the BindPage( ) method.

A practical example of this is given in How do I make List Filters?

How do I make list filters?

Q: I have a “browse” form—i.e. a form with a grid containing a listing of part data. The table underlying the part, however, is very large, and it is highly impractical to locate the desired records in the list without making use of some kind of filtering. How do I achieve this in Visual Welder™?

A: The method of making list filters in the current version of Visual Welder™ is fairly circuitous; in future releases we expect to have list filtering more fully integrated into the architecture.

The first thing to do is to create a non-persisting part, containing all the elements and relationships that are used to filter lists in the application. One such part will suffice for the entire application; we suggest that you name it “AppListFilters”. (“ListFilter” and “ListFilters” are classes within the Visual Welder™ libraries; it is best not to duplicate these class names.) This part should be created in an OwnMany holder off the root part (click here for how to do this). Ensure that the part's Persist property is set to False.

For every TextBox control that will be used to filter a list, there will be either an element in AppListFilters; for DropDownList filter controls, we create an Include relationship. For example, if we wish to limit an invoice list by date range and by customer, we would have elements for DateFrom and DateTo, and an Include relationship to Customer. Generate AppListFilters by right-clicking on it in either the Spatial Editor or the Part Hierarchy, and selecting “Generate Part Class”.

Now we need to start making modifications to the list form. Assuming that you already have a list form with a grid, use the regular toolbox (not the Active Toolbox) to create whatever controls will be used as filters (either TextBox or DropDownList controls), plus whatever labels or other controls will be used to enhance the user interface. In our example, on the InvoiceList form we would create two TextBox controls (txtDateFrom and txtDateTo) and one DropDownList (cboCustomer). Make sure that the AutoPostBack property of these is set to True, then double-click each of them and add the following line into the event code (TextChanged or SelectedIndexChanged):
BindPage(True)
   This will ensure that the value of the control will be bound to the session, and not be lost in the postback to the server.

Now we need to create a reference to an AppListFilters part. In the declarations section of the form, put the following declaration:

```
Private moListFilters As AppListFilters
  Create an accessor for this as follows:
  Private ReadOnly Property InvoiceListFilters( ) As AppListFilters
  Get
    If moListFilters Is Nothing Then
      If IsPostBack Then
        moListFilters = SuppliedPart(“InvoiceListFilters”, New
    AppListFiltersRelationship(ApplicationSettings))
      Else
        moListFilters = SupplyPart(“InvoiceListFilters”, New
    AppListFilters(ApplicationSettings), PreserveMethod.SmartCache)
      End If
    End If
    Return moListFilters
  End Get
End Property
```

It will also be desirable to create a list accessor for any DropDownList filters, following the following template:

```
Private ReadOnly Property CustomerList( ) As List
  Get
    Return PreservedList(“Customer”, InvoiceListFilters.Customer.List)
  End Get
End Property
```

In order to ensure that the filter controls are bound to the AppListFilters part, we will need to write some custom code in the BindPage( ) method. Take note that there is a generated code block here, delimited by “Do Not Modify” comments. Any custom code that is written inside this block will be lost when the form is regenerated, so be sure to put the following code outside the comments (it is immaterial whether you place this before or after the generated block):

```
If BindAppRoot Then
  Dim oListFilters As AppListFilters = InvoiceListFilters
  BindElement(txtDateFrom, oListFilters.DateFrom)
  BindElement(txtDateTo, oListFilters.DateTo)
  BindRelationship(“Customer”, CustomerList,
  “CustomerName”, cboCustomer)
End If
```

In other words, for each TextBox filter, a call should be made to BindElement( ); for each DropDownList, a call should be made to BindRelationship( ).

Now we just need to write the code that will attach these controls as list filters. The list to be filtered should already have a list accessor (e.g. InvoiceList( )); we need to make some modifications to this. NB: Beware, though, that this list accessor is generated code, and any changes made to it at this point will be lost the next time the form is generated. See Writing Custom Form Properties for how to ensure that the code below is not lost.

```
Private ReadOnly Property InvoiceList( ) As List
  Get
      Dim oList As List = PreservedList(“Invoice”,
  AppRoot._Invoice_OwnMany.NiceInvoiceList)
      LimitInvoiceList(oList)
      Return oList
  End Get
End Property
Private Sub LimitInvoiceList(ByVal List As List)
  With List.AndFilters
  .ClearAll( )
    If IsDate(txtDateFrom.Text) Then
    .Add(New ListFilter(“FromDate”, “InvoiceDate”, txtDateFrom.Text,
  DataType.DateTime, FilterType.GreaterThanOrEqualTo))
      End If
  If IsDate(txtDateTo.Text) Then
      .Add(New ListFilter(“ToDate”, “InvoiceDate”, txtDateTo.Text,
        DataType.DateTime, FilterType.LessThanOrEqualTo))
  End If
  End With
  If Not InvoiceListFilters.Customer.Instance.IsNullInstance Then
    List.LimitByRelatedPart(InvoiceListFilters.Customer.Instance,
    “Customer”)
  End If
End Sub
```

LimitInvoiceList( ) checks all filters for validity, and if they are valid, they are added to the filters of the list. At this point, the list filters should operate correctly.

How do I change an element's value without raising a change event?

Q: I have an element that is set to generate a change event when its value changes (using the GenerateChangeEvent property of the element in either the Spatial Editor or the Part Hierarchy). This has the unintended effect of causing the change event to fire even when I change the element's value in my own code. Is there any way that I can change the element's value without causing the change event to fire?

A: There is a very simple way of doing this, using the Load( ) method of the element. This method sets both the current and “load” value (the value against which the current value is compared to check whether the element needs to be saved), without raising any change events.

Q: I want to have a button that navigates to another page, but a part I need for the destination form is not used on my current form. How do I send the right part to the destination form?

A: We will use an example here of a destination form that shows the currently effective tax rate, to which we wish to navigate from an unrelated form, assuming that the detail form for this part already exists.

From the Active Toolbox, drag an “Open” button onto the origin form. In the Button Designer, the “Parts to be supplied” panel will contain all parts that are required for the target form. We select the “TaxRate” part, and in the “Available parts” panel, we select “Part supplied in user code”.

When we click “OK”, the following event code is generated under the button:

```
Private Sub btnTaxRate_Click(ByVal sender As System.Object, ByVal e
    As System.EventArgs) Handles btnTaxRate.Click
  ‘ Button Code: Generated by sembleWare - Start
  ‘ Note: Part “TaxRate”, required for the destination page, is
    supplied by non-generated user code
  NavigateDown(“TaxRateEditForm.aspx”)
  ‘ Button Code: Generated by sembleWare - End
End Sub
```

As noted in the generated comments, the part “TaxRate” must be supplied by the developer. This must be performed before the generated code block; any code written inside the generated code will be lost the next time the form is generated.

In the TaxRate part, we have the following method:

```
Public Shared Function GetTaxRate(ByVal ApplicationSettings As
    ApplicationSettings, ByVal AsAt As Date) As TaxRate
  Dim sQuery As String = “select max(EffectiveDate)
  from TaxRate where
    EffectiveDate = (select max(EffectiveDate) from TaxRate where
    EffectiveDate <= “ &
    ApplicationSettings.QueryBuilder.ToSQL(AsAt) & ”)”
  Dim oResult As Object =
  ApplicationSettings.ResultQuery(sQuery).Rows(0)(0)
  Dim oTaxRate As TaxRate = New TaxRate(ApplicationSettings)
  oTaxRate.EffectiveDate.ValueAsObject = oResult
  oTaxRate.Load( )
  Return oTaxRate
End Function
```

This returns the effective tax rate as at the date supplied. Note that loading the part is performed by filling in its key element(s), then invoking the Load( ) method. Now we can call this method from the origin form, as follows:

```
Private Sub btnTaxRate_Click(ByVal sender As System.Object, ByVal e
    As System.EventArgs) Handles btnTaxRate.Click
  Dim oTaxRate As TaxRate =
  TaxRate.GetTaxRate(ApplicationSettings, Now)
  SupplyPart(“TaxRate”, oTaxRate)
  ‘ Button Code: Generated by sembleWare - Start
  ‘ Note: Part “TaxRate”, required for the destination page,
    is supplied by non-generated user code
  NavigateDown(“TaxRateEditForm.aspx”)
  Button Code: Generated by sembleWare - End
End Sub
```

The SupplyPart( ) method places the part in the page call stack, so that the destination page can use it.

How do I navigate directly to an edit form without using a grid?

Q: I have an edit form that I want to open directly from the main menu, without going via a browse form. How do I do it?

A: You can navigate to any form in the project, from any other form. The only trick is, you might have to provide some parts explicitly.

In this case, let's say we want to have a link to a “quick customer capture” form, from the main menu. Assuming the quick capture form already exists, open the main menu form, and from the Active Toolbox, drag and drop a “New” button. In the Button Designer, you can then change the caption and ID of the button, and select the form to which you wish to navigate (“Customer.CustomerQuickCapture”, or whatever you've called it).

You'll now see in the “Parts to be supplied for destination page” box, a line that says, “[UNDEFINED] -> Customer”. You'll need to supply a customer part—so highlight this line, and in the “Available parts” panel, select “[Part supplied in user code]”—and click OK.

Now you'll see your new button on the form. Double-click on it to see the button's event code, and you'll notice a generated comment to the effect that the developer must supply the “Customer” part. This must be done before the generated code block in the event code. So here's how you do it:

```
Private Sub btnCustomerQuickCapture_Click(ByVal sender As
  System.Object, ByVal e As System.EventArgs) Handles btnAdd.Click
  Dim oCustomer As Part = New Customer(ApplicationSettings)
  SupplyPart(“Customer”, oCustomer)
  ‘ Button Code: Generated by sembleWare - Start
  ‘ Note: Part “Customer”, required for the destination page, is
  supplied by non-generated user code
  NavigateDown(“CustomerQuickCapture.aspx”)
  ‘ Button Code: Generated by sembleWare - End
End Sub
```

How do I display errors on the current page?

Q: While performing certain business logic, my business layer can throw several exceptions relating to the violation of business rules. In the presentation layer this causes the browser to navigate to the standard error page, which doesn't look nice, because it gives the user the impression that there's been some kind of system failure! Isn't there some way of displaying the error on the same page?

A: Yes, there is, using the Error Message Label, found in the Active Toolbox's Control Palette, when “Form” is selected in the Form Parts Panel. Just drag and drop this label onto your form, and all exception messages will be displayed on your form in this label, instead of on a separate error page.

How does saving of data work?

Q: I'm interested to know how parts are saved to the database. What is your algorithm for data persisting?

A: Parts are only saved when at least one element or relationship value has changed since loading. This is determined by comparing the current value of the element with the loaded value; this is the function of the MustSave( ) method, which exists on both elements (indicating whether the element value has changed) and parts (indicating whether any element values in the part have changed).

In the event that MustSave( ) for the part is true, the part is persisted in the overridable Save( ) method, using an Insert or Update query, depending on whether or not this is a new part. Only elements whose value has changed will be included in this query.

How does concurrency protection work?

Q: I have a multi-user environment, and I'm worried that two users might try to edit the same record at the same time, which would obviously cause corruption in the data. How do I prevent this from happening?

A: The good news is, Visual Welder™ automatically takes care of concurrency issues—there is no possibility of data corruption through simultaneous editing. There are two possible ways to configure concurrency protection; for more about this, see Concurrency.

What happened to the code I wrote?

Q: Hey! I wrote a whole block of custom code in my part class, and now it's disappeared! What happened to it?

A: Chances are, the code you wrote was placed within a block of Visual Welder™ generated code. These blocks are delimited at both ends by comments beginning with “sembleWare:” and ending with “Do Not Modify”. Any custom code placed within these generated blocks will be lost the next time the part is generated!

Another possibility is that you wrote form code in a List or form part accessor without setting the CustomProperty property of the form part to True. See Writing Custom Form Properties for how to make these modifications safely.

Why does my control get blanked out when I set its value?

Q: This is really weird—some of my controls, as soon as their value is set at run-time, get blanked out, or restored to their original value! Why is this happening, and how do I fix it?

A: This typically happens when you set the AutoPostBack property of the control to True, but you don't make a call to BindPage( ) in the control's change event code.

BindPage( ) is used to synchronize the value of form controls to the appropriate elements and relationships. AutoPostBack causes an automatic call back to the server as soon as the value of the control changes. As soon as the call to the server returns, the page controls are re-bound to the appropriate elements and relationships. If BindPage( ) was not called in the control's change event code prior to this hit on the server, then the newly entered value for the control will not be written to the form element, and when the call from the server returns, the old value of the control will be restored.

All this can be automatically handled for you by simply setting the HasDependentSiblings property of the form part (which can be found within the form in either the Spatial Editor or the Part Hierarchy) to True. The next time the form is generated, the necessary code will be created by the add-in.

Why have my LinkButtons stopped working?

Q: My application was working fine when I last ran it. Now I've made a couple of changes to one form, and suddenly all the LinkButtons have stopped working! What happened?

A: This is a known bug in Microsoft™ Visual Studio .NET™: the event handling code for the buttons occasionally loses the “Handles btnOpen.Click” phrase, which effectively leaves the method as “dead” code.

There are two possible work-arounds for this:
Double click on the button in design-time. This will restore the “Handles” code.
Right-click on either the form, part or project in the Part Hierarchy, then select “Generate”. This will regenerate any missing “Handles” code within the scope selected.

The present invention thus provides an efficient optoelectronic signal communications system overcoming process incompatibilities previously associated with implementing optical components in high performance electronic systems. While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. For example, the optical signal communications system may be configured to provide a bus structure, comprising joint transmit and receive elements fabricated together at a single position on the waveguide. Further, the principles of the present invention are practicable in a number of process technologies. It is therefore intended that the appended claims encompass any such modifications or embodiments.

1. A software development tool, comprising:
a set of standardized code segments;
an interface for defining a structure of a project; and
a code generator communicably coupled to the set of standardized code segments and the interface, wherein the code generator creates the project from an existing database, or creates a new database from the project, or creates a computer program from the project.

2. The software development tool as recited in claim 1, wherein the structure includes one or more business rules that are implemented using the standardized code segments.

3. The software development tool as recited in claim 2, wherein the one or more business rules are automatically inserted into the project and the one or more business rules comprise record deletion, validation before persisting, numbers, calculated fields, retrieve values for related parts, define the shape of a part, actions, action buttons, defaults or data structure relationship rules.

4. The software development tool as recited in claim 1, wherein the code generator incorporates the standardized code segments into the project, generates one or more customized code segments in accordance with the structure and saves the generated code segments into the project.

5. The software development tool as recited in claim 4, wherein the standardized code segments comprise machine code stored in a library and the generated code segments comprise human readable code.

6. The software development tool as recited in claim 1, wherein the interface comprises two or more interface functions selected from the group comprising of a spatial editor, a part hierarchy, a part list and an active toolbox.

7. The software development tool as recited in claim 1, wherein the interface is a graphical user interface.

8. The software development tool as recited in claim 6, wherein the spatial editor displays a three dimensional representation of the structure of the project.

9. The software development tool as recited in claim 8, wherein the structure of the project can be defined and modified by manipulating the three dimensional representation.

10. The software development tool as recited in claim 1, wherein the structure comprises one or more objects interconnected by one or more relationships.

11. The software development tool as recited in claim 10, wherein the one or more relationships are selected from a group comprising a one-to-many relationship or a many-to-one relationship.

12. The software development tool as recited in claim 1, wherein the structure comprises one or more objects wherein each object is a part and each part comprises one or more elements and one or more holders.

13. The software development tool as recited in claim 12, wherein each element is of a type selected from the group comprising identity, string, integer, single, number, datetime, Boolean and text.

14. The software development tool as recited in claim 12, wherein each element comprises an intrinsic property of the part and each holder comprises a relationship between the part and another part.

15. The software development tool as recited in claim 12, wherein each part further comprises an action, a form or a list.

16. The software development tool as recited in claim 15, wherein each action comprises one or more user defined operations that are applicable to the part, each form comprises one or more screen layouts to present the part to a user, and each list comprises one or more columnar layouts to display a list of the parts to the user.

17. The software development tool, as recited in claim 10, wherein the one or more objects comprise:
a root object; and
one or more other objects directly or indirectly related to the root object.

18. A system comprising:
a processor;
a memory communicably coupled to the processor
a data storage device communicably coupled to the processor;
one or more input/output devices communicably coupled to the processor selected from a group comprising a display, a keyboard, a mouse, a printer, a microphone, a speaker and a video camera;
a computer program stored in the memory and data storage device comprising a set of standardized code segments, an interface for defining a structure of a project, and a code generator communicably coupled to the set of standardized code segments and the interface, wherein the code generator creates the project from an existing database, or creates a new database from the project, or creates a computer program from the project.

19. The system as recited in claim 18, further comprising:
a network interface communicably coupled to the processor;
a network communicably coupled to the network interface; and
one or more computers communicably coupled to the network.

20. The system as recited in claim 19, wherein the computer program is distributed over the one or more computers in a client layer, a presentation layer, a business layer and a database layer.

21. A computer program embodied on a computer readable medium for developing software, the computer program comprising:
a set of standardized code segments;
a code segment for defining a structure of a project; and
a code segment for creating the project from an existing database, or creating a new database from the project, or creating a new computer program from the project.

22. A method for generating a new computer program using a software development tool comprising the steps of:
(a) creating and renaming a root part for a project having a structure;
(b) adding and renaming one or more holders to the renamed root part;
(c) adding and renaming a part to one or more of the renamed holders;
(d) adding and renaming one or more holders to the renamed parts;
(e) creating one or more elements for each renamed part;
(f) repeating steps (c), (d) and (e) as needed to complete the structure; and
(g) generating the new computer program from the project.

23. The method as recited in claim 22, wherein the renamed holders establish relationships between the renamed root part and renamed parts.

24. The method as recited in claim 23, further comprising the step of designing the project by identifying the parts, relationships and elements of the project.

25. The method as recited in claim 22, further comprising the steps of:
creating the project; and
setting one or more properties of the project.

26. The method as recited in claim 22, further comprising the step of coding one or more business rules for the project.

27. The method as recited in claim 22, further comprising the step of generating a database from the project.

28. The method as recited in claim 22, further comprising the step of creating one or more forms from the project.

29. The method as recited in claim 22, further comprising the step of executing the new computer program.

30. The method as recited in claim 22, further comprising the step of modifying the renamed root part, the renamed part(s), or the renamed holder(s).

31. A computer program embodied on a computer readable medium for generating a new computer program comprising:
(a) a code segment for creating and renaming a root part for a project having a structure;
(b) a code segment for adding and renaming one or more holders to the renamed root part;
(c) a code segment for adding and renaming a part to one or more of the renamed holders;
(d) a code segment for adding and renaming one or more holders to the renamed parts;
(e) a code segment for creating one or more elements for each renamed part;
(f) a code segment for repeating steps (c), (d) and (e) as needed to complete the structure; and
(g) a code segment for generating the new computer program from the project.

32. A system comprising:
a computer comprising a processor, a memory communicably coupled to the processor, a data storage device communicably coupled to the processor, and one or more input/output devices communicably coupled to the processor selected from a group comprising a display, a keyboard, a mouse, a printer, a microphone, a speaker and a video camera; and
a computer program stored in the memory and data storage device that performs the steps: (a) creating and renaming a root part for a project having a structure, (b) adding and renaming one or more holders to the renamed root part, (c) adding and renaming a part to one or more of the renamed holders, (d) adding and renaming one or more holders to the renamed parts, (e) creating one or more elements for each renamed part, (f) repeating steps (c), (d) and (e) as needed to complete the structure, and (g) generating the new computer program from the project.
